(19) United States
(12) Patent Application Publication
(10) Pub. No.: US 2015/0141154 A1
(43) Pub. Date: May 21, 2015

(54) Interactive Experimentation

(71) Applicant: Moblab Inc., Pasadena, CA (US)

(72) Inventors: Miao Walter Yuan, Arcadia, CA (US); Matthew O. Jackson, Stanford, CA (US); Beilin Zhang, Foster City, CA (US); Stephanie W. Wang, Pittsburgh, PA (US)

(73) Assignee: Moblab Inc., Pasadena, CA (US)

(21) Appl. No.: 14/081,374

(22) Filed: Nov. 15, 2013

(51) Int. Cl. A63F 13/40

(52) U.S. Cl. CPC A63F 13/10
USPC 463/43

(57) ABSTRACT

A system and method for providing interactive experimentations for users are described. In one embodiment, the method includes receiving a signal of creating a playlist from a user; creating an empty playlist, responsive to receiving the signal; receiving one or more templates for one or more games; and populating, using the one or more processors, the playlist based on the one or more templates for one or more games.

The specification relates to electronic services. In particular, the specification relates to online interactive experimentations.

### BACKGROUND

With advent of personal computer, smart phones and tablets, there have been attempts to augment the classroom experience with these devices as well as use the for distance learning. Classrooms have typically been used for lectures augmented by chalkboard and more recently overhead slides and PowerPoint presentations. However, this lecture format even when a Socratic method is used is not the best vehicle for teaching students and providing clear education about complex topics. One problem with the lecture format is that it is not interactive, and is not the way many learn. With the increased use of technology in society, students learn better with experience and narrative. Especially, future generations of students learn differently from us, as technology is an integral part of their upbringing. Existing methods and systems do not provide effective teaching constructs for learning complex and abstract concepts in the classroom. One way to teach complex and abstract concepts is by through playing games and relating with concrete context through games. Sometime past teachers have run games or experiments as a teaching vehicle, but the time required to collect and collate data takes up too much valuable class time. Moreover, it is difficult to modify the games, rerun them or adapt them to different uses in the classroom. Finally, there are not mechanisms in the prior art to share and reuse content, games and game results. Therefore, there is a need for systems and method that provide better interactivity between students and the teacher to learn new concepts.

### SUMMARY

The specification overcomes deficiencies and limitations of the prior art at least in part by providing a system and methods for providing interactive experimentations to users.

In one embodiment, a system includes a processor and a memory storing instructions that, when executed, cause the system to: receive a signal to create a playlist from a first user; create an empty playlist, responsive to receiving the signal; receive a first template for a first game; and populate the playlist based on the first template for the first game.

In one embodiment, the method comprises receiving, using one or more processors, a signal to create a playlist from a first user; creating, using the one or more processors, an empty playlist, responsive to receiving the signal; receiving, using the one or more processors, a first template for a first game; and populating, using the one or more processors, the playlist based on the first template for the first game.

Other implementations of one or more of these aspects include corresponding systems, apparatus, and computer programs, configured to perform the actions of the methods, encoded on computer storage devices.

The features and advantages described herein are not all-inclusive and many additional features and advantages will be apparent in view of the figures and description. Moreover, it should be noted that the language used in the specification has been principally selected for readability and instructional purposes, and not to limit the scope of the subject matter disclosed herein.

### BRIEF DESCRIPTION OF THE DRAWINGS

The embodiments are illustrated by way of example, and not by way of limitation in the figures of the accompanying drawings in which like reference numerals are used to refer to similar elements.

FIG. 1A illustrates a system for providing interactive experimentations to users according to one embodiment.

FIG. 1B illustrates a system for providing interactive experimentations to users according to another embodiment.

FIG. 2A is a block diagram illustrating an experimentation server according to one embodiment.

FIG. 2B is a block diagram illustrating an experimentation server according to another embodiment.

FIG. 3 is a block diagram illustrating an interactive experimentation module according to one embodiment.

FIG. 4 is a flow chart illustrating a method for creating a playlist according to one embodiment.

FIG. 5 is a flow chart illustrating a method for creating a playlist according to another embodiment.

FIG. 6 are flow charts illustrating a method for setting up an account for a user according to one embodiment.

FIG. 7A is a flow chart illustrating a method for allowing users to join games according to one embodiment.

FIG. 7B is a flow chart illustrating a method for adding users as participants to a playlist according to one embodiment.

FIG. 7C is a flow chart illustrating a method for allowing users to play games according to one embodiment.

FIG. 8 is a flow chart illustrating a method for running a demo according to one embodiment.

FIG. 9A is a flow chart illustrating a method for generating a result for a game according to one embodiment.

FIG. 9B is a flow chart illustrating a method for analyzing user behavior in a game according to one embodiment.

FIG. 10 is a graphical representation illustrating a user interface for allowing users to create a class according to one embodiment.

FIG. 11 is a graphical representation illustrating a user interface for displaying class information to users according to one embodiment.

FIG. 12 is a graphical representation illustrating a user interface for displaying a class code to a user according to one embodiment.

FIG. 13 is a graphical representation illustrating a user interface allowing users to share a class with other users according to one embodiment.

FIG. 14 is a graphical representation illustrating a user interface for creating a playlist for users according to one embodiment.

FIG. 15 is a graphical representation illustrating a user interface for copying a playlist to a class according to one embodiment.

FIG. 16 is a graphical representation illustrating a user interface for displaying instructions about how to populate a playlist according to one embodiment.

FIG. 17 is a graphical representation illustrating a user interface for displaying a created playlist according to one embodiment.

FIG. 18 is a graphical representation illustrating a user interface for displaying a configuration setting for a Bargaining game according to one embodiment.

FIG. 19 is a graphical representation illustrating a user interface for requesting a user to input the number of players that the user wants to play with in a demo of a game according to one embodiment.

FIG. 20 is a graphical representation illustrating a user interface for displaying a demo of the Bargaining game according to one embodiment.

FIG. 21 is a graphical representation illustrating a user interface for displaying a result of the demo of the Bargaining game according to one embodiment.

FIG. 22 is a graphical representation illustrating a user interface for displaying a summary of the demo for the Bargaining game according to one embodiment.

FIG. 23 is a graphical representation illustrating a user interface for displaying an analysis result of the demo for the Bargaining game according to one embodiment.

FIG. 24 is a graphical representation illustrating a user interface for displaying an analysis result of the demo for the Bargaining game according to one embodiment.

FIG. 25 is a graphical representation illustrating a user interface for displaying a class roster according to one embodiment.

FIG. 26 is a graphical representation illustrating a user interface for displaying a list of available playlists for a user who registers with a class according to one embodiment.

FIG. 27 is a graphical representation illustrating a user interface for displaying an indication that the instructor of the class has allowed students to join a playlist according to one embodiment.

FIG. 28 is a graphical representation illustrating a user interface for displaying the available playlists for a user according to one embodiment.

FIG. 29 is a graphical representation illustrating a user interface for displaying an indication that one participant is playing games in a playlist according to one embodiment.

FIG. 30 is a graphical representation illustrating a user interface for displaying information of the participant who is playing games in a playlist according to one embodiment.

FIG. 31 is a graphical representation illustrating a user interface that allows users to choose different patterns to replay a game according to one embodiment.

FIG. 32 is a graphical representation illustrating a user interface that allows users to input notes according to one embodiment.

FIG. 33 is a graphical representation illustrating a user interface that displays tools for users to learn about a game in the library according to one embodiment.

FIG. 34 is a graphical representation illustrating a user interface for displaying a manual of how to play a game according to one embodiment.

FIG. 35 is a graphical representation illustrating a user interface for displaying a demo of a game according to one embodiment.

FIG. 36 is a graphical representation illustrating a user interface for displaying class instructions for a game according to one embodiment.

FIG. 37 is a graphical representation illustrating a user interface that allows users to view different categories of games from the library according to one embodiment.

FIG. 38 is a graphical representation illustrating a user interface that displays a guide of the online interactive lab system according to one embodiment.

FIG. 39 is a graphical representation illustrating a user interface that displays parameters for configuring an Ultimatum game and a Dictator game according to one embodiment.

FIG. 40 is a graphical representation illustrating a user interface that displays parameters for configuring a Trust game and a Herding game according to one embodiment.

FIG. 41 is a graphical representation illustrating a user interface that displays parameters for configuring a game of Market for Lemons and a Continuous Market game according to one embodiment.

FIG. 42 is a graphical representation illustrating a user interface that displays parameters for configuring a game of Matching Pennies according to one embodiment.

FIG. 43 is a graphical representation illustrating a user interface that displays parameters for configuring a Matrix game according to one embodiment.

FIG. 44 is a graphical representation illustrating a user interface that displays parameters for configuring a game of Prisoner Dilemma and an Election game according to one embodiment.

FIG. 45 is a graphical representation illustrating a user interface that displays parameters for configuring a game of Ascending Clock Auction and a game of Descending Clock Auction according to one embodiment.

FIG. 46 is a graphical representation illustrating a user interface that displays parameters for configuring a game of Private Value Auctions and a game of Common Value Auctions according to one embodiment.

FIG. 47 is a graphical representation illustrating a user interface that displays parameters for configuring a Guessing game and a game of Tragedy of the Commons according to one embodiment.

FIG. 48 is a graphical representation illustrating a user interface that displays parameters for configuring an Oligopoly game and a Minimum Effort game according to one embodiment.

FIG. 49 is a graphical representation illustrating a user interface that displays parameters for configuring a game of Linear Public Goods and a game of Threshold Public Goods according to one embodiment.

FIG. 50 is a graphical representation illustrating a user interface that allows users to input questions according to one embodiment.

FIG. 51 is a graphical representation illustrating a user interface that allows users to play the ultimatum game according to one embodiment.

FIG. 52 is a graphical representation illustrating a user interface that displays how users play the Dictator game according to one embodiment.

FIG. 53 is a graphical representation illustrating a user interface that allows users to play the Trust game according to one embodiment.

FIG. 54 is a graphical representation illustrating a user interface that allows users to play the Herding game according to one embodiment.

FIG. 55 is a graphical representation illustrating a user interface that allows users to play the game of Market for Lemons according to one embodiment.

FIG. 56 is a graphical representation illustrating a user interface that allows users to play the Continuous Market game according to one embodiment.

FIG. 57 is a graphical representation illustrating a user interface that allows users to play the game of Matching Pennies according to one embodiment.

FIG. 58 is a graphical representation illustrating a user interface that allows users to play the Matrix game according to one embodiment.

FIG. 59 is a graphical representation illustrating a user interface that allows users to play the Prisoner Dilemma game according to one embodiment.

FIG. 60 is a graphical representation illustrating a user interface that allows users to play the Election game according to one embodiment.

FIG. 61 is a graphical representation illustrating a user interface that allows users to play the Election game according to another embodiment.

FIG. 62 is a graphical representation illustrating a user interface that allows users to play the game of Ascending Clock Auction according to one embodiment.

FIG. 63 is a graphical representation illustrating a user interface that allows users to play the game of Descending Clock Auction according to one embodiment.

FIG. 64 is a graphical representation illustrating a user interface that allows users to play the game of Private Value Auction according to one embodiment.

FIG. 65 is a graphical representation illustrating a user interface that allows users to play the game of Common Value Auctions according to one embodiment.

FIG. 66 is a graphical representation illustrating a user interface that allows users to play the Guessing game according to one embodiment.

FIG. 67 is a graphical representation illustrating a user interface that displays how users play the Guessing game according to one embodiment.

FIG. 68 is a graphical representation illustrating a user interface that allows users to play the game of Tragedy of the Commons according to one embodiment.

FIG. 69 is a graphical representation illustrating a user interface that displays how users play the game of Tragedy of the Commons according to one embodiment.

FIG. 70 is a graphical representation illustrating a user interface that allows users to play the Oligopoly game according to one embodiment.

FIG. 71 is a graphical representation illustrating a user interface that displays how users play the Oligopoly game according to one embodiment.

FIG. 72 is a graphical representation illustrating a user interface that allows users to play the Minimum Effort game according to one embodiment.

FIG. 73 is a graphical representation illustrating a user interface that displays how users play the Minimum Effort game according to one embodiment.

FIG. 74 is a graphical representation illustrating a user interface that allows users to play the Linear Public Goods game according to one embodiment.

FIG. 75 is a graphical representation illustrating a user interface that allows users to play the Threshold Public Goods game according to one embodiment.

FIG. 76 is a graphical representation illustrating a user interface that displays an analysis result for the Election game according to one embodiment.

FIG. 77 is a graphical representation illustrating a user interface that displays an analysis result for the game of Ascending Clock Auction according to one embodiment.

FIG. 78 is a graphical representation illustrating a user interface that displays an analysis result for the game of Private Value Auctions according to one embodiment.

FIG. 79 is a graphical representation illustrating a user interface that displays an analysis result for the game of Common Value Auctions according to one embodiment.

FIG. 80 is a graphical representation illustrating a user interface that displays an analysis result for the Guessing game according to one embodiment.

FIG. 81 is a graphical representation illustrating a user interface that displays an analysis result for the Oligopoly game according to one embodiment.

FIG. 82 is a graphical representation illustrating a user interface that displays an analysis result for the game of Linear Public Goods according to one embodiment.

FIG. 83 is a graphical representation illustrating a user interface that displays an analysis result for the Ultimatum game according to one embodiment.

FIG. 84 is a graphical representation illustrating a user interface that displays an analysis result for the Dictator game according to one embodiment.

FIG. 85 is a graphical representation illustrating a user interface that displays an analysis result for the Prisoner Dilemma game according to one embodiment.

FIG. 86 is a graphical representation illustrating a user interface that displays an analysis result for the Herding game according to one embodiment.

FIG. 87 is a graphical representation illustrating a user interface that displays an analysis result for the game of Market for Lemons according to one embodiment.

FIG. 88 is a graphical representation illustrating a user interface that displays an analysis result for the continuous market game according to one embodiment.

FIG. 89 is a graphical representation illustrating a user interface that displays an analysis result for the game of Matching Pennies according to one embodiment.

FIG. 90 is a graphical representation illustrating a user interface that displays an analysis result for the Matrix game according to one embodiment.

FIG. 91 is a block diagram illustrating a system for providing interactive experimentations to users according to yet another embodiment.

FIG. 92 is a block diagram illustrating architecture for the system that provides interactive experimentations to users according to one embodiment.

FIG. 93 is a block diagram illustrating architecture for data service included in the system that provides interactive experimentations to users according to one embodiment.

FIGS. 94A and 94B are flow charts illustrating a method for processing payments by the monetization module according to one embodiment.

### DETAILED DESCRIPTION

A system and method for providing online interactive experimentations to users is described. In the following description, for purposes of explanation, numerous specific details are set forth in order to provide a thorough understanding of the embodiments. It will be apparent, however, that the embodiments can be practiced without these specific details. In other instances, structures and devices are shown in block diagram form in order to avoid obscuring the embodiments. For example, one embodiment is described below with reference to user interfaces and particular hardware. However, the present embodiments apply to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including, for example, “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The embodiments can take the form of an entirely hardware embodiment, an entirely software embodiment or an embodiment containing both hardware and software elements. An exemplary embodiment is implemented in software, which includes but is not limited to firmware, resident software, microcode, etc.

Furthermore, the embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

### System Overview

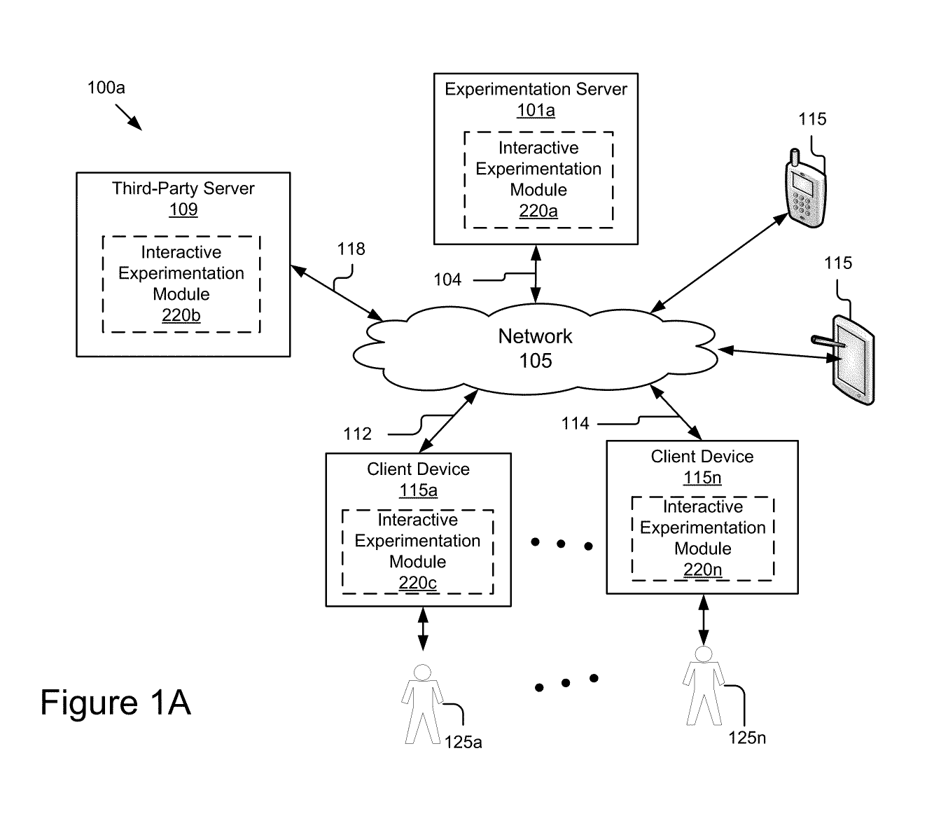

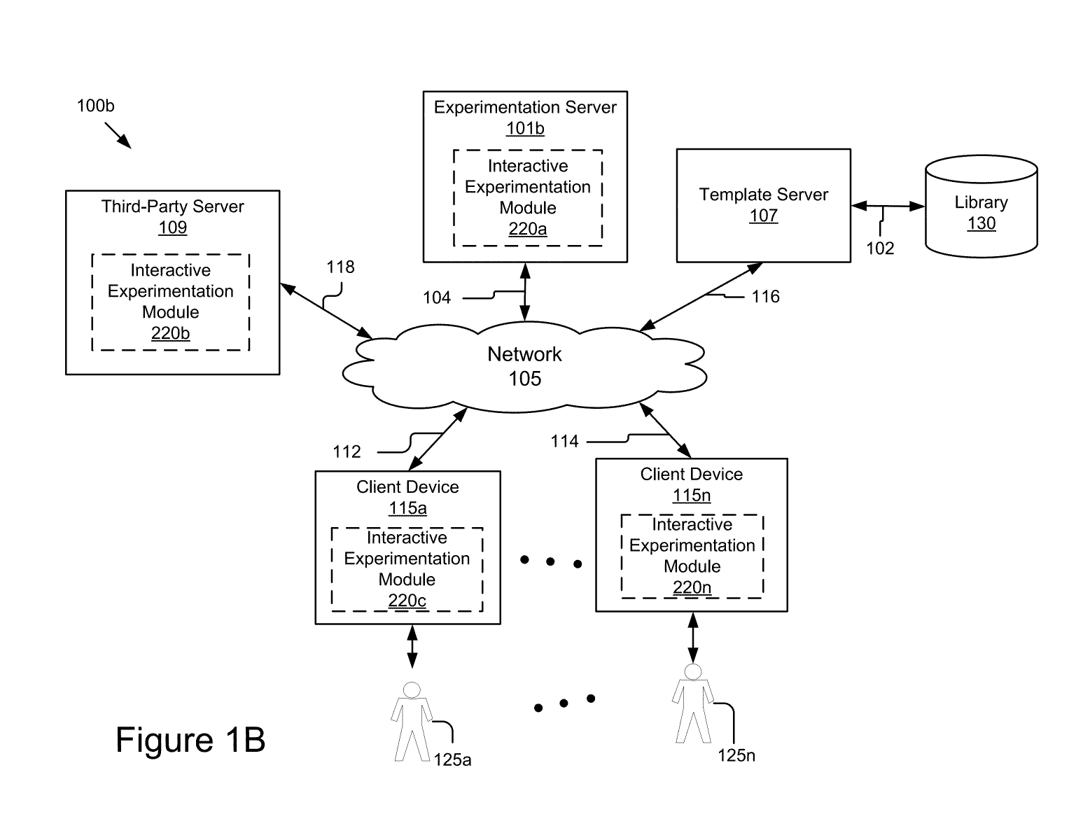

FIG. 1A illustrates a block diagram of a system 100a for providing online interactive experimentations to users according to one embodiment. The illustrated system 100a includes client devices 115a and 115n (also referred to collectively as client devices 115 or individually as client device 115) that are accessed by users 125a and 125n (also referred to collectively as users 125 or individually as user 125), an experimentation server 101a, and a third-party server 109. In the illustrated embodiment, these entities are communicatively coupled via a network 105. The third-party server 109 is merely an example and the system 100a in some implementations can include a document server, a blogging server, a news feed server, a video sharing server, a photo sharing server, a map server and any other third party server, etc.

The client devices 115 in FIG. 1A are used by way of example. While FIG. 1A illustrates two client devices 115, the present specification applies to any system architecture having one or more client devices 115. Furthermore, while only one network 105 is coupled to the client devices 115, the experimentation server 101 and the third-party server 109, in practice any number of networks 105 can be connected to the entities. Furthermore, while FIG. 1A illustrates one experimentation server 101, the present specification applies to any system architecture having one or more experimentation servers 101. Furthermore, while only one third-party server 109 is shown, the system 100a can include any number of third-party servers 109.

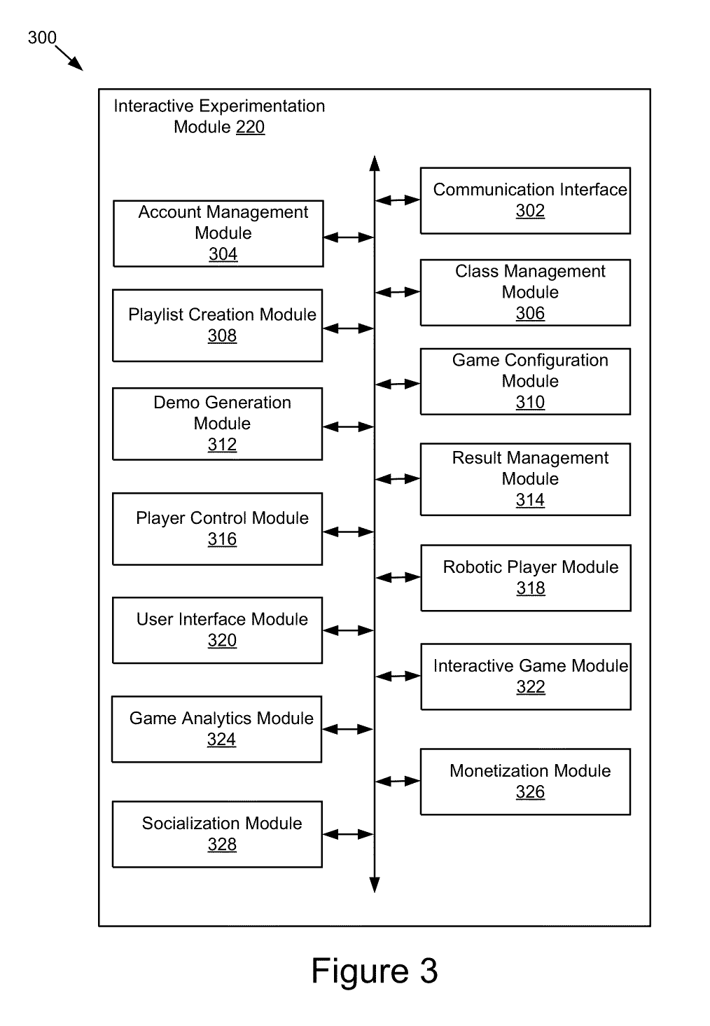

In one embodiment, an interactive experimentation module 220a is included in the experimentation server 101 and is operable on the experimentation server 101, which is connected to the network 105 via signal line 104. In another embodiment, an interactive experimentation module 220b is included in the third-party server 109 and is operable on the third-party server 109, which is connected to the network 105 via signal line 118. In yet another embodiment, an interactive experimentation module 220c is included in the client device 115a and is operable on the client device 115a, which is connected to the network 105 via signal line 112. In yet another embodiment, an interactive experimentation module 220n is included in the client device 115n and is operable on the client device 115n, which is connected to the network 105 via signal line 114. It will be recognized that the interactive experimentation module 220a/220b/220c/220n (referred to generally as the multimedia publisher module 220) can be stored in any of one or more experimentation servers 101, one or more third-party servers 109, one or more client devices 115 or a combination thereof. In some embodiments, the interactive experimentation module 220 includes multiple, distributed modules that cooperate with each other to perform the functions described below. Details describing the functionality and components of the interactive experimentation module 220 are explained in further detail below in reference to FIG. 3.

While shown as operational on one of the experimentation server 101, the third-party server 109 and the client device 115 in FIG. 1A, in some embodiments, all or part of the interactive experimentation module 220 may be operational on any other servers which the system 100a can include and are connected to the network 105. The interactive experimentation module 220 interacts with the servers 101, 109 and other servers via the network 105.

In one embodiment, the interactive experimentation module 220 can be integrated with an application program interface (API) on a third-party platform so that the interactive strategic games for unprecedented large-scale social science studies can be combined with the access of vast human subject pool available on the third-party platform.

The network 105 enables communications between client devices 115, the experimentation server 101, the third-party server 109 and other servers. Thus, the network 105 can include links using technologies including, for example, Wi-Fi, Wi-Max, 2G, Universal Mobile Telecommunications System (UMTS), 3G, Ethernet, 802.11, integrated services digital network (ISDN), digital subscriber line (DSL), asynchronous transfer mode (ATM), InfiniBand, PCI Express Advanced Switching, etc. Similarly, the networking protocols used on the network 105 can include the transmission control protocol/Internet protocol (TCP/IP), multi-protocol label switching (MPLS), the User Datagram Protocol (UDP), the hypertext transport protocol (HTTP), the simple mail transfer protocol (SMTP), the file transfer protocol (FTP), lightweight directory access protocol (LDAP), Code Division Multiple Access (CDMA), Wideband Code Division Multiple Access (WCDMA), Global System for Mobile communications (GSM), High-Speed Downlink Packet Access (HSDPA), etc. The data exchanged over the network 105 can be represented using technologies and/or formats including the hypertext markup language (HTML), the extensible markup language (XML), JavaScript Object Notation (JSON), Comma Separated Values (CSV), etc. In addition, all or some of links can be encrypted using conventional encryption technologies, for example, the secure sockets layer (SSL), Secure HTTP (HTTPS) and/or virtual private networks (VPNs) or Internet Protocol security (IPsec). In another embodiment, the entities can use custom and/or dedicated data communications technologies instead of, or in addition to, the ones described above. Depending upon the embodiment, the network 105 can also include links to other networks.

In one embodiment, the network 105 is a partially public or a wholly public network, for example, the Internet. The network 105 can also be a private network or include one or more distinct or logical private networks (e.g., virtual private networks, Wide Area Networks (“WAN”) and/or Local Area Networks (“LAN”)). Additionally, the communication links to and from the network 105 can be wire line or wireless (i.e., terrestrial or satellite-based transceivers). In one embodiment, the network 105 is an IP-based wide or metropolitan area network.

In the illustrated embodiment, the client devices 115a and 115n are coupled to the network 105 via signal lines 112 and 114, respectively. The user 125a can interact with the client device 115a. Similarly, the user 125n can interact with the client device 115n. In one embodiment, a client device 115 is an electronic device. In one embodiment, the client device 115 interacts with the various servers 101, 109, and other client devices 115 of the system 100a via the network 105. The client device 115 can be, for example, a laptop computer, a desktop computer, a tablet computer, a mobile telephone, a personal digital assistant (PDA), a mobile email device, a portable game player, a portable music player, a television with one or more processors embedded therein or coupled thereto, or any other electronic device capable of accessing a network. It will be recognized that other types of client devices 115 are possible. In one embodiment, the system 100a comprises a combination of different types of client devices 115. For example, a combination of a personal computer and a mobile phone. The user 125 is a human user of the client device 115. In some embodiments, the client device 115 includes Android and iOS devices, including iPod Touch, iPad and iPhone, in the form of native apps, as well as all major web browsers that support HTML5 and JavaScript.

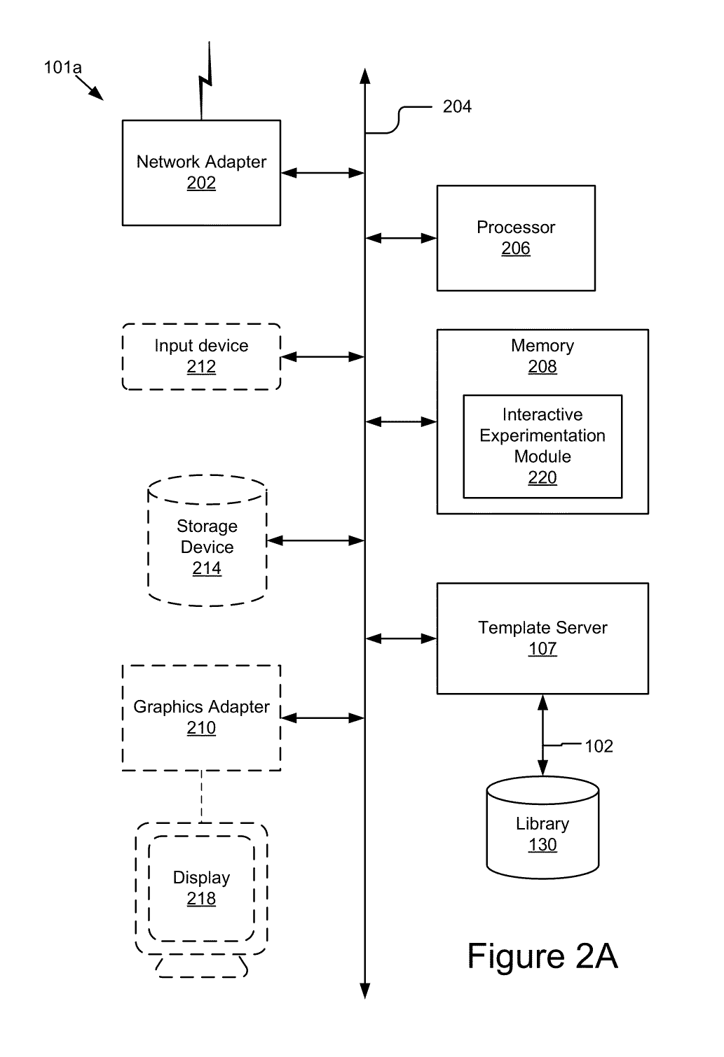

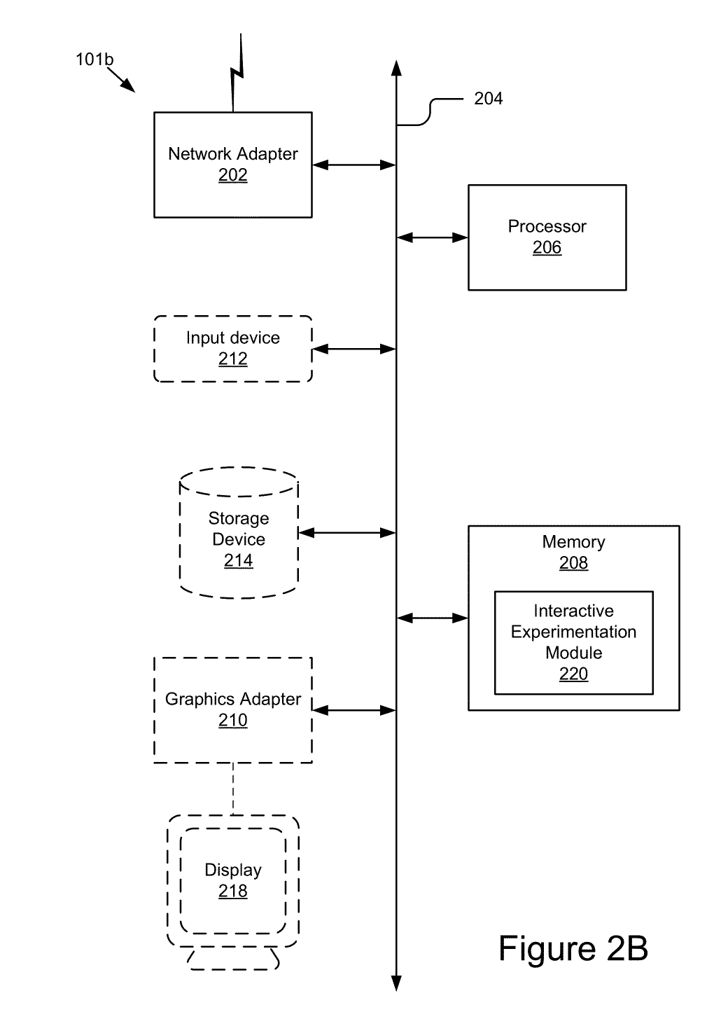

FIG. 1B illustrates a block diagram of a system 100b for providing online interactive experimentations to users according to another embodiment. The illustrated system 100b includes the same or similar components as those in the system 100a, for example, the client devices 115a and 115n (also referred to collectively as client devices 115 or individually as client device 115) that are accessed by users 125a and 125n (also referred to collectively as users 125 or individually as user 125) and a third-party server 109. The illustrated system 100b also includes an experimentation server 101b and a template server 107 which is connected to a library 130 via signal line 102. In one embodiment, the combination of the experimentation server 101b and the template server 107 implements the functionality of the experimentation server 101a in the system 100a. In other words, the experimentation server 101a also includes a template server 107 connected to the library 130, as shown in FIG. 2A which will be described in further detail below. In the illustrated embodiment, these entities 101b, 107, 109, 115 are communicatively coupled via a network 105. The servers 107, 109 are merely examples and the system 100b in some implementations includes a document server, a blogging server, a news feed server, a video sharing server, a photo sharing server, a map server and any other third party server, etc.

In one embodiment, the template server 107 is a server having one or more processors, memory and communication capabilities for creating and managing templates of games. In one embodiment, the template server 107 also constructs the library 130 that stores the templates of games. For example, the library 130 may be a NoSQL database. The template server 107 is coupled to the network 105 via signal line 116 for communication with the other components in the system 100b. For example, the template server 107 receives queries about one or more templates of games from another entity, e.g., the experimentation server 101b, the third-party server 109, the client device 115, searches for the one or more queried templates in the library 130 and provides the one or more templates to the server via the network 105. In one embodiment, the template server 107 creates templates for games. For example, the template server 107 generates templates based on economic models. In one embodiment, the template server 107 retrieves templates for games from one or more resources via the network 105, e.g., other servers providing economic templates or models.

In one embodiment, a game template is a template including information about a game or information for constructing a game. For example, a game template can have a set of parameters that allow one or more games to be configured and extended. In one embodiment, a game template may be generated by combining distilled information from relevant academic papers with past experiences. For example, the template server has a module (not pictured) that filtered the information from economic academic articles based on past education and research experience and generate a game template as a result of the combination of the filtered information. Therefore, the game template contains not only the set of parameters to allow one or multiple concrete games to be extended, but also a robust flow of logic to ensure game execution at runtime. The game templates may correspond or mimic any variety of real world social or economic interactions between parties/users.

### Example Experimentation Server 101a, 101b

FIG. 2A is a block diagram of an experimentation server 101a for providing online interactive experimentations to users 125 according to one embodiment. As illustrated in FIG. 2A, the experimentation server 101a includes a network adapter 202 coupled to a bus 204. According to one embodiment, also coupled to the bus 204 are at least one processor 206, memory 208, a graphics adapter 210, an input device 212 and a storage device 214. The memory 208 stores one or more modules, which are executed by the processor 206. In one embodiment, the functionality of the bus 204 is provided by an interconnecting chipset. In one embodiment, the experimentation server 101a also includes a display 218, which is coupled to the graphics adapter 210. In one embodiment, the experimentation server 101a also includes a template server 107 connected to a library 130 via signal line 102, which is depicted in FIG. 1B as a separate server from the experimentation server 101b of the system 100b. The functionalities of the template server 107 will not be repeated herein.

The processor 206 may be any general-purpose processor. The processor 206 comprises an arithmetic logic unit, a microprocessor, a general purpose controller or some other processor array to perform computations and execute code and routines. The processor 206 is coupled to the bus 204 for communication with the other components of the experimentation server 101a. Processor 206 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2A, multiple processors may be included. The experimentation server 101a also includes an operating system executable by the processor including but not limited to WINDOWS®, MacOS X, Linux or UNIX® based operating systems. It will be recognized that other processors, operating systems, sensors, displays and physical configurations are possible.

The memory 208 is a non-transitory storage medium. The memory 208 holds instructions and/or data that may be executed by the processor 206. In one embodiment, the instructions and/or data stored on the memory 208 comprise code for performing any and/or all of the techniques described herein. The memory 208 may be a dynamic random access memory (DRAM) device, a static random access memory (SRAM) device, flash memory or some other memory device. In one embodiment, the memory 208 also includes a non-volatile memory or similar permanent storage device and media, for example, a hard disk drive, a floppy disk drive, a CD-ROM device, a DVD-ROM device, a DVD-RAM device, a DVD-RW device, a flash memory device, or some other mass storage device known for storing information on a more permanent basis. The memory 208 is coupled by the bus 204 for communication with the other components of the experimentation server 101a. In one embodiment, an interactive experimentation module 220 is stored in memory 208 and executable by the processor 206 of the experimentation server 101a.

The interactive experimentation module 220 includes code and routines executable by the processor 206 for providing online interactive experimentations to users 125. In one embodiment, the interactive experimentation module 220 is a set of instructions executable by the processor 206. In another embodiment, the interactive experimentation module 220 is stored in the memory 208 and is accessible and executable by the processor 206. Details describing the functionality and components of the interactive experimentation module 220 are explained in further detail below in reference to FIGS. 3.

The storage device 214 is any device capable of holding data, like a hard drive, compact disk read-only memory (CD-ROM), DVD, or a solid-state memory device. The storage device 214 is a non-volatile memory device or similar permanent storage device and media. The storage device 214 stores data and instructions for processor 206 and comprises one or more devices including a hard disk drive, a floppy disk drive, a CD-ROM device, a DVD-ROM device, a DVD-RAM device, a DVD-RW device, a flash memory device, or some other mass storage device. In one embodiment, the storage device 214 stores data and information of a user 125.

The input device 212 may include a mouse, track ball, or other type of pointing device to input data into the experimentation server 101a. The input device 212 may also include a keyboard, for example, a QWERTY keyboard or any other physical or soft keyboard in any language. The input device 212 may also include a microphone, a web camera or similar audio or video capture device. The graphics adapter 210 displays images and other information on the display 218. The display 218 is a conventional type, for example, a liquid crystal display (“LCD”) or any other similarly equipped display device, screen, touchscreen or monitor. The display 218 represents any device equipped to display electronic images and data as described herein. The network adapter 202 couples the experimentation server 101a to a local or wide area network.

As is known in the art, an experimentation server 101a can have different and/or other components than those shown in FIG. 2A. For example, the experimentation server 101a can have speakers or another form of audio output. In addition, the experimentation server 101a can lack certain illustrated components. For example, in one embodiment, the experimentation server 101a lacks an input device 212, graphics adapter 210 and/or display 218. Moreover, the storage device 214 can be local and/or remote from the experimentation server 101a (e.g., a storage area network (SAN)).

The experimentation server 101a is adapted to execute computer program modules for providing the functionality described herein. As used herein, the term “module” refers to computer program logic utilized to provide the specified functionality. Thus, a module can be implemented in hardware, firmware, and/or software. In one embodiment, program modules are executed by the processor 206.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

FIG. 2B is a block diagram of an experimentation server 101b for providing online interactive experimentations to users 125 according to one embodiment. As illustrated in FIG. 2B, the experimentation server 101b includes a network adapter 202 coupled to a bus 204. According to one embodiment, also coupled to the bus 204 are at least one processor 206, memory 208, a graphics adapter 210, an input device 212 and a storage device 214. The memory 208 stores one or more modules, which are executed by the processor 206. In one embodiment, the functionality of the bus 204 is provided by an interconnecting chipset. In one embodiment, the experimentation server 101a also includes a display 218, which is coupled to the graphics adapter 210. In one embodiment, an interactive experimentation module 220 is stored in memory 208 and executable by the processor 206 of the experimentation server 101b.

### Example Interactive Experimentation Module 220

Referring now to FIG. 3, the interactive experimentation module 220 is shown in more detail according to one embodiment. FIG. 3 is a block diagram of the interactive experimentation module 220 included in an experimentation server 101a or 101b, a third party server 109, a client device or any other servers.

In one embodiment, the interactive experimentation module 220 comprises a communications interface 302, an account module 304, a class management module 306, a playlist creation module 308, a game configuration module 310, a demo generation module 312, a result management module 314, a player control module 316, a robotic player module 318, an user interface module 320, an interactive game module 322, a game analytics module 324, a monetization module 326 and a socialization module 328.

It will be recognized that the modules 302, 304, 306, 308, 310, 312, 314, 316, 318, 320, 322, 324, 326, 328 comprised in the interactive experimentation module 220 are not necessarily all on the experimentation server 101a or 101b. In one embodiment, the modules 302, 304, 306, 308, 310, 312, 314, 316, 318, 320, 322, 324, 326, 328 are distributed across the experimentation server 101a or 101b, the client device 115 and the third-party server 109. For example, in one embodiment, the player control module 316 is included in the client device 115, while the other modules 302, 304, 306, 308, 310, 312, 314, 316, 318, 320, 322, 324, 326, 328 are included in the experimentation server 101a or 101b. In another example, in one embodiment, the modules 302, 304, 306, 308, 310, 312, 314, 316, 318, 320, 322, 324, 326, 328 are distributed across multiple experimentation servers 101a or 101b. It will be recognized that the preceding are merely examples of distributing modules across multiple computing devices and that other examples exist.

It will be also recognized that some of the modules 302, 304, 306, 308, 310, 312, 314, 316, 318, 320, 322, 324, 326, 328 can be, in some embodiments, combined to implement multiple functionalities. For example, the game configuration module 310, the result management module 314 and the interactive game module 322 can combined as a signal module (e.g., a game module) to implement the functionalities of the three modules 310, 314 and 322. For example, the game module can configure games, generate game results as well as handle user interactions during the games.

The communication interface 302 includes code and routines for handling communications between the account module 304, the class management module 306, the playlist creation module 308, the game configuration module 310, the demo generation module 312, the result management module 314, the player control module 316, the robotic player module 318, the user interface module 320, the interactive game module 322, the game analytics module 324, the monetization module 326, the socialization module 328, the sub-modules thereof and other components of the experimentation server 101a or 101b. In one embodiment, the communication interface 302 is a set of instructions executable by the processor 206. In another embodiment, the communication interface 302 is stored in the memory 208 and is accessible and executable by the processor 206. In either embodiment, the communication interface 302 is adapted for cooperation and communication with the processor 206, other components of the experimentation server 101a or 101b and other components of the interactive experimentation module 220.

In one embodiment, the communication interface 302 receives data from one or more of the client device 115, the third-party server 109 and other servers not depicted and delivers the information to one or more other appropriate sub-modules of the interactive experimentation module 220. For example, the communication interface 302 receives, via the network 105, registration information from a client device 115 operated by a user 125 and delivers the registration information to the account module 304 for creating an account for the user 125. For example, the communication interface 302 receives a request for joining a playlist from a client device 115 operated by a user 125 and delivers the request to the player control module 316.

In one embodiment, the communication interface 302 receives data from the one or more sub-modules of the interactive experimentation module 220 and delivers the data to one or more of the client device 115, the third-party server 109 and other servers not depicted. For example, the communication interface 302 receives graphical data describing game results from the user interface module 320 and sends the graphical data to the client device 115 for presenting the game results to a user 125 operating on the client device 115. In one embodiment, the communication interface 302 also handles communications between the one or more sub-modules of the interactive experimentation module 220. For example, the communication interface 302 communicates with the game configuration module 310 and the demo generation module 312, to pass an output of the game configuration module 310 (e.g., a configured game based on parameters) to the demo generation module 312 for generating a demo for the configured game. For purpose of clarity and convenience, the above description may occasionally omit mention of the communication interface 302 and the above scenario may be described as the game configuration module 310 passing the configured game to the demo generation module 312 for generation a demo for the configured game.

The account management module 304 includes code and routines for creating and managing accounts for users 125. In one embodiment, the account management module 304 is a set of instructions executable by the processor 206. In another embodiment, the account management module 304 is stored in the memory 208 and is accessible and executable by the processor 206. In either embodiment, the account management module 304 is adapted for cooperation and communication with the processor 206, other components of the experimentation server 101a or 101b and other components of the interactive experimentation module 220.

The account management module 304 receives registration information of a user 125 from a client device 115 via the network 105 and the communication interface 302 and creates an account for the user 125 based on the registration information. For example, the account management module 304 cooperates with the user interface module 320 to provide a user interface allowing a user 125 to input information (e.g., a user name and a password) for registration with an online lab website, and when the user 125 inputs the information and sends a registration request through the user interface the account management module 304 receives the information and the registration request. The account management module 304 can then create an account for the user 125 based upon the information and the registration request.

Examples for registration information can also include, but not limited to, an email address, affiliation information, an occupation, student identification (ID), age, gender, race, a school, a year of school, a major in school, an address, residence, etc. In one embodiment, the account management module 304 can generate a profile for a user 125 based on the registration information. The profile for users 125 can later be used by the game analytics module 324 to analyze the game results based on the profile. For example, the game analytics module 324 can use demographic data (e.g., age, gender, race residence, etc.) to analyze the game results.

In one embodiment, the account management module 304 also cooperates with the user interface module 320 to require the user 125 to choose a type of account via a user interface. For example, the user interface can allow the user 125 to choose from a list of different types of account. For example, the types of account can include a student account, an instructor account, a teaching assistant account, etc. In another example, the types of account can include a basic account, a premium account, a VIP account, etc.

In one embodiment, the account management module 304 also verifies the information for registration provided by the user 125. For example, the account management module 304 communicates with another server (e.g., an authentication server, a notary server) for verifying the information provided by the user 125. Once the account management module 304 receives verification for the information, the account management module 304 creates an account for the user 125 using the information.

The class management module 306 includes code and routines for allowing users 125 to create and manage classes. In one embodiment, the class management module 306 is a set of instructions executable by the processor 206. In another embodiment, the class management module 306 is stored in the memory 208 and is accessible and executable by the processor 206. In either embodiment, the class management module 306 is adapted for cooperation and communication with the processor 206, other components of the experimentation server 101a or 101b and other components of the interactive experimentation module 220.

In one embodiment, the class management module 306 cooperates with the user interface module 320 to generate one or more user interfaces that allows a user 125 to create and manage a class. For example, the class management module 306 controls the user interface module 320 to generate a user interface allows the user 125 to indicate that the user 125 wants to create a class. When the user 125 expresses the desire of creating a class through the user interface (e.g., by clicking a button for creating a class, etc.), the class management module 306 receives a signal indicating that the user 125 is willing to create a class. The class management module 306 can then cooperate with the user interface module 320 to provide one or more other user interfaces for allowing the user 125 to input information for creating the class. For example, the one or more other user interfaces can require the users 125 to input a name for the class, an ID for the class, a brief description for the class, etc. After the user 125 inputs the information, the class management module 306 can receive the information and create the class based on the information. In one embodiment, the class management module 306 also cooperates with the user interface module 320 to provide a user interface for presenting class information to the user 125.

In one embodiment, the class management module 306 generates a class code for a class that allows other users 125 to join the class. For example, the class management module 306 creates an economics class for a user 125 who is an instructor of a school and generates a class code for the economics class. The class management module 306 can control the user interface module 320 to present the class code to the instructor 125 and the class code can allow the instructor 125 to invite one or more students 125 to join the economics class. For example, the instructor 125 can provide the class code to students 125 and the students 125 can join the class using the code. In one embodiment, the class management module 306 generates a class roster for a class to register users 125 (e.g., students 125) with the class. For example, when a student 125 enters a class code for a class through a user interface, the class management module 306 registers the student 125 with the class and adds the student 125 into the roster for the class once verifying that the class code is correct. In another example, the instructor 125 can upload information for a set of one or more students 125 through a user interface, the class management module 306 receives the information for the set of one or more students 125 and adds the set of one or more students 125 to the roster for the class.

In one embodiment, the class management module 306 also cooperates with the socialization module 328 to allow the user 125 to share the class with other users 125. For example, the class management module 306 receives a request from a first user 125 for sharing a class with one or more second users 125 when the first user 125 indicates so through a user interface. The class management module 306 cooperates with the socialization module 328 to share the class to the one or more second users 125 indicated by the user 125. For example, the class management module 306 controls the socialization module 328 to share the class through email addresses. In one embodiment, the class management module 306 can cooperate with the socialization module 328 to allow the user 125 to permit other users 125 to modify parameters or configurations for games in the shared class.

The playlist creation module 308 includes code and routines for creating playlists for users 125. In one embodiment, the playlist creation module 308 is a set of instructions executable by the processor 206. In another embodiment, the playlist creation module 308 is stored in the memory 208 and is accessible and executable by the processor 206. In either embodiment, the playlist creation module 308 is adapted for cooperation and communication with the processor 206, other components of the experimentation server 101a or 101b and other components of the interactive experimentation module 220.

It should be understood that the terms “playlist” and “game” are used throughout this specification, but are merely convenient labels used to describe the present invention. Other terms, such as but not limited to, activity list, game activity, activity agenda, game agenda, session list, session agenda, game list, game room, game collection, collection of activities, set of game or group of games could be used in place of the term “playlist.” The play list may be a group, set or collection of games or activities to be played a group of people at certain time (in class or in a TA session). An analogy would be an activity list a party host has. You can change the activities depending on the situation. The assumption that a group of people all present and more or less stay is important, which enables replays and makes repeated plays easier. Just like when a party host is entertaining a party with some activities (decided prior to the party or on the spot), he needs the guests to be at the party. The playlist is more useful to the host than to the guests. The guests just need to come to the party (game room) on time; they do not need to know about the activity list. The games or activities can be of different types and can be executed in any order, including repeated or skipping. In the context of a class or course, it represents a flexible way of organizing games to play in and out of class and in online classes. More specifically, a play list may be a collection of games, quizzes, polls, or other interactive modules, to be engaged with students or participants in general, either synchronously or asynchronously. When the order of the games does matter, it often serves to create a unique path or experience or a specific pedagogical purpose for the users. Similarly, other terms, such as but not limited to, activities, quizzes, polls may be used in place of the term “game.”

In one embodiment, the playlist creation module 308 cooperates with the user interface module 320 to provide a user interface that allows users 125 to indicate they want to create a playlist. When the users 125 indicate so, the playlist creation module 308 receives a request for creating a playlist and controls the user interface module 320 to provide another user interface for requesting the users 125 to input information about the playlist, for example, a name for the playlist, etc. The playlist creation module 308 can then create the playlist based on the information. At this point, the created playlist can be only a frame, which can be populated with games later. For example, the playlist creation module 308 can cooperates with the user interface module 320 to provide a user interface that allows the users 125 to select one or more games to be added into the playlist. For example, the user interface allows the users 125 to choose from a library of games. In one embodiment, a playlist can be a list of games that associated with a class. For example, a class can include one or more playlists and each playlist can include one or more games relevant to the class. For example, if the class is an economics class, the playlists in the class can include one or more games related to economics.

In one embodiment, the playlist creation module 308 can generate a syllabus based game catalog. For example, the playlist creation module 308 can package games based on syllabus of popular classes and textbooks for classes.

In one embodiment, the playlist creation module 306 can cooperate with the user interface module 320 to generate multiple skins of user interface for presenting a game to users 125. For example, the playlist creation module 306 can allow the instructor 125 of a class to choose between an abstract user interface and a user interface having a specific storyline based on the level and subject of the class.

In one embodiment, the playlist creation module 308 can send queries to the template server 107 and retrieve templates for games from the library 130. The playlist creation module 308 can generate games based on the templates and provide the games to users to choose.

The game configuration module 310 includes code and routines for configuring the games. In one embodiment, the game configuration module 310 is a set of instructions executable by the processor 206. In another embodiment, the game configuration module 310 is stored in the memory 208 and is accessible and executable by the processor 206. In either embodiment, the game configuration module 310 is adapted for cooperation and communication with the processor 206, other components of the experimentation server 101a or 101b and other components of the interactive experimentation module 220.

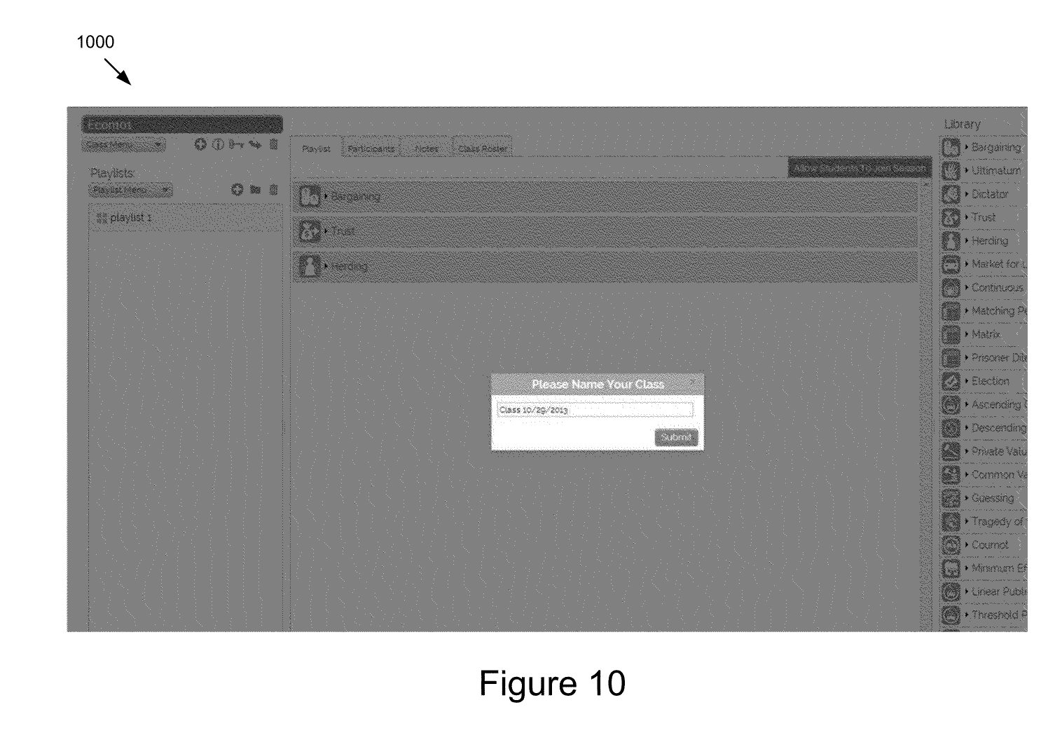

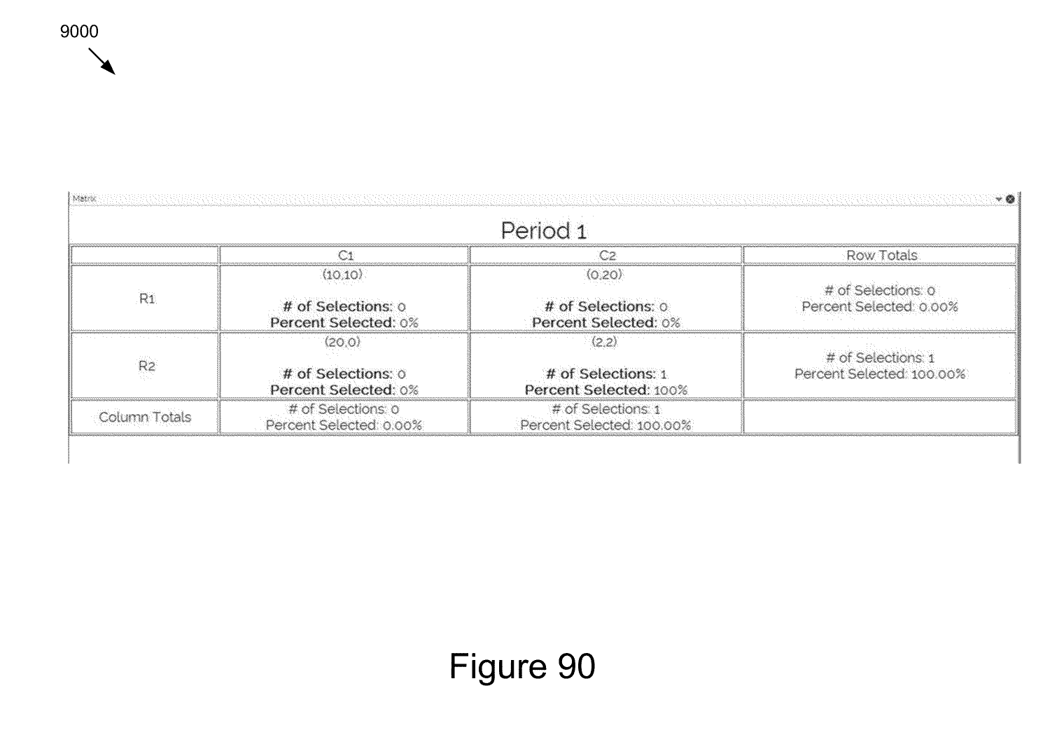

In one embodiment, the game configuration module 310 cooperates with the user interface module 320 to provide a user interface that allows users 125 to input configuration settings for games. For example, the user interface allows the users 125 to enter parameter values for games and the game configuration module 310 can receive the parameter values entered by the users 125 and configure the games based on the parameter values. The parameters for the games can be any parameters necessary for setting up the games. For example, for a bargaining game, the parameters can include turn duration, a total pie, a discount factor, the number of rounds, etc. Parameters for games are described in more detail below in Graphical User Interfaces (GUIs) with references to FIGS. 10-90. In one embodiment, the game configuration module 310 sends the configured games to the demo generation module 312 or the interactive game module 322.

The demo generation module 312 includes code and routines for generating demos based on game configurations. In one embodiment, the demo generation module 312 is a set of instructions executable by the processor 206. In another embodiment, the demo generation module 312 is stored in the memory 208 and is accessible and executable by the processor 206. In either embodiment, the demo generation module 312 is adapted for cooperation and communication with the processor 206, other components of the experimentation server 101a or 101b and other components of the interactive experimentation module 220.

In one embodiment, the demo generation module 312 receives game configuration for a game from the game configuration module 310 and once users 125 requests a demo for the game through a user interface, the demo generation module 312 generates a demo of the game based on the game configuration. For example, a user 125 enters parameter values for configuring a game and clicks to preview the game through the user interface; the demo generation module 312 generates a demo for the game configured based on the parameter values. During the demo, the demo generation module 312 also controls the user interface module 320 to provide a user interface allowing users 125 to play with the demo. For example, the user interfaces allows the users 125 to make inputs or actions to the demo and upon receiving the inputs or actions the demo generation module 312 generates a next stage of the demo based on the inputs or actions.

In one embodiment, the demo generation module 312 cooperates with the robotic player module 318 to generate robotic players to join the demo and play with the users 125. In one embodiment, the functionality of the demo generation module 312 can be implemented by the interactive game module 322. For example, the interactive game module 322 can generate demos based on game configuration and incorporate robotic players into participants for the demos.

The result management module 314 includes code and routines for generating and managing game results. In one embodiment, the result management module 314 is a set of instructions executable by the processor 206. In another embodiment, the result management module 314 is stored in the memory 208 and is accessible and executable by the processor 206. In either embodiment, the result management module 314 is adapted for cooperation and communication with the processor 206, other components of the experimentation server 101a or 101b and other components of the interactive experimentation module 220.

In one embodiment, the result management module 314 generates result data based on how users 125 play the games. For example, the result data describes a result that a user 125 has obtained by playing the game. For example, the result indicates that the user 125 won or lost; how much payoff the user 125 obtained; how much payoff the competitor achieved; etc. In one embodiment, the result data also include descriptions based on nature of the games. For example, the result data include statistical analysis about the result of the game.

In one embodiment, the result management module 314 can generate instant game results during games. For example, instead of generating a result for a game at the end of the game play, the result management module 314 can generate an instant result when the game is ongoing, responsive upon receiving a demand from a user 125 who is playing the game. The result management module 314 can cooperate with the user interface module 320 to present the instant result to the user 125 during the game.

In one embodiment, the result management module 314 sends the result data to the user interface module 320 for generating graphical data to present the results of the games to users 125. In one embodiment, the result management module 314 stores the result data to the storage 214 for being used by the game analytics module 324 to analyze user behaviors during the games.

The player control module 316 includes code and routines for allowing users 125 to join playlists. In one embodiment, the player control module 316 is a set of instructions executable by the processor 206. In another embodiment, the player control module 316 is stored in the memory 208 and is accessible and executable by the processor 206. In either embodiment, the player control module 316 is adapted for cooperation and communication with the processor 206, other components of the experimentation server 101a or 101b and other components of the interactive experimentation module 220.

In one embodiment, the player control module 316 cooperates with the user interface module 320 to provide a user interface that allows users 125 to join playlists. For example, the player control module 316 can monitor the system to check if the user 125 who created the playlist under a class (also referred to as the creator 125 or the instructor 125, hereinafter) allows other users 125 to join. For example, the player control module 316 controls the user interface module 320 to provide a user interface, through which the instructor 125 can allow the students in the class roster to join. In another example, the player control module 316 controls the user interface module 320 to provide a user interface allowing the creator 125 to permit any other users 125 to join the playlist. Once the player control module 316 determines that the instructor 125 or creator 125 allows other users 125 to join the playlist, the player control module 316 can cooperate with the user interface module 320 to provide a user interface indicating to the other users 125 that the playlist is ready to join and they can join now.

In one embodiment, if one of the other users 125 indicates through the user interface that the one of the other users 125 wants to join a playlist of a class, the player control module 316 receives a request of the user 125 willing to join the playlist. The one of the other users 125 who requests to join the playlist will be referred to as the requesting user 125 hereinafter. Upon receiving the request, the player control module 316 controls the user interface module 320 to provide a waiting image for the requesting user 125 so that the requesting user 125 can wait for an approval of starting to play. In one embodiment, the player control module 316 may also determine if the requesting user 125 is a member of the roster for the class. If the requesting user 125 is registered with the roster for the class, the player control module 316 controls to provide a waiting image for the requesting user 125. In one embodiment, while keeping the requesting user 125 waiting, the player control module 316 may monitor the system to check if the creator 125 or instructor 125 starts one or more games in the playlist. If the player control module 316 detects that the creator 125 or instructor 125 starts a game in the playlist, the player control module 316 cooperates with the interactive game module 322 to retrieve the game in the playlist from the storage 214 and determine an instance of the game. The player control module 316 can then allow the requesting user 125 to play the game. For example, the player control module 316 controls the interactive game module 322 and the user interface module 320 to provide a user interface based on the instance of the game and through the user interface the requesting user 125 can start playing the game.

In one embodiment, the player control module 316 allows requesting users 125 to join and play a game after the game has started. For example, the player control module 316 can monitor the system after the game has started and been ongoing to check if any other users 125 indicate that they want to join the playlist of the game. If the player control module 316 detects that any other users 125 want to join the playlist, the player control module 316 adds the other requesting users 125 to join and play the game as participants after the game has started and been ongoing. In this way, users 125 are conveniently allowed to play the games whenever they want and don't have to wait until all other participants 125 are ready. In one embodiment, the player control module 316 can also allow participants 125 to drop a game at any point of the game. For example, after the game has started, the player control module 316 can also allow a participant 125 to quit the game without affecting other participants' playing. For example, the player control module 316 can cooperate with the robotic player module 318 to generate robotic players to fill the spot of the quit participant.

In one embodiment, the player control module 316 can select a set from the requesting users 125 as participants for a game based on certain criteria. For example, the player control module 316 may allow the first 10 requesting users 125 to play the game and keep the following requesting users 125 waiting until the first 10 have done the game. In another example, the player control module 316 can select a set of participants for a playlist based on rules specified by the instructor 125 or creator 125 of the playlist. One skilled in the relevant art will recognize other criteria can be used by the player control module 316 to determine the set of participants for a game.

In one embodiment, the player control module 316 assigns participants 125 into groups. For example, the player control module 316 divides the participants 125 into sets of optimized size. For example, if there are 20 participants 125, the player control module 316 can group the participants 125 into three sets having six, seven and seven members, respectively. In one embodiment, the player control module 316 can cooperate with the robotic player module 318 to add one or more robotic players or computerized players into the groups. For example, the player control module 316 can add a robotic player into the group of 20 participants 125 to make it 21 and divide the 21 players into three sets, each having seven members.

The robotic player module 318 includes code and routines for generating robotic or computerized players. In one embodiment, the robotic player module 318 is a set of instructions executable by the processor 206. In another embodiment, the robotic player module 318 is stored in the memory 208 and is accessible and executable by the processor 206. In either embodiment, the robotic player module 318 is adapted for cooperation and communication with the processor 206, other components of the experimentation server 101a or 101b and other components of the interactive experimentation module 220.

In one embodiment, the robotic player module 318 can generate robotic or computerized players based on player behavior models. For example, the robotic player module 318 can analyze player behavior and determine a pattern or a model describing behavior of an average player. The robotic player module 318 can then generate a mimic robotic player based on the pattern or model. In another example, the robotic player module 318 cooperates with the game analytics module 324 to obtain the pattern or model describing behavior of an average player. In yet another example, the robotic player module 318 retrieves the pattern or model describing behavior of an average player from other servers, storage, or any other resources. In one embodiment, patterns or models can describe players with different attributes. For example, a variety of different patterns or models can describe a slow player, a reactive player, an aggressive play, a defensive player, an offensive player, etc. In one embodiment, the robotic player module 318 can generate different types of players based on the variety of different patterns or models.

The user interface module 320 includes code and routines for generating graphical data that can be used to provide user interfaces to client devices 115 of users 125. In one embodiment, the user interface module 320 is a set of instructions executable by the processor 206. In another embodiment, the user interface module 320 is stored in the memory 208 and is accessible and executable by the processor 206. In either embodiment, the user interface module 320 is adapted for cooperation and communication with the processor 206, other components of the experimentation server 101a or 101b and other components of the interactive experimentation module 220.

As described above, in one embodiment, the user interface module 320 cooperates with other sub-modules of the interactive experimentation module 220 to generate graphical data for providing user interfaces to client devices 115 of users 125. For example, the user interface module 320 cooperates with the account management module 304 to generate graphical data based on a request of creating an account for a user 125 and sends the graphical data to the client device 115, causing the client device 115 to present a user interface that allows the user 125 to input account information for creating the account. In another example, the user interface module 320 generates and sends graphical data to the client device 115, causing the client device 115 to present a user interface that allows the user 125 to input parameter values for configuration of a game.

The interactive game module 322 includes code and routines for allowing users 125 to play game interactively. In one embodiment, the interactive game module 322 is a set of instructions executable by the processor 206. In another embodiment, the interactive game module 322 is stored in the memory 208 and is accessible and executable by the processor 206. In either embodiment, the interactive game module 322 is adapted for cooperation and communication with the processor 206, other components of the experimentation server 101a or 101b and other components of the interactive experimentation module 220.

In one embodiment, the interactive game module 322 determines an instance of a game in a playlist and cooperates with the user interface module 320 to provide the instance of the game for users 125 to play with. In one embodiment, the interactive game module 322 also receives inputs from the participants of the game and provides a next session of the game based on the inputs. In one embodiment, the interactive game module 322 generates feedback based on inputs of a first participant and sends the feedback to a second participant so that the first and second participants can play the game interactively. In one embodiment, the interactive game module 322 cooperates with the result management module 314 to generate instantaneous results based on the playing of the game.

The game analytics module 324 includes code and routines for analyzing games. In one embodiment, the game analytics module 324 is a set of instructions executable by the processor 206. In another embodiment, the game analytics module 324 is stored in the memory 208 and is accessible and executable by the processor 206. In either embodiment, the game analytics module 324 is adapted for cooperation and communication with the processor 206, other components of the experimentation server 101a or 101b and other components of the interactive experimentation module 220.

In one embodiment, the game analytics module 324 receives game data including configuration of the game, inputs of the participants to the game, outputs during middle stages of the game, result data describing results of the game, profiles for the participants of the game and any other data associated with the game and the participants for the game, and analyzes the game data to determine behavior data describing user behavior during the game. In one embodiment, the game analytics module 324 also identifies bias in the game based on the analysis of the game data so that the bias can be used later to adjust the model of the game. In one embodiment, the game analytics module 324 also uses the analysis of the game to determine if there are any technological issues associated with the game and obtain better understanding of the game, etc.

In one embodiment, the game analytics module 324 uses demographic data (e.g., age, gender, race, residence, etc.) in the profile for participants to analyze user behavior in games. For example, the game analytics module 324 analyzes the user behavior by partitioning the game results based on the demographic data. For example, the game analytics module 324 can determine race as a factor or attribute and analyze user behavior of participants with different race. For example, the game analytics module 324 may determine that Asian do well at trust games but poor at bargaining games; etc. One skilled in the relevant art will recognize that any demographic characteristic can be used to partition, analyze and process the results of games.

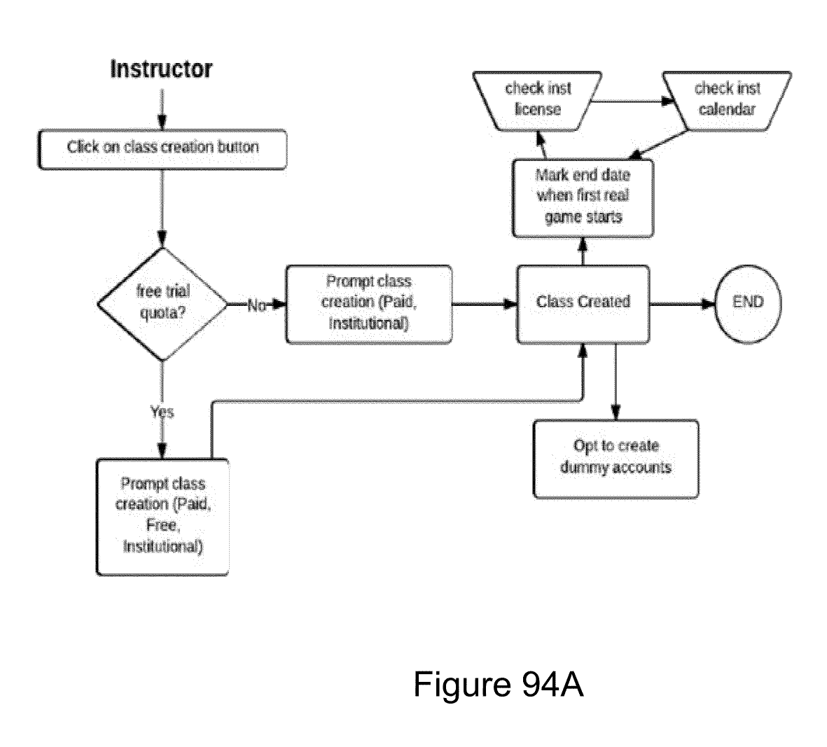

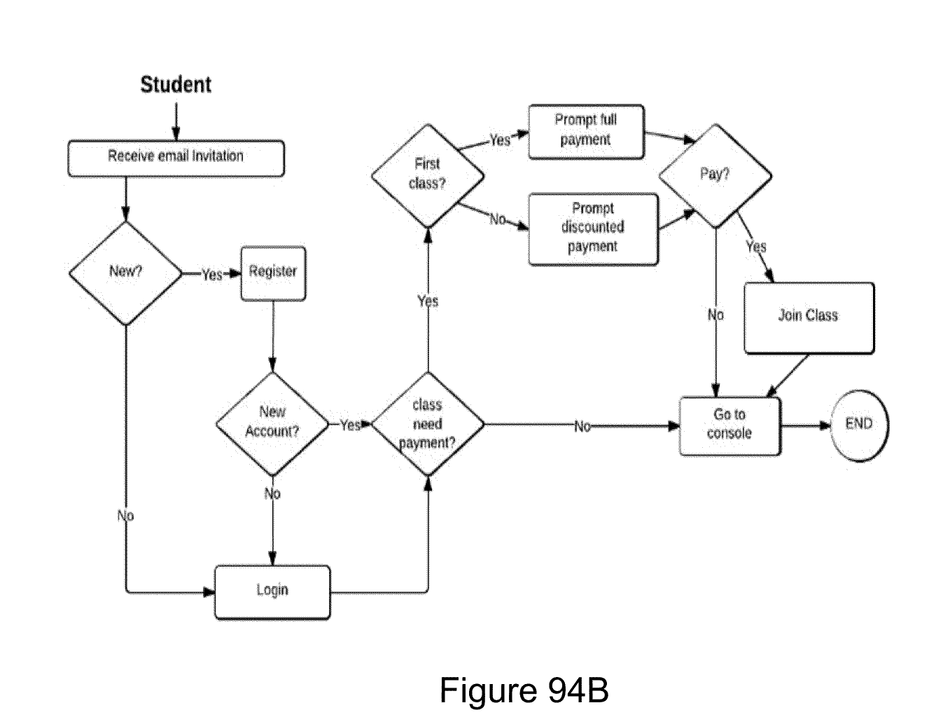

The monetization module 326 includes code and routines for monetizing the playlists of games. In one embodiment, the monetization module 326 is a set of instructions executable by the processor 206. In another embodiment, the monetization module 326 is stored in the memory 208 and is accessible and executable by the processor 206. In either embodiment, the monetization module 326 is adapted for cooperation and communication with the processor 206, other components of the experimentation server 101a or 101b and other components of the interactive experimentation module 220. One embodiment of a payment process is described below in Appendix A and referenced in FIGS. 94A and 94B.

In one embodiment, the monetization module 326 generates a marketplace where users 125 can purchase products included in the market place. For example, the products include ebooks, software products, hardware products, videos, written publications, etc., associated with the playlists of games. The products can be free or paid-for resources. For example, the marketplace provides a software product of a game including an access to a link to purchase the software product. In another example, the marketplace includes software of a game that can be downloaded for free as long as an account is provided. In one embodiment, the monetization module 326 rewards users 125 who rank high in a game. For example, if a user 125 plays well with a game and ranks the top one among other users 125, the monetization module 326 determines a reward for the user 125.

The socialization module 328 includes code and routines for allowing users 125 to share classes and playlists. In one embodiment, the socialization module 328 is a set of instructions executable by the processor 206. In another embodiment, the socialization module 328 is stored in the memory 208 and is accessible and executable by the processor 206. In either embodiment, the socialization module 328 is adapted for cooperation and communication with the processor 206, other components of the experimentation server 101a or 101b and other components of the interactive experimentation module 220.

In one embodiment, the socialization module 328 generates a social community where users 125 can share with other users 125 classes and playlists of games that they created. For example, the socialization module 328 cooperates with the user interface module 320 to provide user interfaces that allows users 125 to share classes and playlists with other users 125 through email, messaging, blog, microblog, social network, etc. In one embodiment, the socialization module 328 also allows users 125 to connect to other users 125 and construct a social graph for users 125 that describes how the users are connected to each other. In this way, the socialization module 328 can provides a list of connections for a user 125 when the user 125 wants to share a class or playlist of games to others 125.

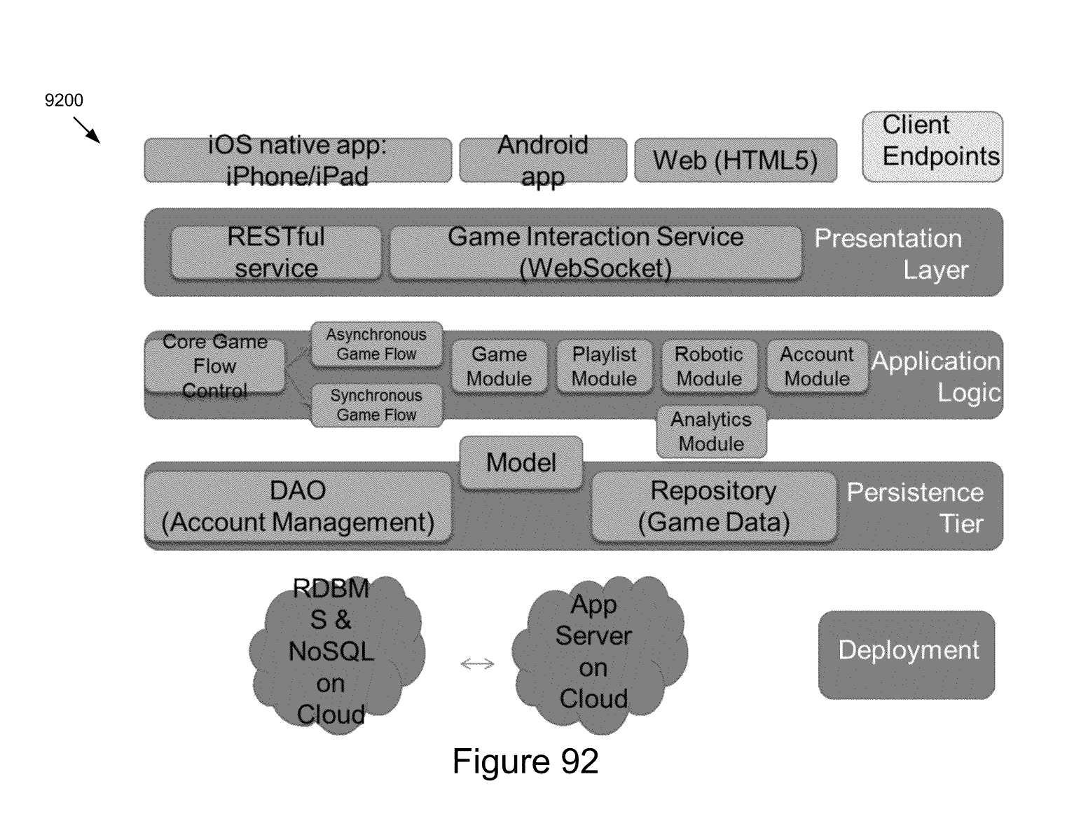

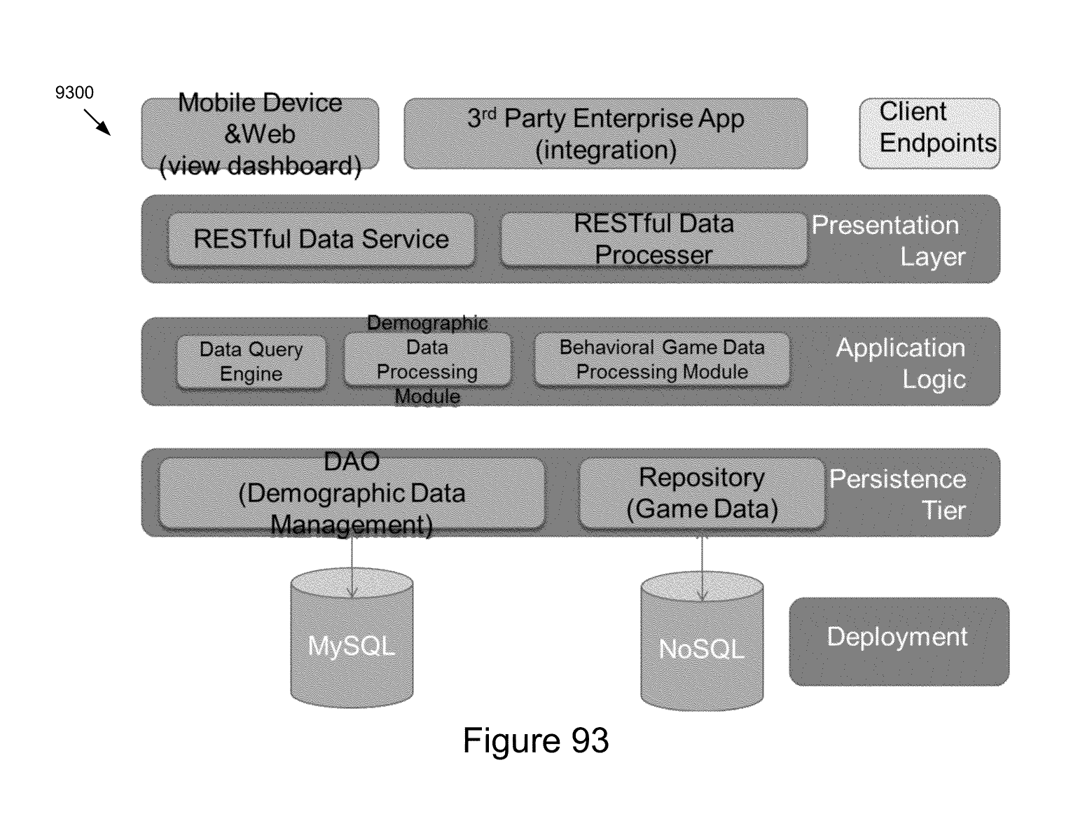

FIG. 92 is a block diagram illustrating an architecture for another embodiment of the system 100 that provides interactive experimentations to users 125. FIG. 93 is a block diagram illustrating an architecture for a data service included in the system 100 that provides interactive experimentations to users 125. Additional embodiments of the system 100 of the present disclosure and further features and functions are disclosed below in Appendices B and C.

### Example Processes

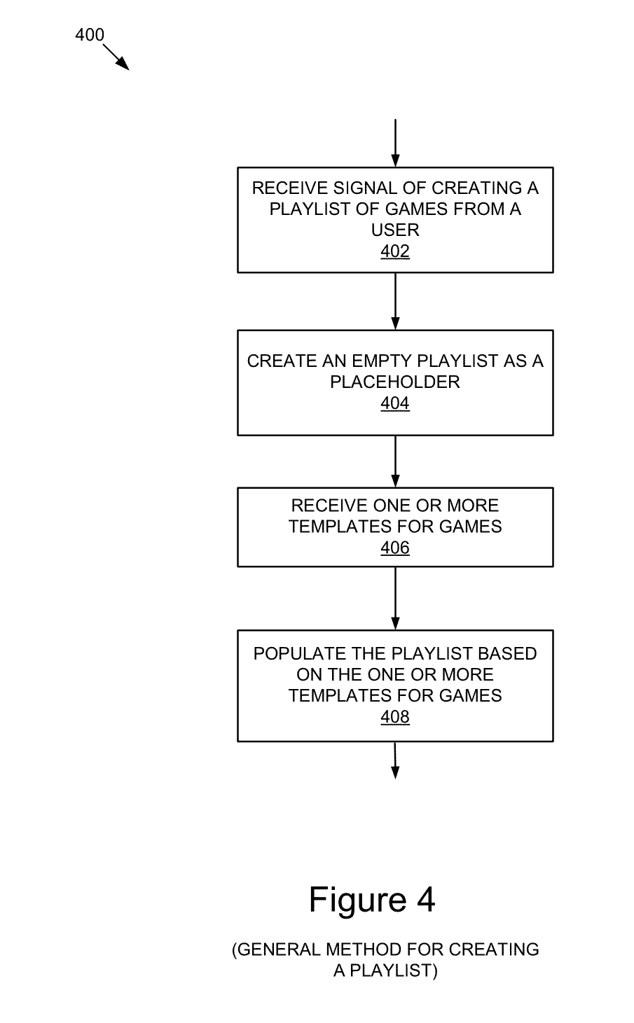

FIGS. 4, 5, 6, 7A-7C, 8 and 9A-B depict various methods 400, 500, 600, 700, 800, 900, 950 performed by the system described above in reference to FIGS. 1A, 1B, 2A, 2B and 3.

FIG. 4 is a flow chart illustrating a method 400 for creating a playlist of games according to one embodiment. In the illustrated embodiment, the method 400 can include receiving 402 signal of creating a playlist of games from a user 125. For example, when a user 125 indicates through a user interface that the user 125 wants to create a playlist of games, the playlist creation module 308 receives a signal of creating a playlist of games via the network 105 and the communication interface 302. The method 400 can include creating 402 an empty playlist as a placeholder. For example, the playlist creation module 308 creates an empty playlist based up the request. The method 400 can also include receiving 406 one or more templates for games. For example, the playlist creation module 308 receives one or more templates for games from the template server 107 for creating games. The method 400 can include populating 408 the playlist based on the one or more templates for games. For example, the playlist creation module 308 populates the empty playlist based on the one or more templates for games.

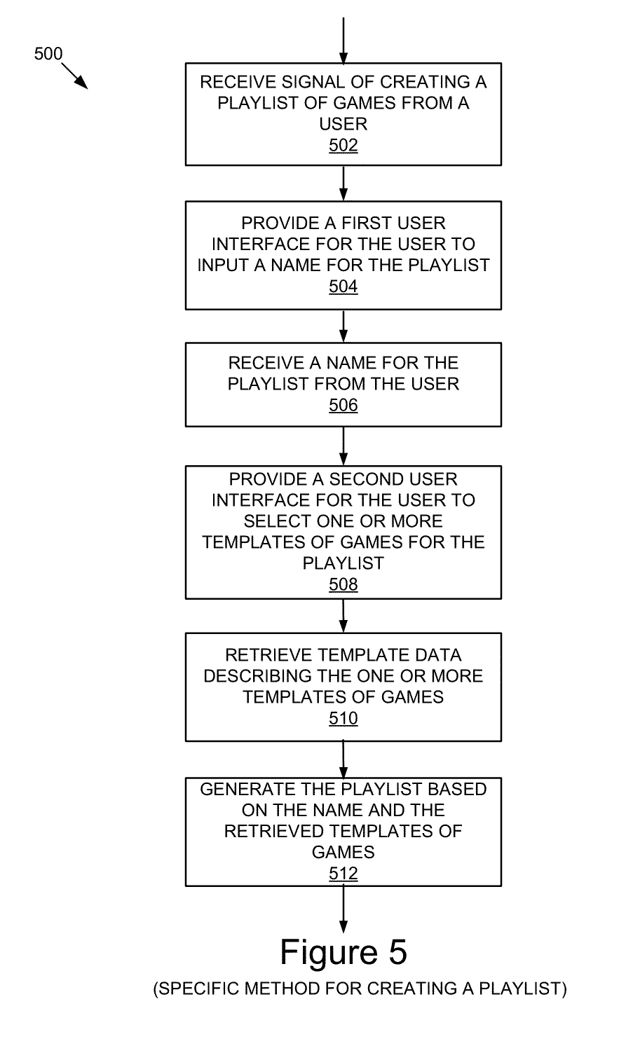

FIG. 5 is a flow chart illustrating a method 500 for creating a playlist of games according to another embodiment. In the illustrated embodiment, the method 500 can include receiving 502 signal of creating a playlist of games from a user 125. For example, as described with reference to FIG. 4, when a user 125 indicates through a user interface that the user 125 wants to create a playlist of games, the playlist creation module 308 receives a signal of creating a playlist of games via the network 105 and the communication interface 302. The method 500 can also include providing 504 a first user interface for the user 125 to enter a name for the playlist. The method 500 can include receiving 506 a name for the playlist from the user 125. For example, the playlist creation module 308 cooperates with the user interface module 320 to provide a dialog box that allows the user 125 to input a name for the playlist, as depicted in FIG. 10. Once the user 125 inputs a name and submits it, the playlist creation module 308 receives the name for the playlist.

The method 500 can include providing 508 a second user interface for the user 125 to select one or more templates of games for the playlist. For example, the playlist creation module 308 cooperates with the user interface module 320 to provide a list from which the user 125 can select one or more templates of games. The method 500 can also include retrieving 510 template data describing the one or more templates of games. For example, the playlist creation module 308 retrieves template data from the template server 107 describing one or more templates of games. The method 500 can include generating 512 the playlist based on the name and the retrieved templates of games. For example, based on the retrieved template data, the playlist creation module 308 generates a playlist of games.

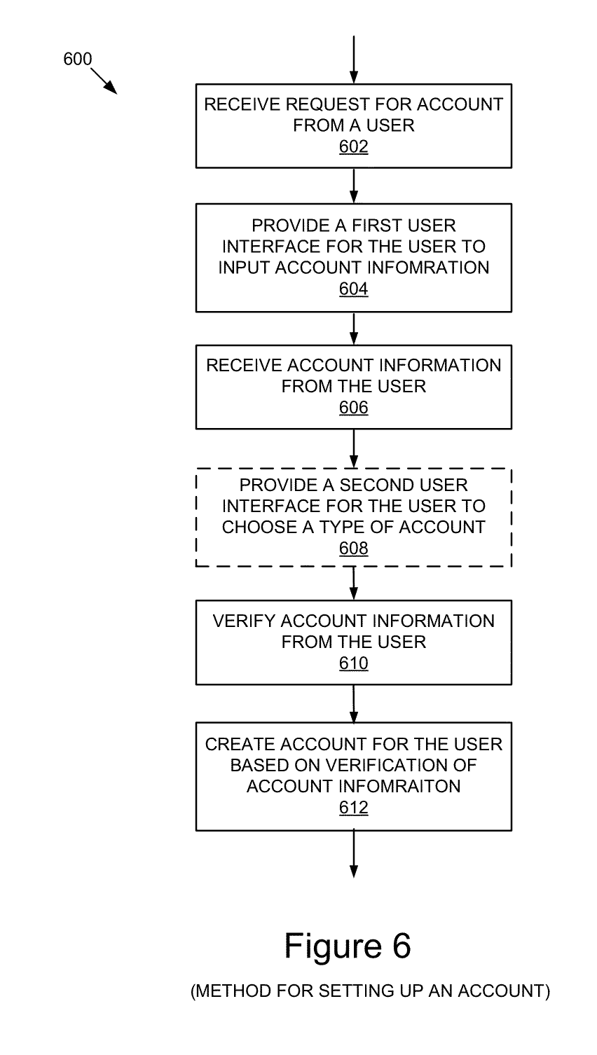

FIG. 6 is a flow chart illustrating a method 600 for setting up an account for a user 125 according to one embodiment. In the illustrated embodiment, the method 600 can include receiving 602 a request for an account from a user 125. For example, when a user 125 indicates through a user interface that the user 125 wants to register an account with the online interactive lab system 101a or 101b, the account management module 304 receives a request indicating that the user 125 is willing to have an account with the system 101a or 101b. The method 600 can also include providing 604 a first user interface for the user 125 to enter account information. For example, upon receiving the request for registration of an account, the account management module 304 cooperates with the user interface module 320 to provide a user interface that requires the user 125 to input account information. For example, the account information can include a name, a password, an age, a gender, a school, a year of school, a race, a major in school, an address, etc. So the account management module 304 can register the user 125 with the system 101a or 101b using an account and creates a profile for the user 125 based on the account information.

The method 600 can also include providing 608 a second user interface for the user 125 to choose a type of account. Though the step 608 can be an optional step for the method 600, this step provides the user 125 an opportunity to choose a type for the account. For example, the user interface may allow the user 125 to choose from a student account, an instructor account, a basic account, a premium account, an advanced account, etc. The account management module 304 can assign the user 125 different privileges based on the different types of account once the account management module 304 determines that the user 125 is qualified for the type of account the user 125 chooses. The method 600 can also include verifying 610 account information input by the user 125 and creating 612 an account for the user 125 based on the verification of the account information. For example, the account management module 304 verifies the account information through another server or system and if the account information is verified, the account management module 304 creates an account and generates a profile for the user 125 based on the account information and the type of the account. The profile can later be used as data for analyzing user behaviors and generating demographic data.

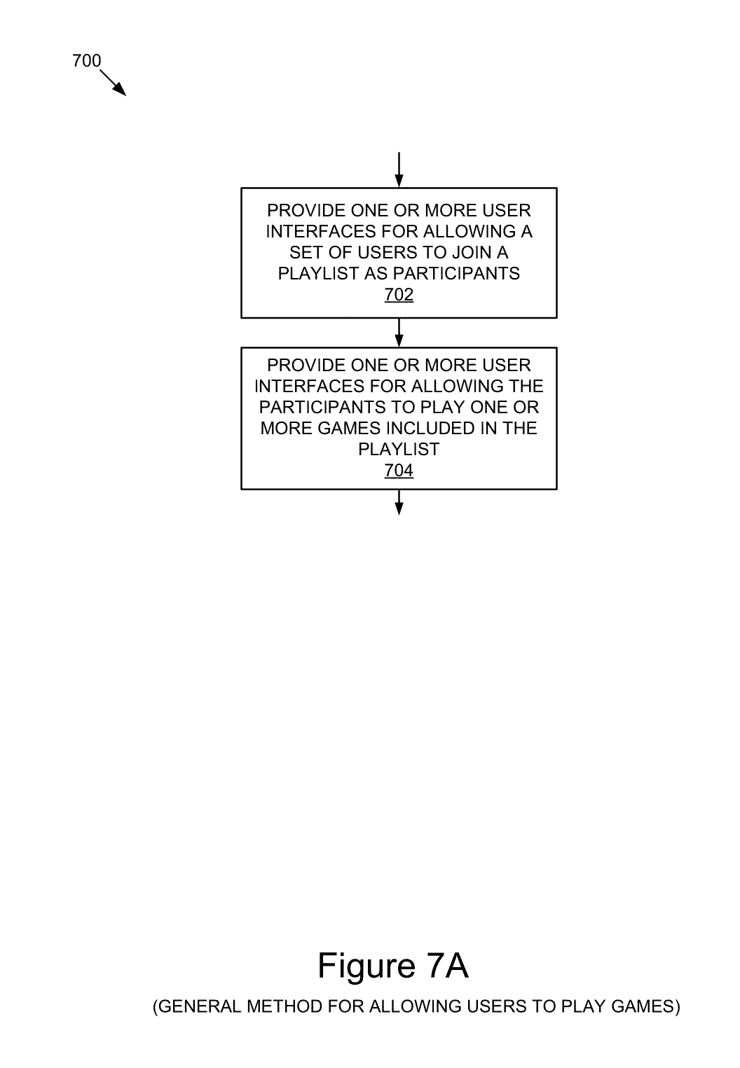

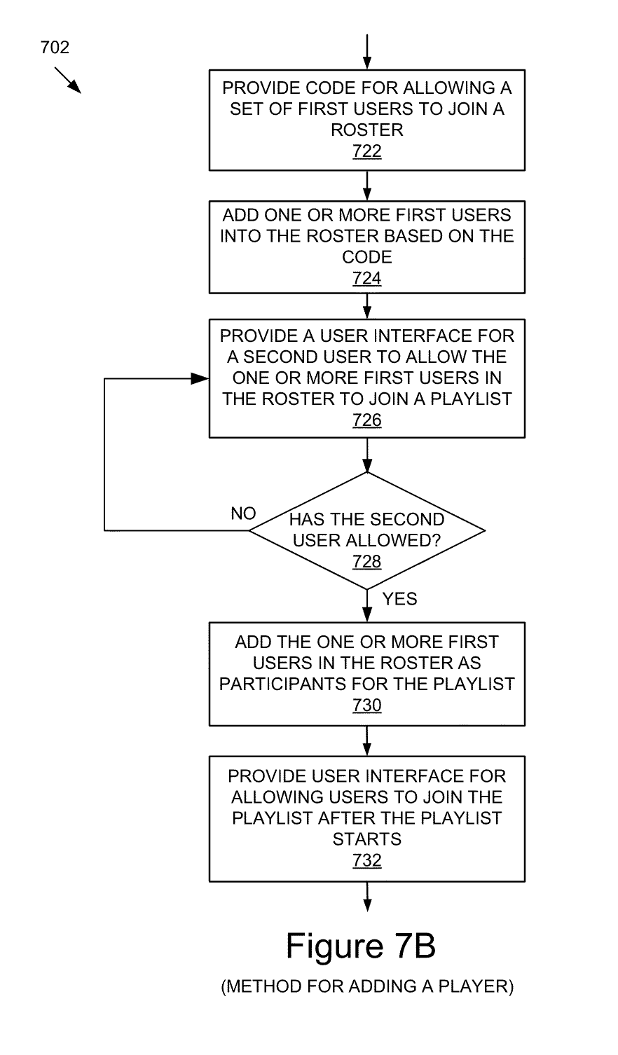

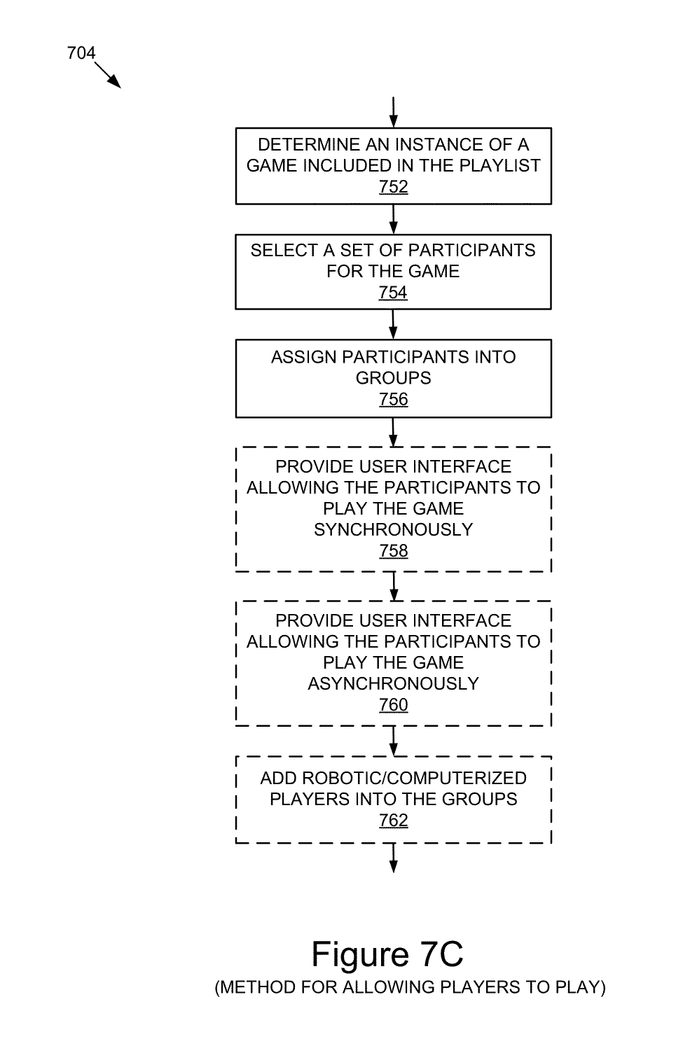

FIG. 7A is a flow chart illustrating a method 700 for allowing users 125 to play games in a playlist according to one embodiment. In the illustrated embodiment, the method 700 can include providing 702 one or more user interfaces for allowing a set of users 125 to join a playlist as participants. The step 702 will be described in further detail below with reference to FIG. 7B. The method 700 can also include providing 704 one or more user interfaces for allowing the participants to play one or more games included in the playlist. The step 704 will be described in further detail below with reference to FIG. 7C.

FIG. 7B is a flow chart illustrating a method 702 for allowing users 125 to join a playlist as participants according to one embodiment. In the illustrated embodiment, the method 702 can include providing 722 a code for allowing a set of first users 125 to join a roster. For example, the class management module 306 can provide a class code and by using this code users 125 can join a class and register with the roster of the class. The method 702 can also include adding one or more first users 125 into the roster based on the code. For example, when one or more first users 125 input the code, the class management module 306 can add the one or more first users 125 into the roster. In another embodiment, the class management module 306 can allow an instructor (or creator) 125 of the class to add one or more first user 125 to the roster of the class. For example, the class management module 306 allows the instructor of the class to upload information of one or more first users 125 (e.g., students of the class) to the system 101a or 101b and the class management module 306 adds the one or more first users 125 into the roster.

The method 702 can also include providing 726 a user interface for a second user 125 to allow the one or more first users 125 in the roster to join a playlist. For example, the player control module 316 cooperates with the user interface module 320 to provide a button clickable for the instructor 125 of the class to allow students to join the playlist. The method 702 can also include determining 728 if the second user 125 has allowed the one or more first users 125 to join the playlist. For example, the player control module 316 can keep tracking if the instructor 125 has clicked the button to allow students 125 to join the playlist. If the second user 125 has allowed the one or more first users 125 to join the playlist, the method 702 can include adding 730 the one or more first users 125 in the roster as participants for the playlist. For example, when the instructor 125 clicks the button to allow the one or more first users 125 to join the playlist, the one or more first users 125 can be notified through a user interface that the playlist is ready to join. If any of the one or more first users 125 indicates to join through the user interface, the player control module 316 adds the user 125 to the playlist as participant.

If the second user 125 has not allowed the one or more first users 125 to join the playlist, the method 702 proceeds back to the last step of keeping providing 706 the user interface for the second user 125 to allow the one or more first users 125 in the roster to join the playlist. The method 702 can also include providing 732 a user interface for allowing users 125 to join the playlist after the playlist starts. For example, after the player control module 316 adds one or more of the first users 125 as participants to the playlist, the player control module 316 can control the interactive game module 322 to let the one or more of the first users 125 to play games in the playlist. For example, the player control module 316 can allow the second user 125 (e.g., the instructor of the class) to start a game in the playlist. When the second user 125 starts the game through a user interface, the player control module 316 can control the interactive game module 322 to allow the one or more of the first users 125 to start playing the games in the playlist. After the one or more of the first users 125 start to play the games in the playlist, the player control module 316 can still allow more first users 125 to join the playlist and play the games.

FIG. 7C is a flow chart illustrating a method 704 for allowing users 125 to play games in the playlist according to one embodiment. In the illustrated embodiment, the method 704 can include determining 752 an instance of a game included in the playlist. For example, the interactive game module 322 determines an instance of a game in the playlist for participants to play. The method 704 can also include selecting 754 a set of participants for the game. For example, the player control module 316 can select a set of participants based upon if the one or more first users 125 have joined the playlist. The method 704 can include assigning 756 participants into groups. For example, the player control module 316 can divide the participants into groups and cooperates with the interactive game module 322 to let the groups compete in the games.

The method 704 can include either providing 758 a user interface allowing the participants to play the game synchronously or providing 760 a user interface allowing the participants to play the game asynchronously. For example, the player control module 316 can allow users 125 to join and play the game any time before or after the game starts playing. The method 704 can also optionally include adding 762 robotic/computerized players into the groups. For example, the player control module 316 can control the robotic player module 318 to generate the one or more robotic/computerized players and add the robotic/computerized players into the groups of participants.

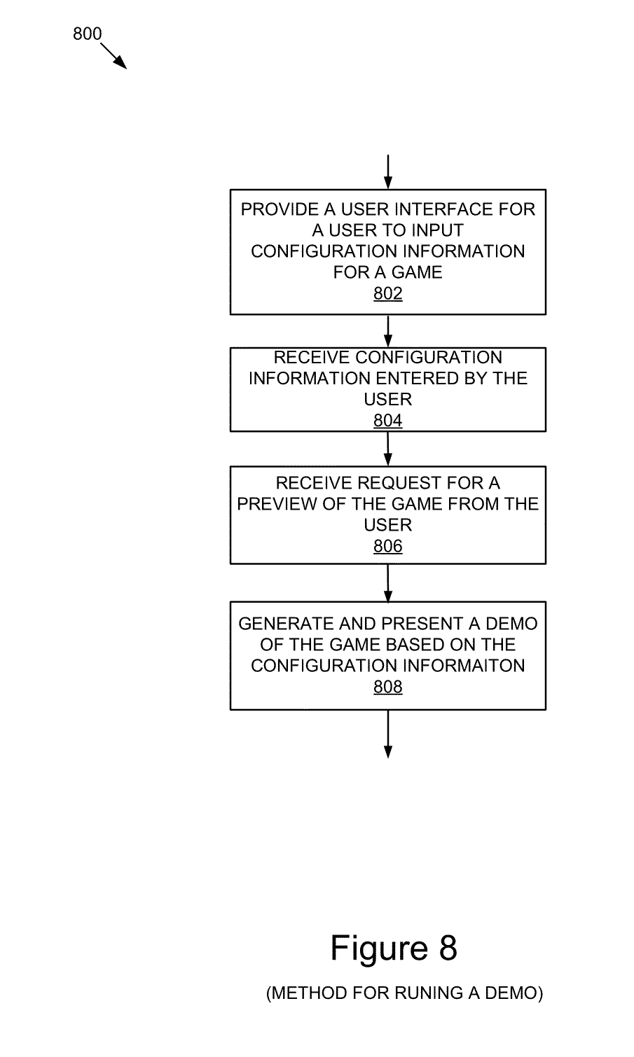

FIG. 8 is a flow chart illustrating a method 800 for running a demo of a game according to one embodiment. In the illustrated embodiment, the method 800 can include providing 802 a user interface for a user 125 to input configuration information for a game. For example, the game configuration module 310 cooperates with the user interface module 320 to provide one or more input boxes for the user 125 to input parameter values for configuring the game. The method 800 can also include receiving 804 configuration information entered by the user 125. For example, the game configuration module 310 receives the parameter values set by the user 125 through the input boxes. The method 800 can include receiving 806 a request for a preview of the game from the user 125 and generating and presenting 808 a demo of the game based on the configuration information. For example, when the user 125 indicates through the user interface that the user 125 wants to preview the game, the demo generation module 312 receives a request indicating that the user 125 is willing to preview the game and then generates a demo of the game based on the configuration. The demo generation module 312 can also present the demo of the game to the user 125.

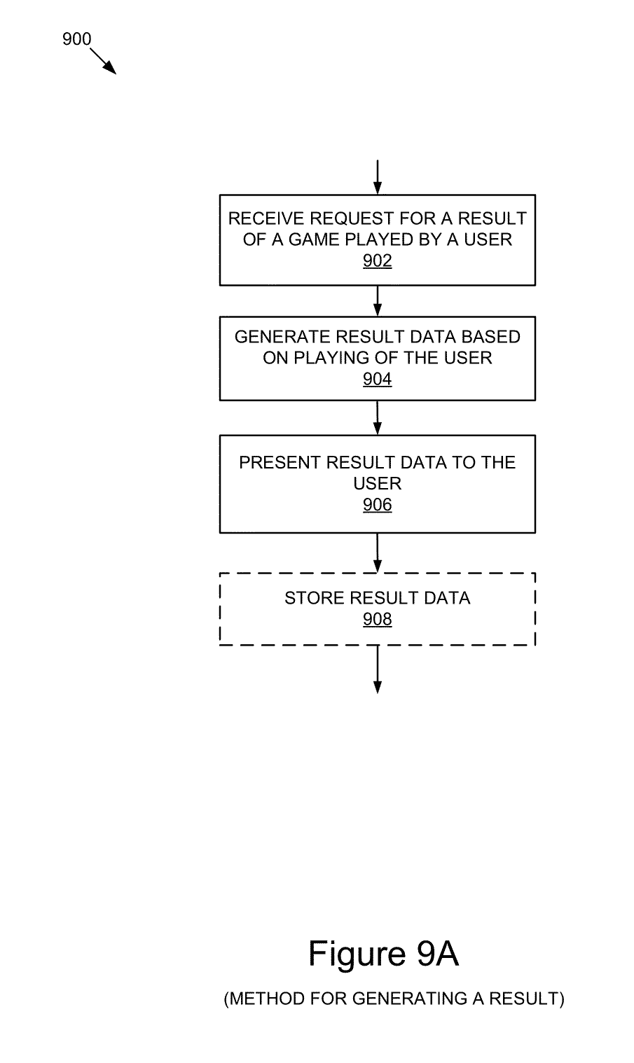

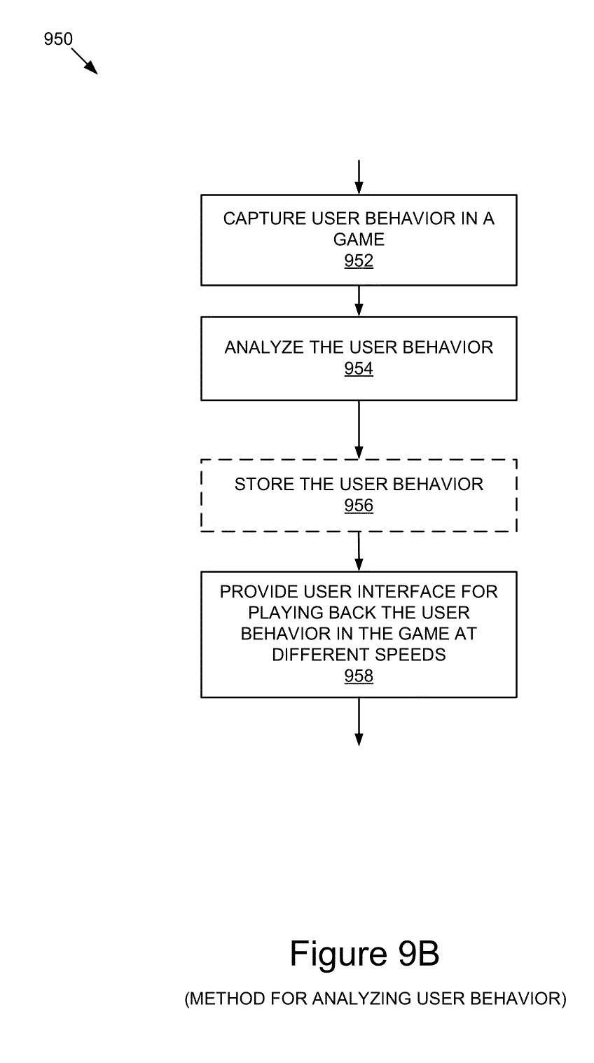

FIG. 9A is a flow chart illustrating a method 900 for generating a result of a game according to one embodiment. In the illustrated embodiment, the method 900 can include receiving 902 a request for a result of a game played by a user 125. For example, when a user 125 finish playing a game, the user 125 may want to see a result. The result management module 314 can cooperate with the user interface module 320 to provide a user interface through which the user 125 can order a result of the game. The result management module 314 can receive a request if the user 125 orders the result of the game through the user interface. The method 900 can also include generating 904 result data based on playing of the user 125 and presenting 906 the result data to the user 125. For example, the result data can be used to show a result graph or description to the user 125. The method 900 can also optionally include storing 908 the result data.

FIG. 9B is a flow chart illustrating a method 950 for analyzing user behavior in games according to one embodiment. In the illustrated embodiment, the method 950 can include capturing 952 user behaviors in a game. For example, the game analytics module 324 captures user behavior when users 125 play a game. The method 950 can also include analyzing 954 the user behavior and storing 956 the user behavior. For example, the game analytics module 324 can analyze captured user behavior, generate statistical analysis data describing the user behavior and store the analysis data. The method 950 can include providing 958 a user interface for playing back the user behavior in the game at different speeds. For example, the game analytics module 324 can cooperate with the user interface module 320 to provide a user interface through which the user 125 can play back the played game at the original speed or a higher speed, e.g., two times speed, three times speed, etc.

### Example Graphical Representations

FIG. 10 is a graphical representation illustrating a user interface 1000 allowing users 125 to create a class according to one embodiment. In the illustrated embodiment, the user interface 1000 requests users 125 to input a class name.

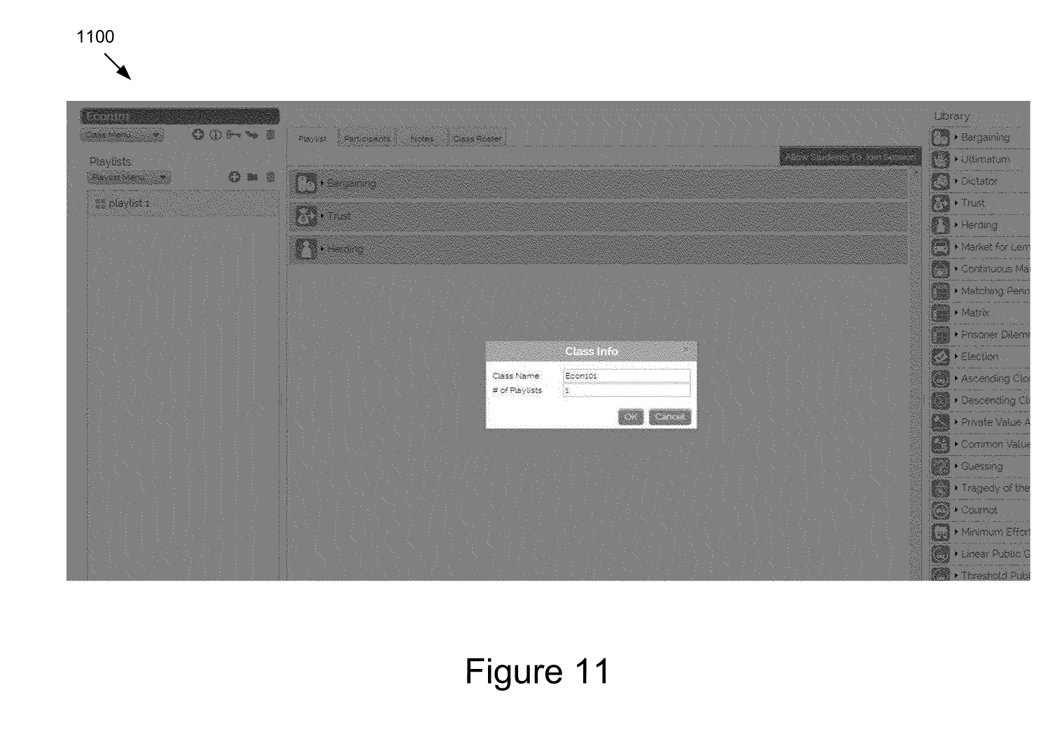

FIG. 11 is a graphical representation illustrating a user interface 1100 for displaying class information to users 125 according to one embodiment. In the illustrated embodiment, the user interface 1100 allows users 125 to review and modify class information (e.g., a class name, the number of playlists in the class, etc.) for a class.

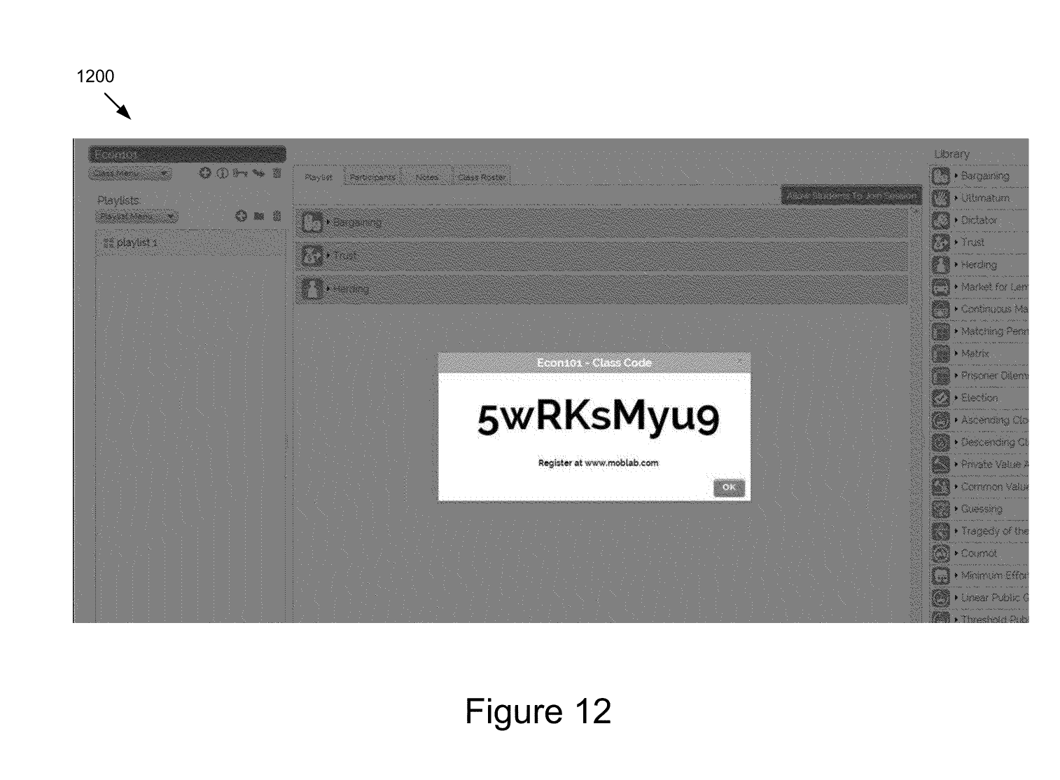

FIG. 12 is a graphical representation illustrating a user interface 1200 for displaying a class code to a user 125 according to one embodiment.

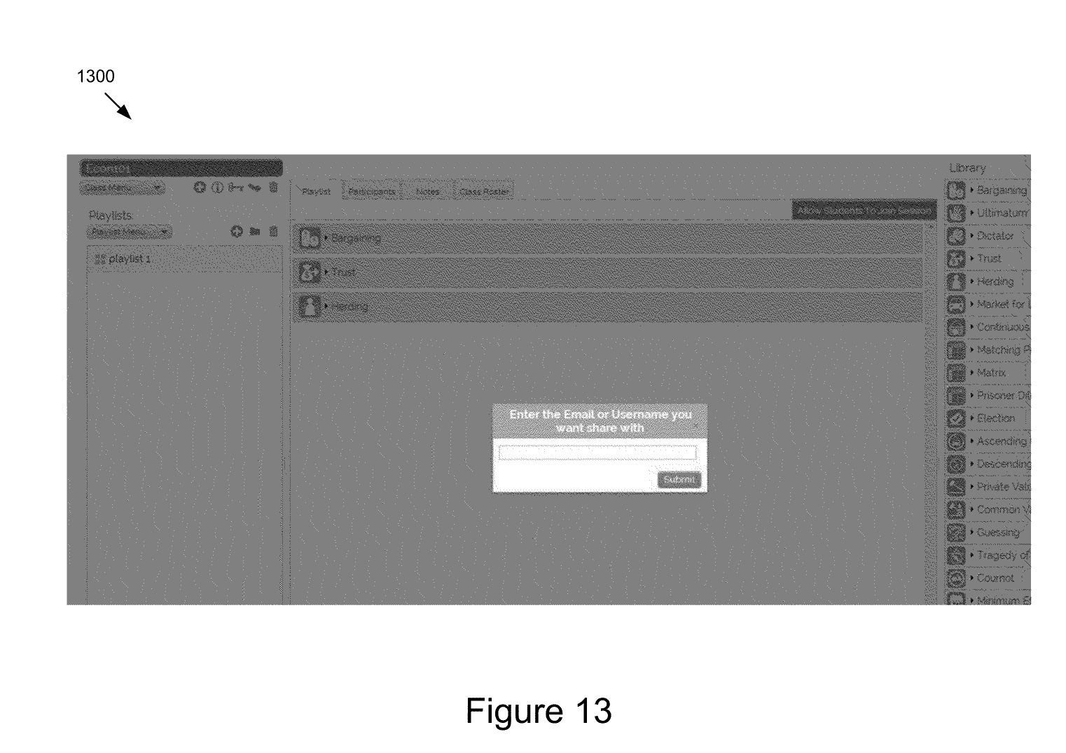

FIG. 13 is a graphical representation illustrating a user interface 1300 allowing users 125 to share a class with other users 125 according to one embodiment. In the illustrated embodiment, the user interface 1300 allows a user 125 to input the email or username of another user 125 to be shared with.

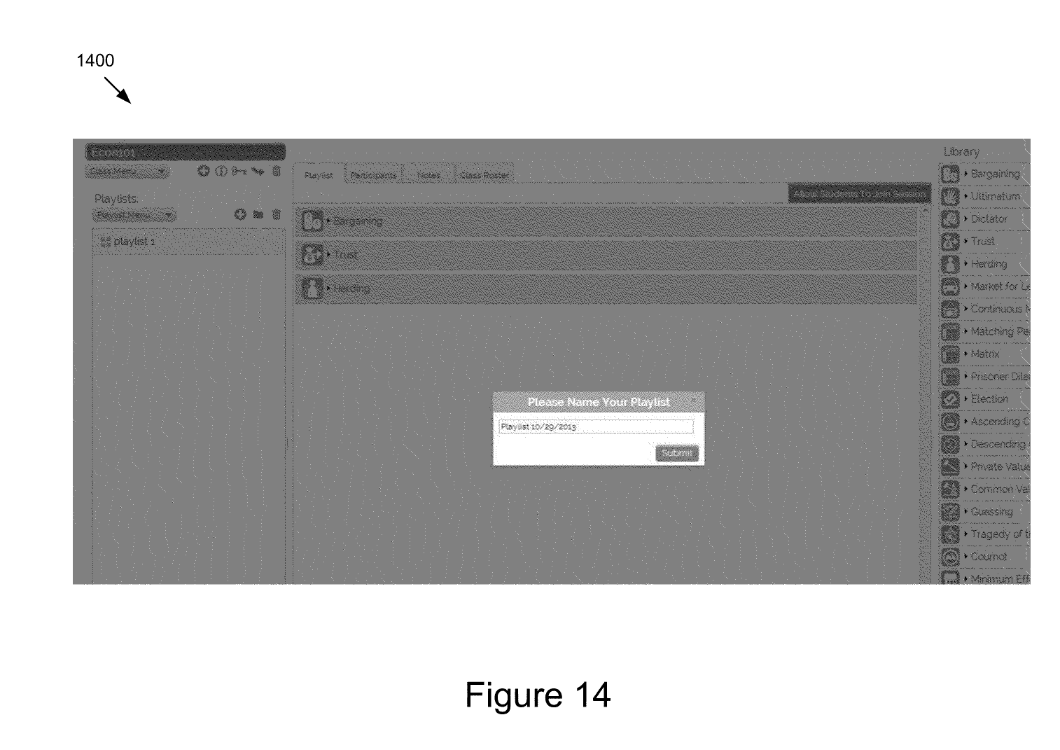

FIG. 14 is a graphical representation illustrating a user interface 1400 for creating a playlist for users 125 according to one embodiment. In the illustrated embodiment, the user interface 1400 allows the users 125 to input a name for the playlist to be created.

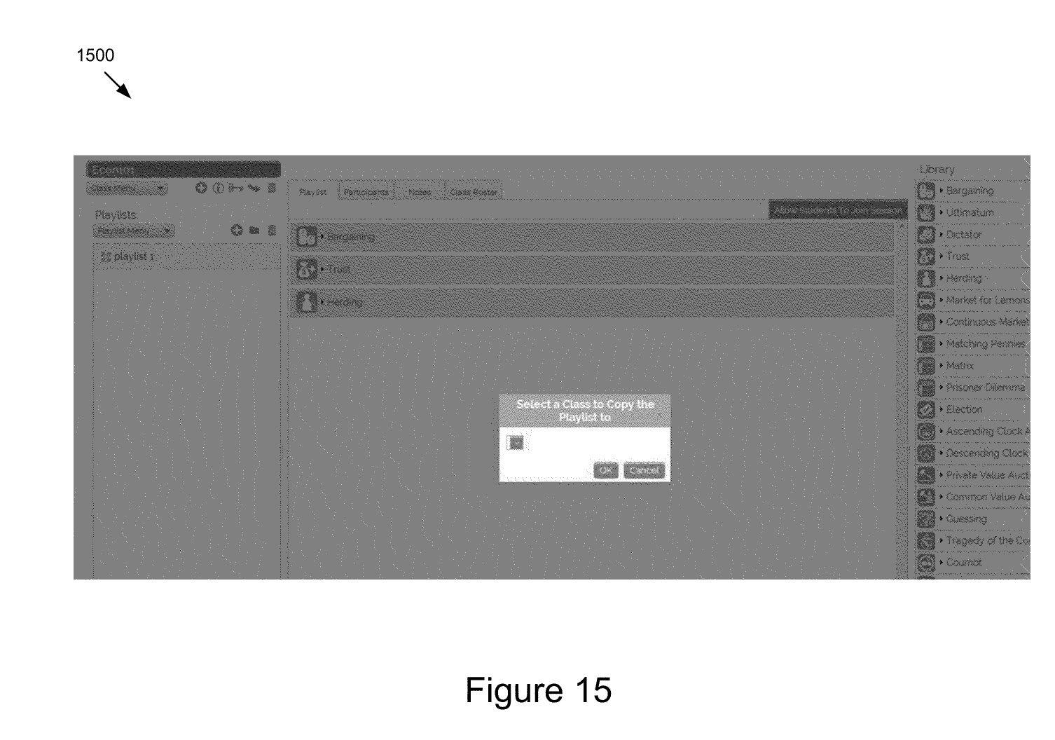

FIG. 15 is a graphical representation illustrating a user interface 1500 for copying a playlist to a class according to one embodiment. In the illustrated embodiment, the user interface 1500 allows users 125 to input a class to copy a playlist to.

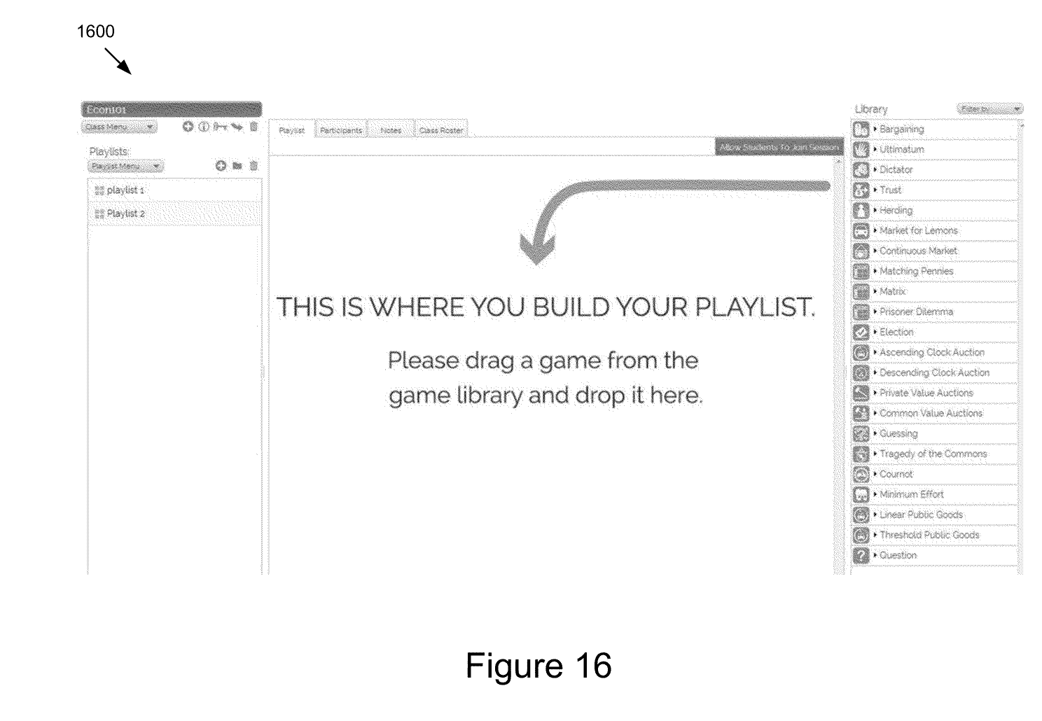

FIG. 16 is a graphical representation illustrating a user interface 1600 for displaying instructions about how to populate a playlist according to one embodiment.

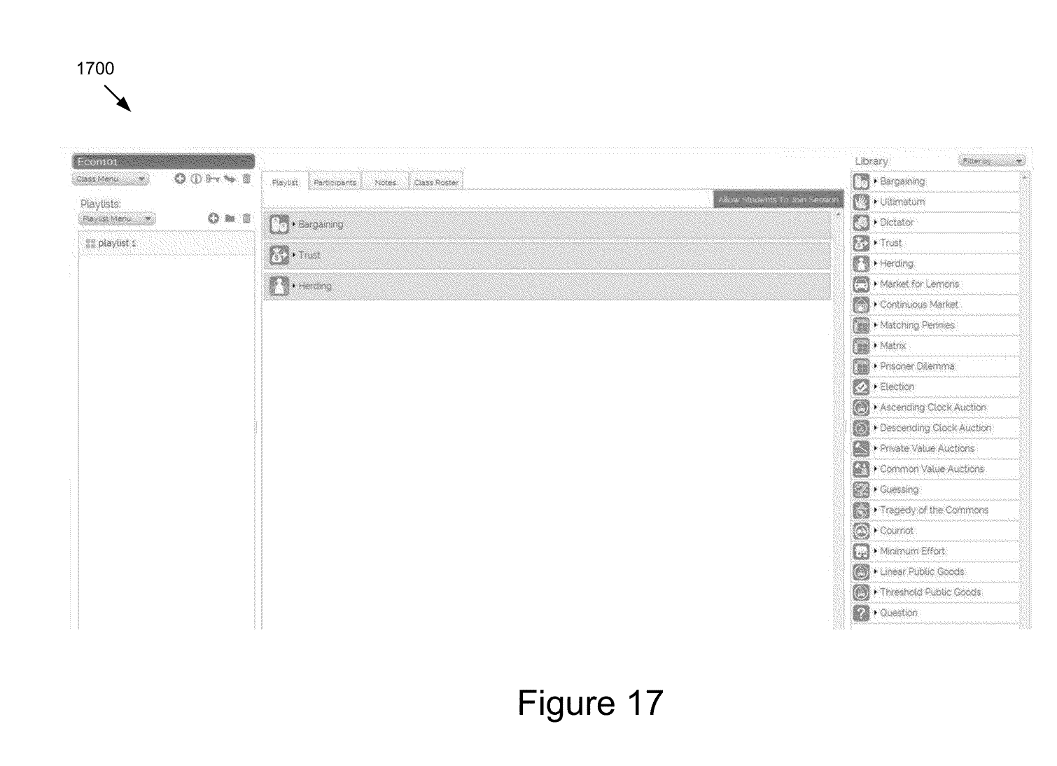

FIG. 17 is a graphical representation illustrating a user interface 1700 for displaying a created playlist according to one embodiment. In the illustrated embodiment, the user interface 1700 displays the playlist that includes one or more games (e.g., a Bargaining game, a Trust game and a Herding game).

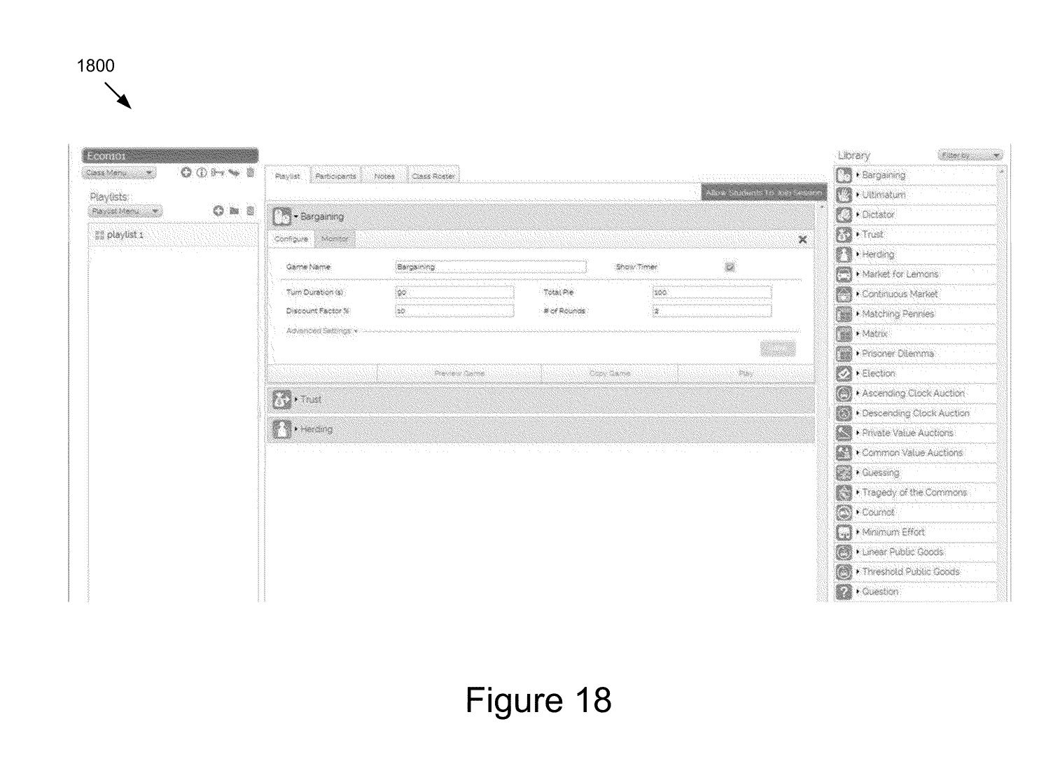

FIG. 18 is a graphical representation illustrating a user interface 1800 for displaying a configuration setting for a Bargaining game according to one embodiment. In the illustrated embodiment, the user interface 1800 allows users 125 to enter parameter values for configuring the Bargaining game.

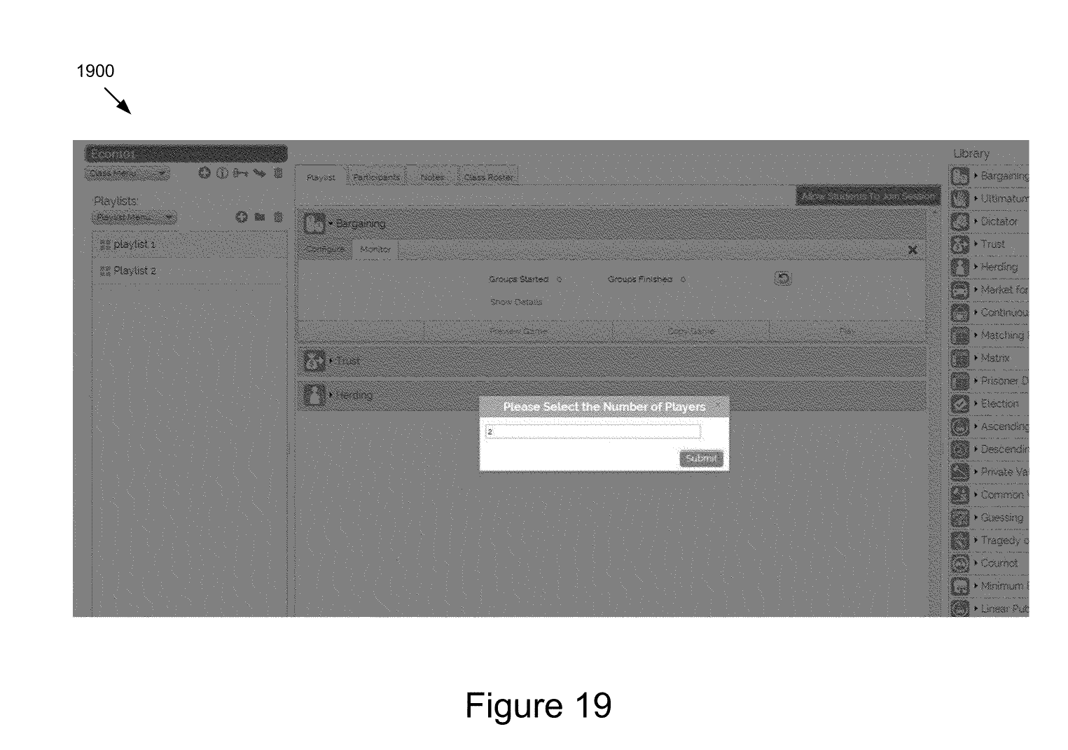

FIG. 19 is a graphical representation illustrating a user interface 1900 for requesting a user 125 to input the number of players that the user 125 wants to play with in a demo of a game according to one embodiment.

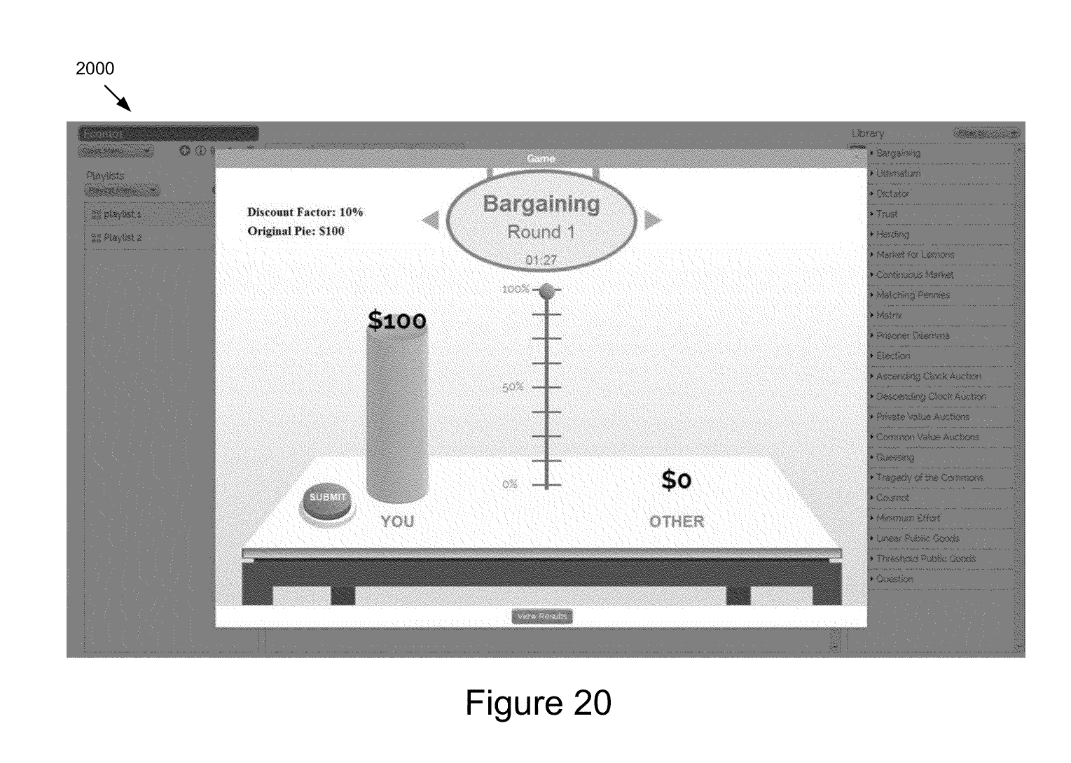

FIG. 20 is a graphical representation illustrating a user interface 2000 for displaying a demo of the Bargaining game according to one embodiment.

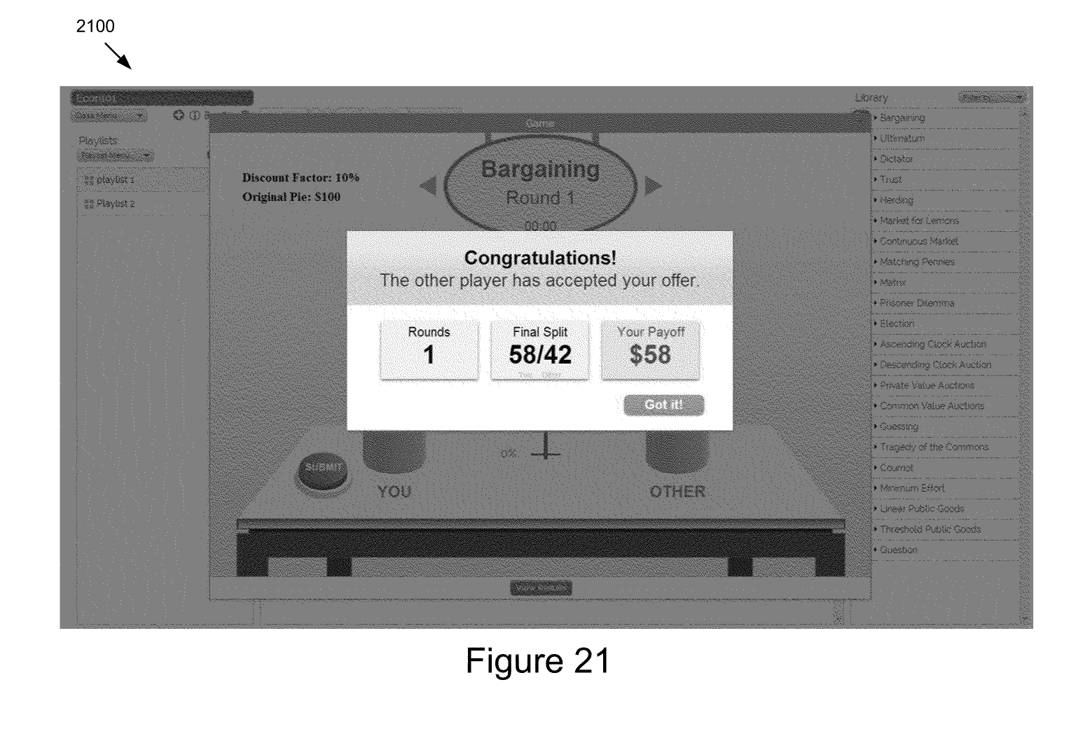

FIG. 21 is a graphical representation illustrating a user interface 2100 for displaying a result of the demo of the Bargaining game according to one embodiment.

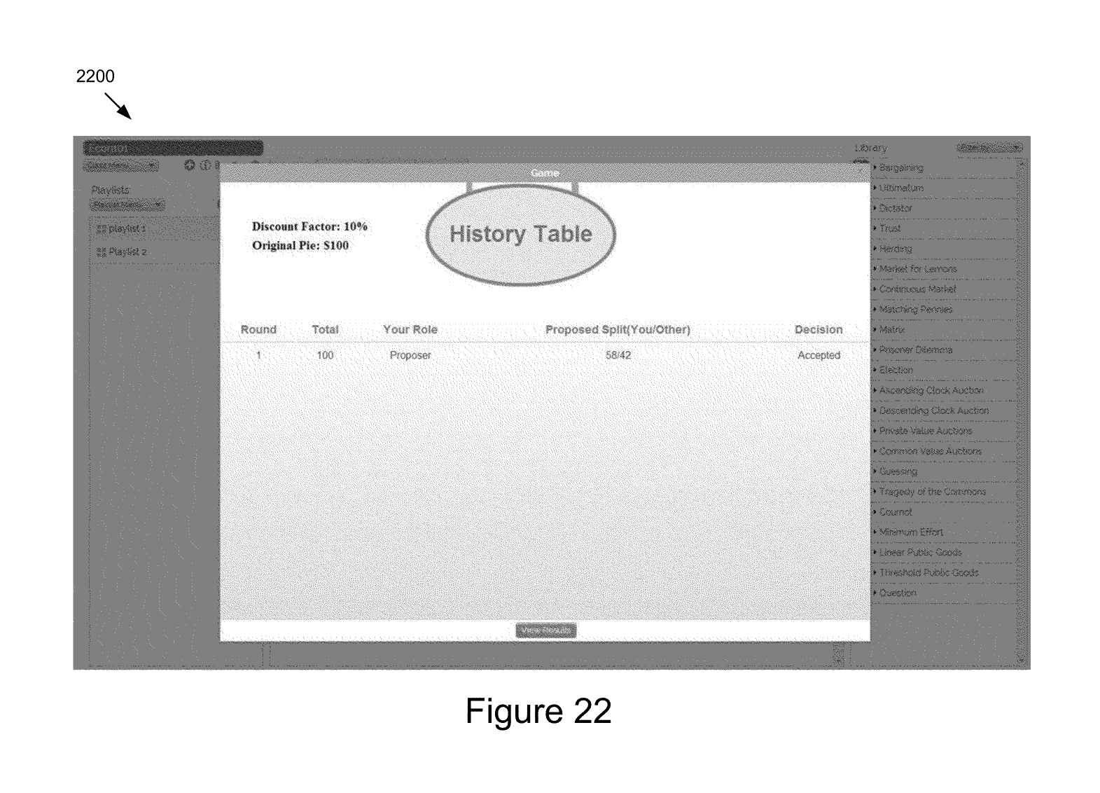

FIG. 22 is a graphical representation illustrating a user interface 2200 for displaying a summary of the demo for the Bargaining game according to one embodiment. In the illustrated embodiment, the user interface 2200 includes a history table.

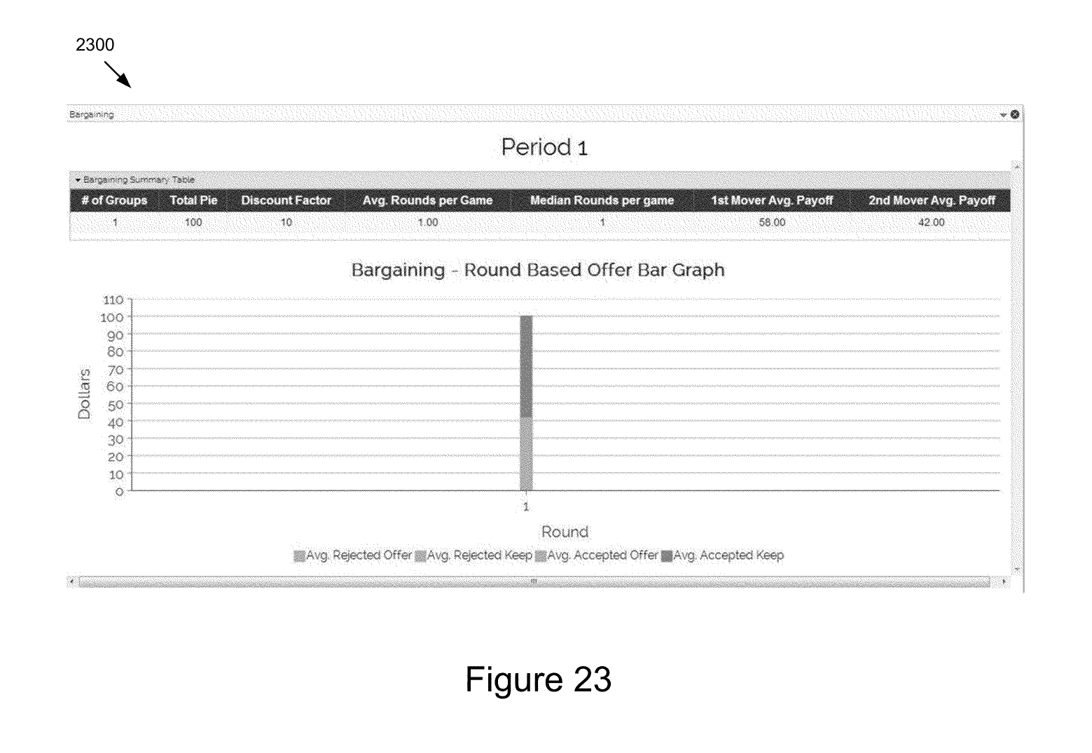

FIG. 23 is a graphical representation illustrating a user interface 2300 for displaying an analysis result of the demo for the Bargaining game according to one embodiment. In the illustrated embodiment, the user interface 2300 includes a bar graph illustrating a result for the first round of the game.

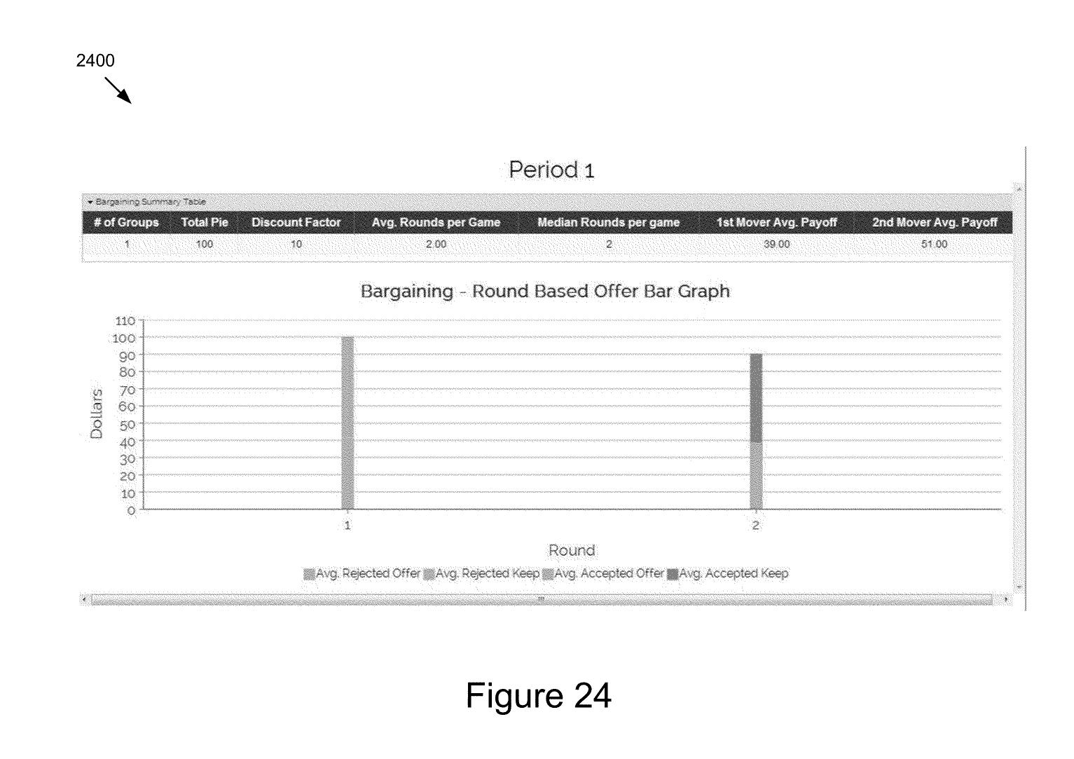

FIG. 24 is a graphical representation illustrating a user interface 2400 for displaying an analysis result of the demo for the Bargaining game according to another embodiment. In the illustrated embodiment, the user interface 2300 includes a bar graph illustrating results for two rounds of the game.

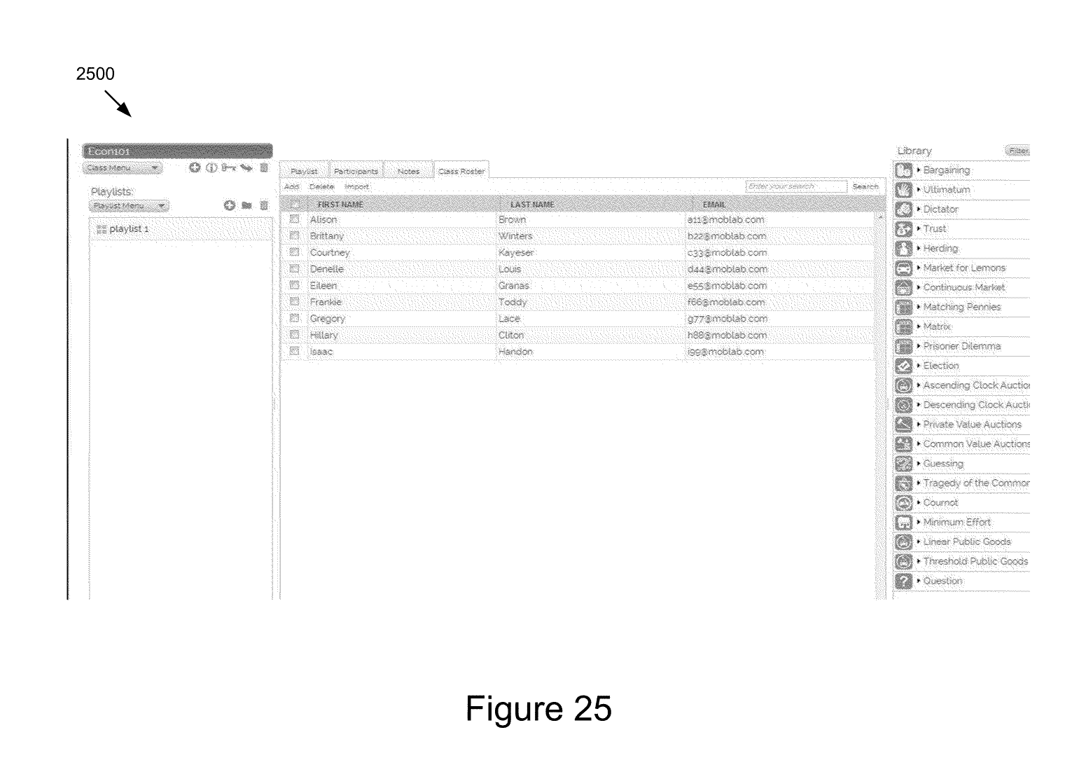

FIG. 25 is a graphical representation illustrating a user interface 2500 for displaying a class roster according to one embodiment. In the illustrated embodiment, the user interface 2500 includes the class roster containing a list of student users 125.

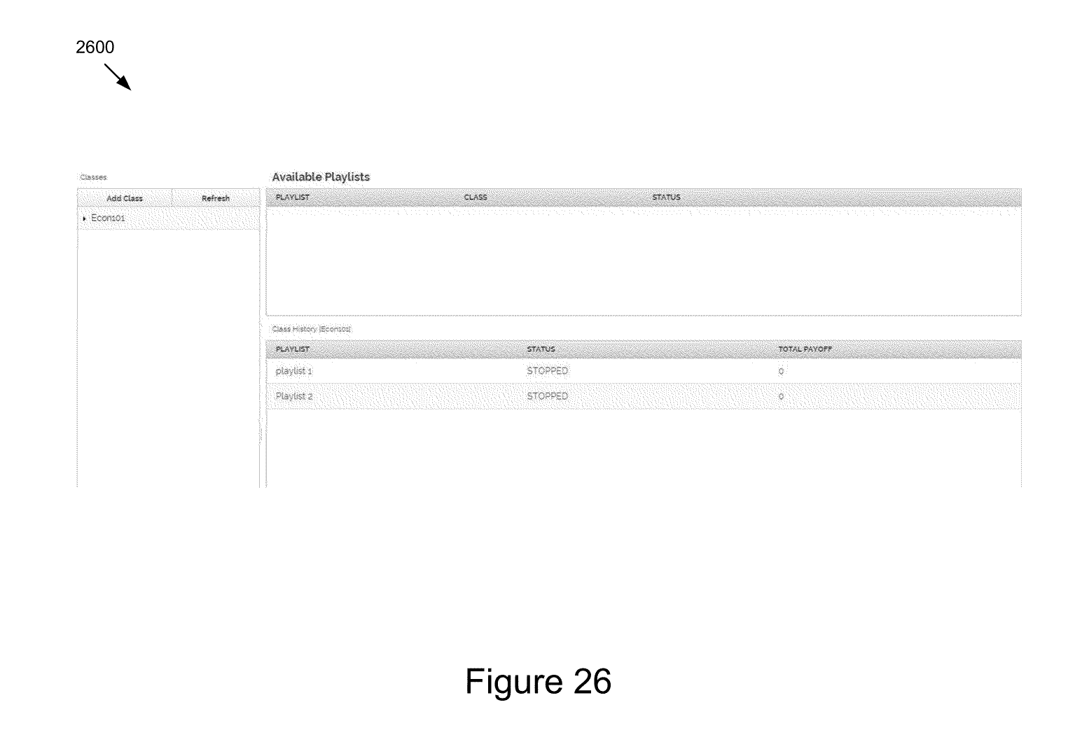

FIG. 26 is a graphical representation illustrating a user interface 2600 for displaying a list of available playlists for a user 125 who registers with a class according to one embodiment. In the illustrated embodiment, the user interface 2600 display the status of two playlists as stopped, which indicates that the instructor 125 of the class has not yet allowed students to join the playlists.

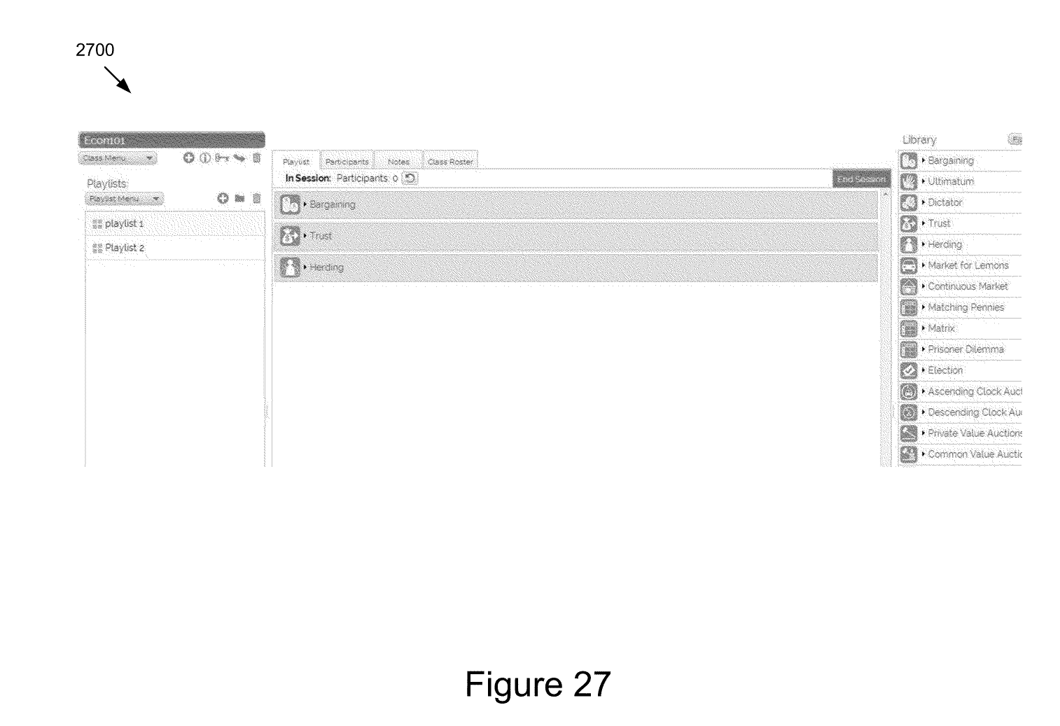

FIG. 27 is a graphical representation illustrating a user interface 2700 for displaying an indication that the instructor 125 of the class has allowed students 125 to join a playlist according to one embodiment.

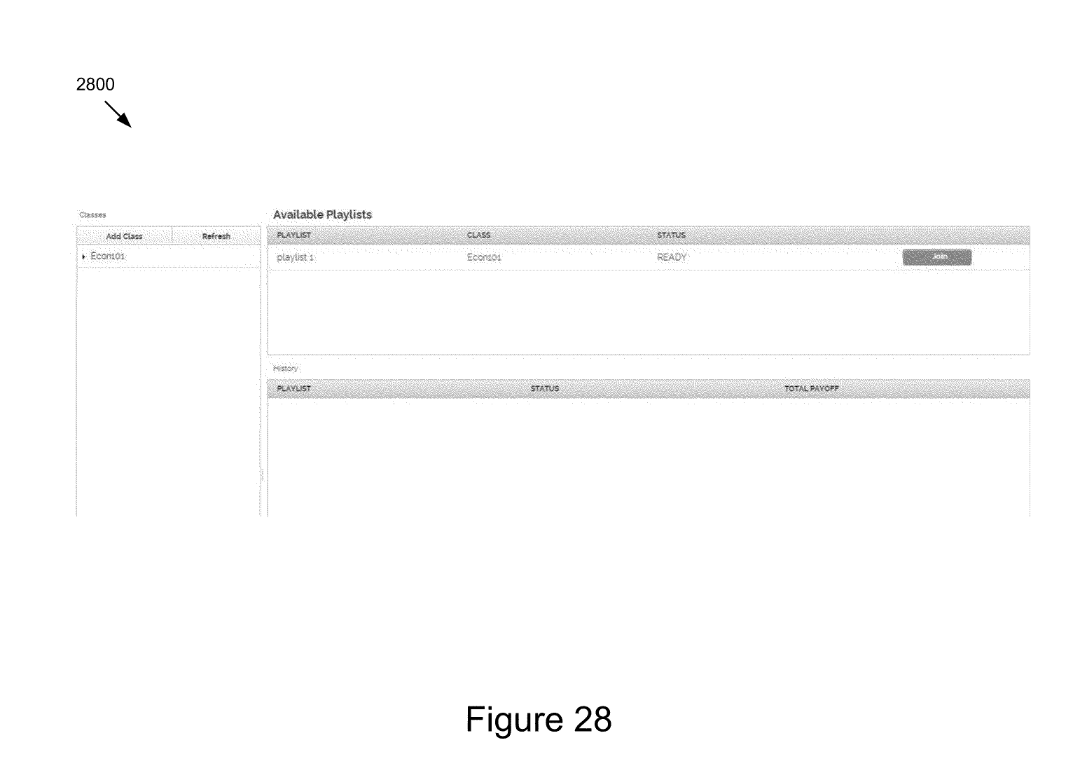

FIG. 28 is a graphical representation illustrating a user interface 2800 for displaying the available playlists for a user 125 according to another embodiment. In the illustrated embodiment, the user interface 2800 displays the status of one playlist as ready, which indicates that the instructor 125 of the class has allowed students to join the playlists and the user 125 can join the playlist.

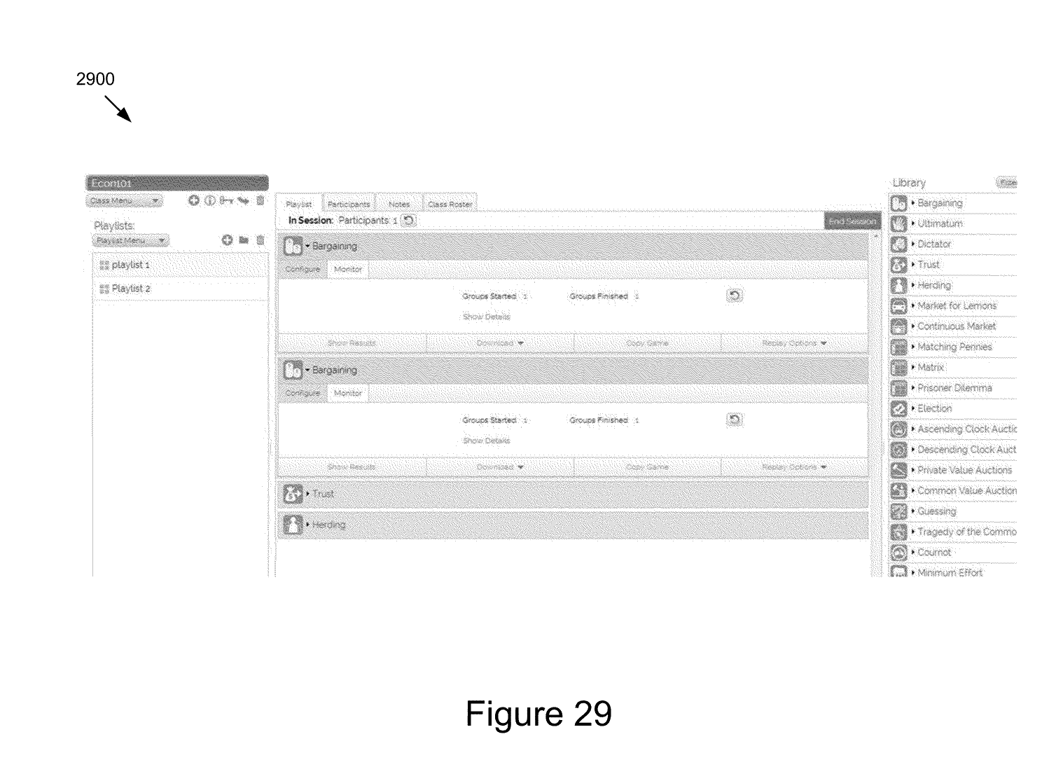

FIG. 29 is a graphical representation illustrating a user interface 2900 for displaying an indication that one participant is playing games in a playlist according to one embodiment.

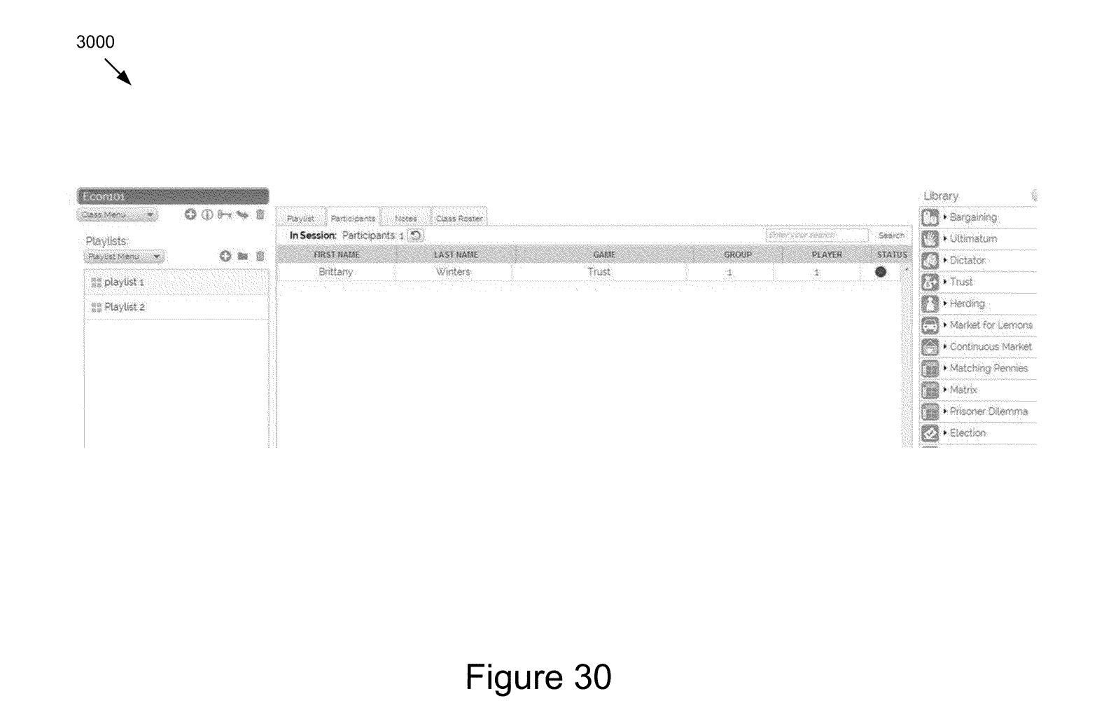

FIG. 30 is a graphical representation illustrating a user interface 3000 for displaying information of the participant who is playing games in a playlist according to one embodiment.

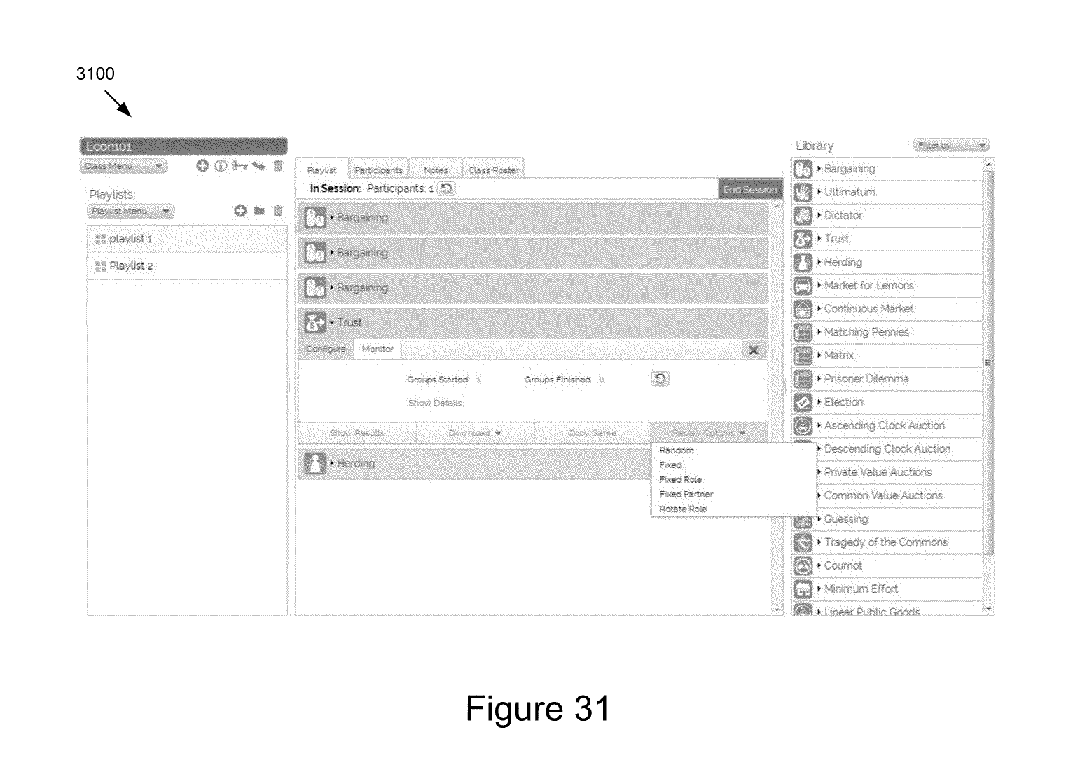

FIG. 31 is a graphical representation illustrating a user interface 3100 that allows users 125 to choose different patterns to replay a game according to one embodiment.

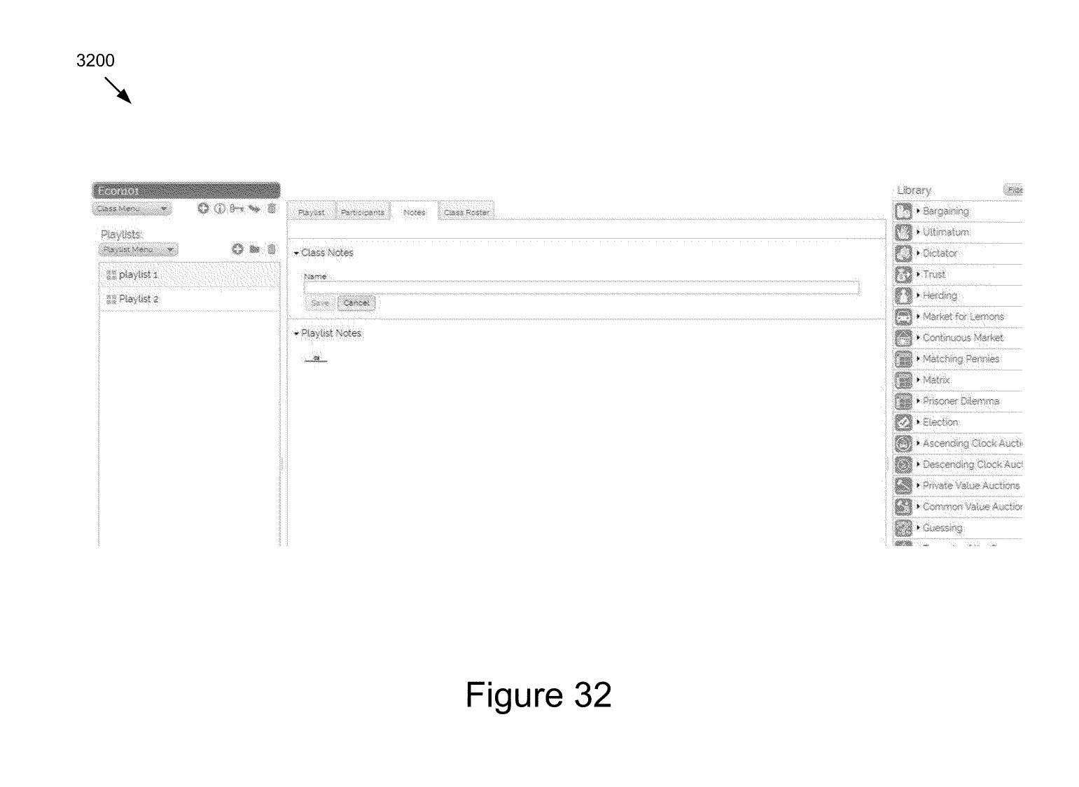

FIG. 32 is a graphical representation illustrating a user interface 3200 that allows users 125 to input notes according to one embodiment. In the illustrated embodiment, the user interface 3200 allows users 125 to input class notes and playlist notes.

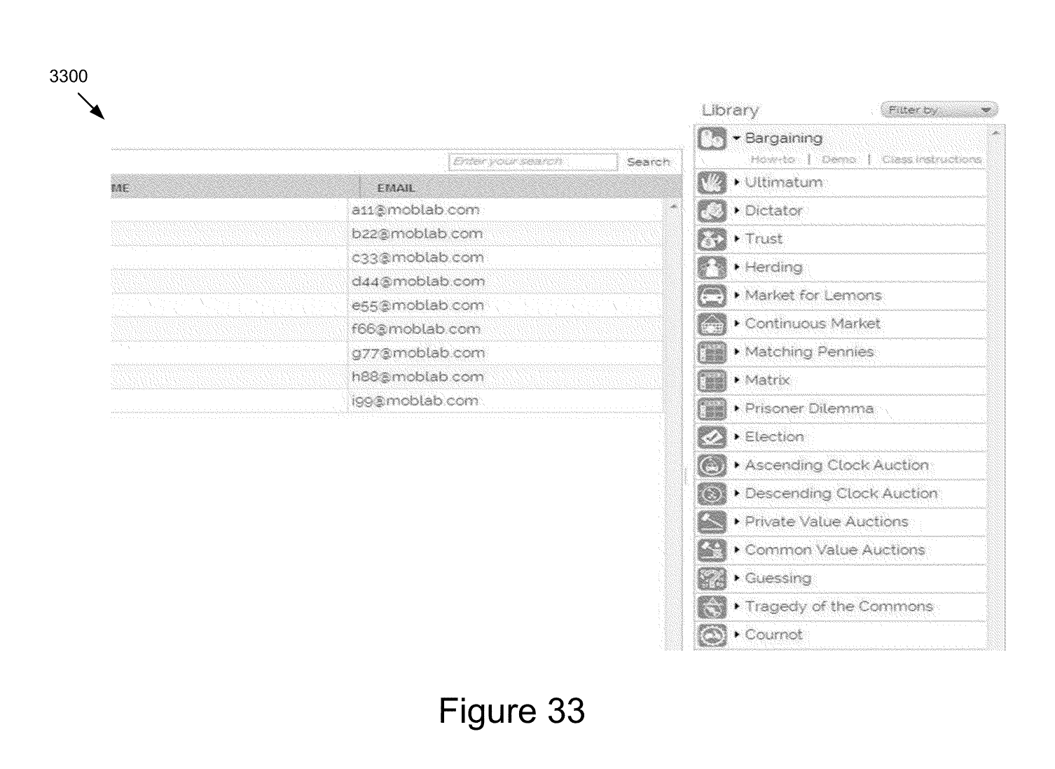

FIG. 33 is a graphical representation illustrating a user interface 3300 that displays tools for users 125 to learn about a game in the library according to one embodiment. For example, the tools can include description about how to play the game, a demo of the game and class instructions for the game.

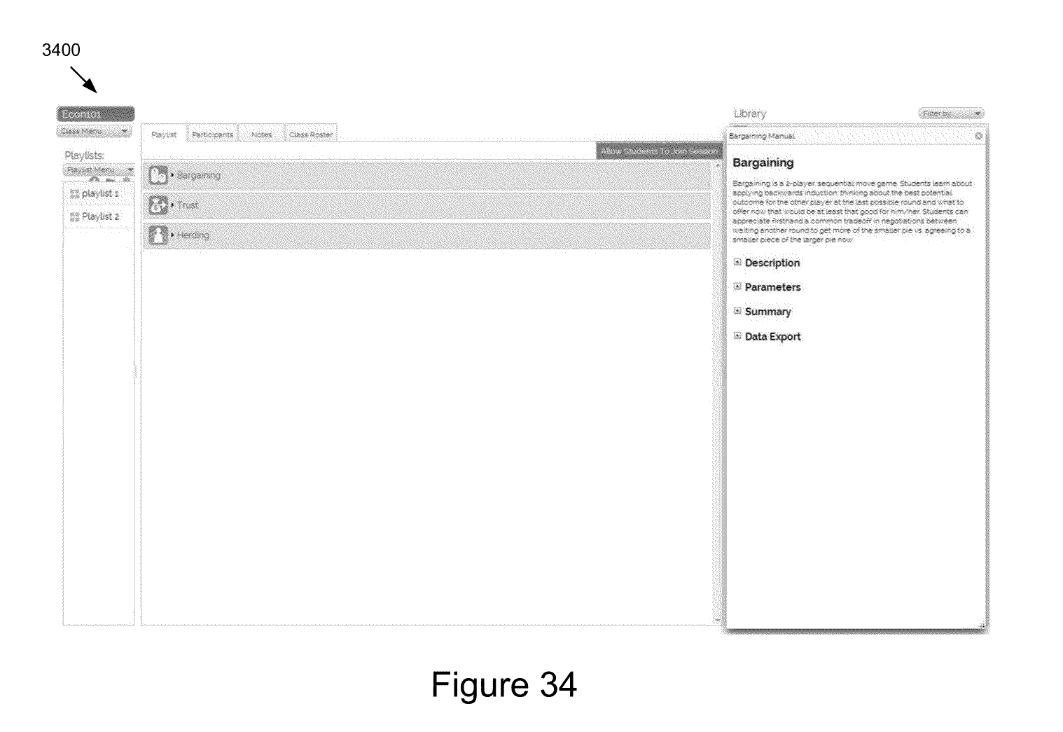

FIG. 34 is a graphical representation illustrating a user interface 3400 for displaying a manual of how to play a game according to one embodiment.

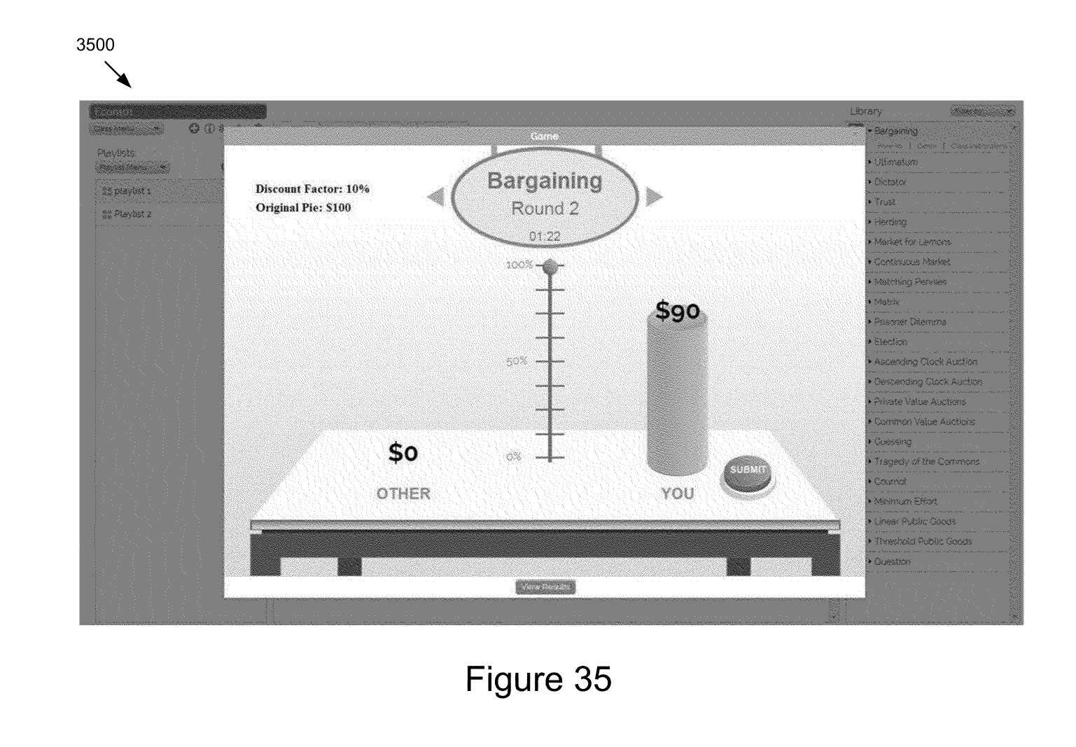

FIG. 35 is a graphical representation illustrating a user interface 3500 for displaying a demo of a game according to one embodiment. In the illustrated embodiment, the user interface 3500 showing the demo of the game can pop up when the user 125 clicks the tool of demo.

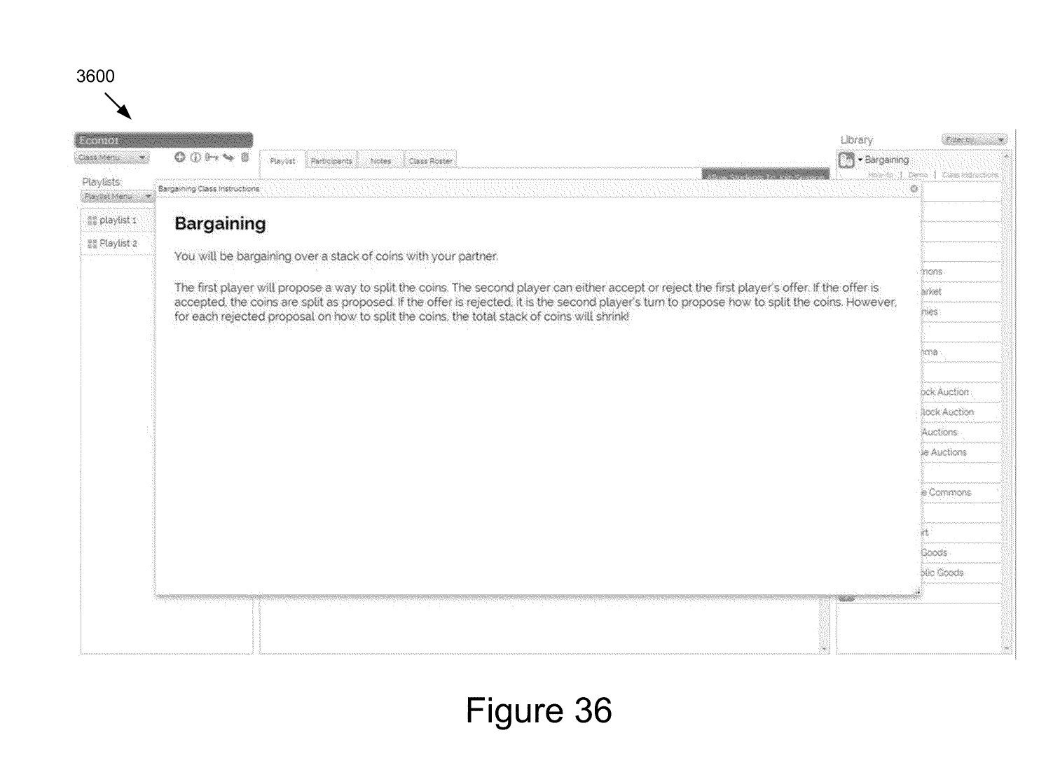

FIG. 36 is a graphical representation illustrating a user interface 3600 for displaying class instructions for a game according to one embodiment.

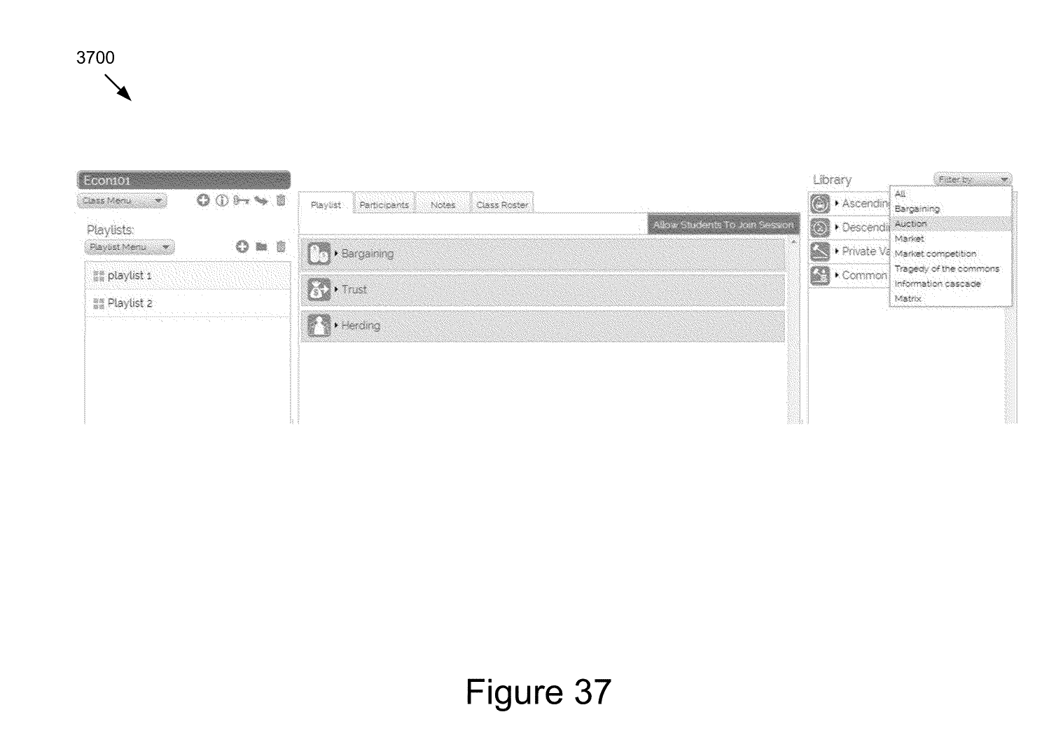

FIG. 37 is a graphical representation illustrating a user interface 3700 that allows users 125 to view different categories of games from the library according to one embodiment.

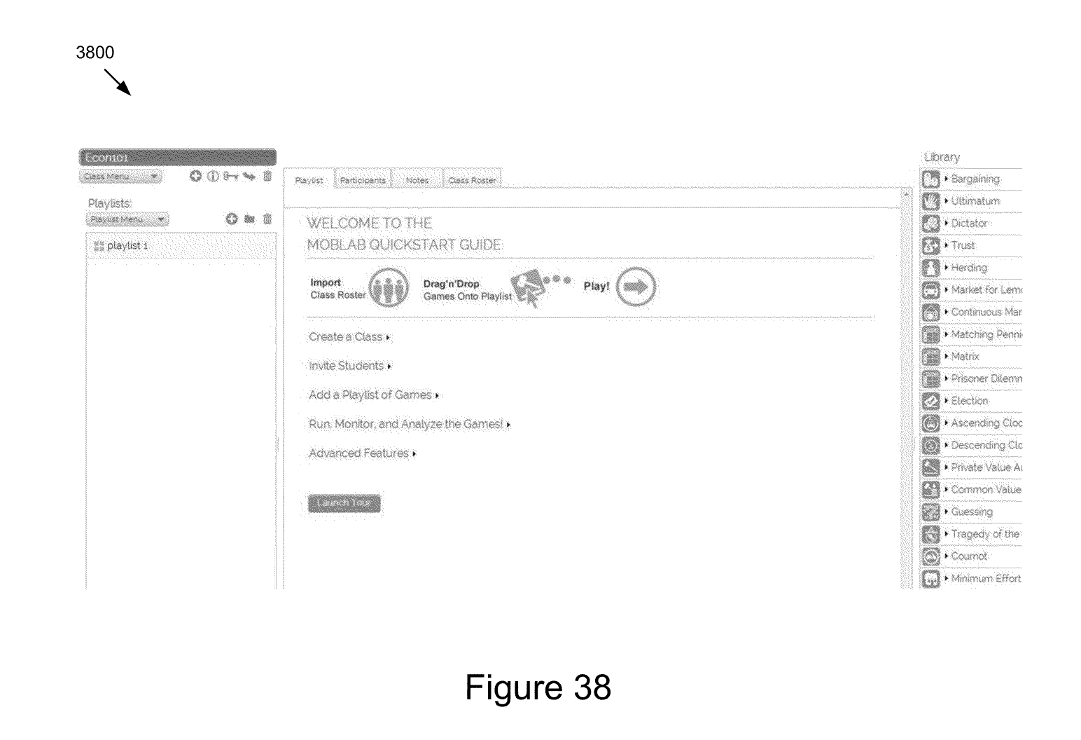

FIG. 38 is a graphical representation illustrating a user interface 3800 that displays a guide of the online interactive lab system according to one embodiment.

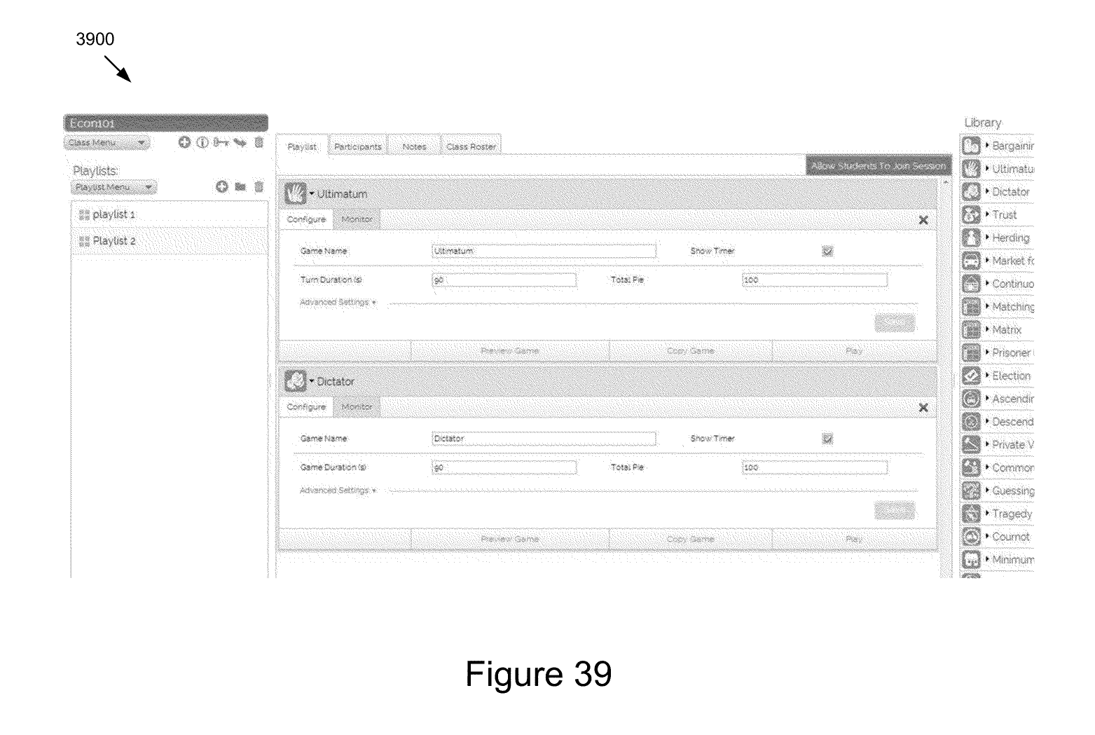

FIG. 39 is a graphical representation illustrating a user interface 3900 that displays parameters for configuring an Ultimatum game and a Dictator game according to one embodiment. For example, the parameters for configuring the Ultimatum game can include turn duration and a total pie. The parameters for configuring the Dictator game can include a game duration and total pie.

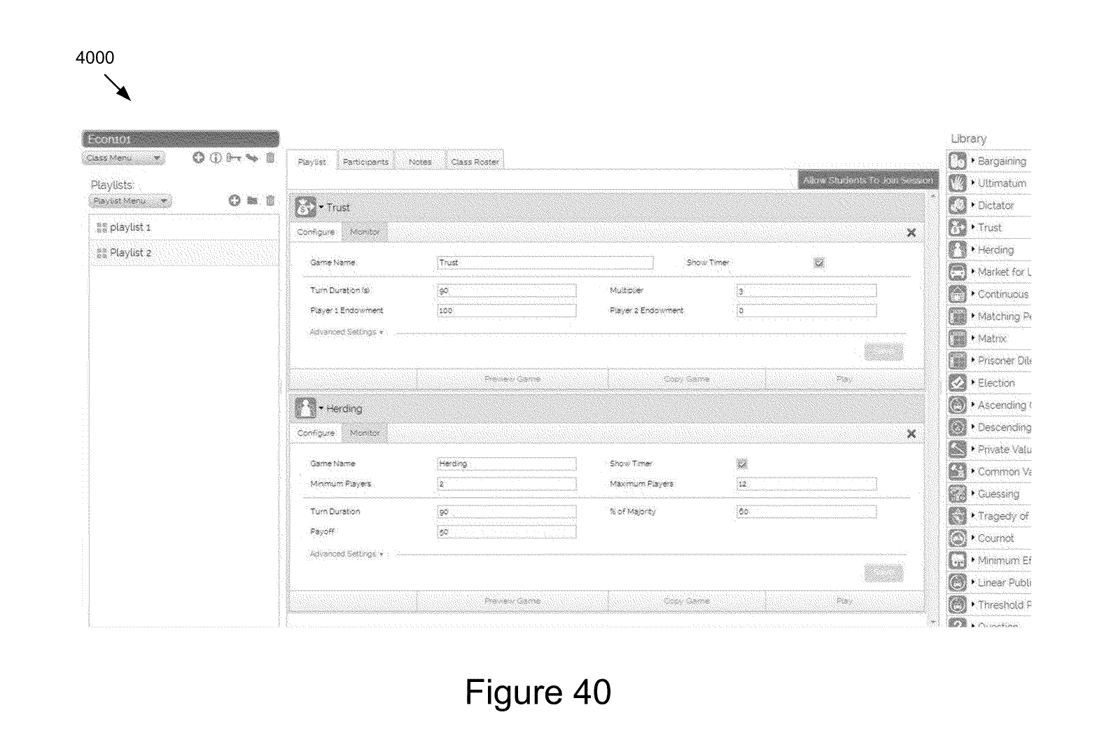

FIG. 40 is a graphical representation illustrating a user interface 4000 that displays parameters for configuring a Trust game and a Herding game according to one embodiment. For example, the parameters for configuring the Trust game can include turn duration, a multiplier, player endowment, etc. The parameters for configuring the Herding game can include the minimum player number, the maximum player number, turn duration, a percentage of majority, payoff, etc.

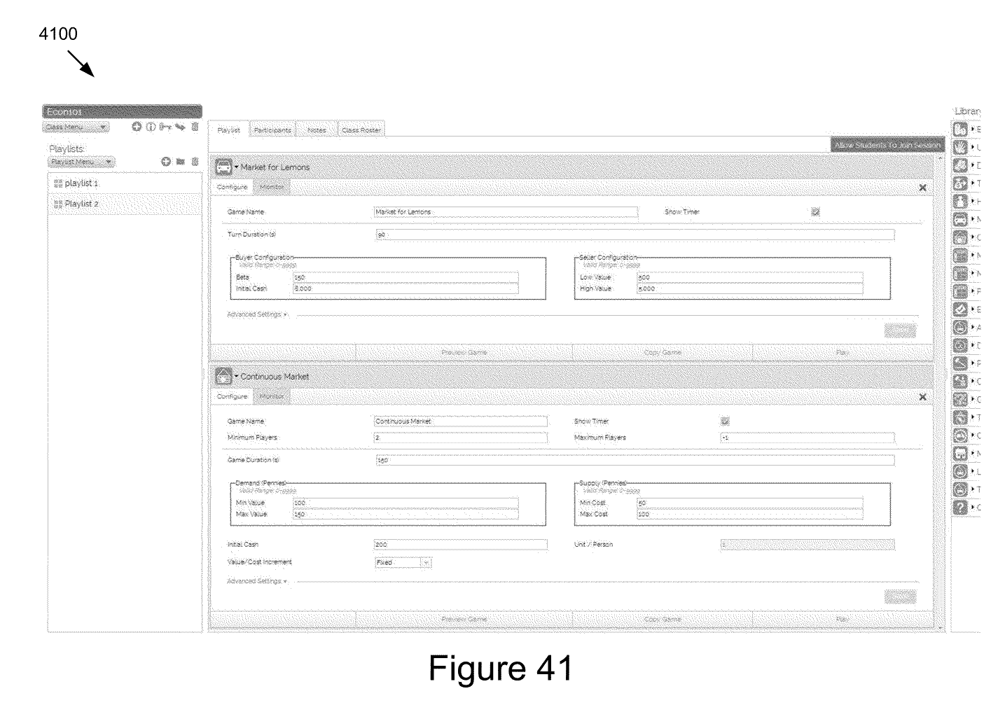

FIG. 41 is a graphical representation illustrating a user interface 4100 that displays parameters for configuring a game of Market for Lemons and a Continuous Market game according to one embodiment. For example, the parameters for configuring the game of Market for Lemons can include turn duration, buyer configuration including beta and initial cash, seller configuration including a low value and a high value, etc. The parameters for configuring the Continuous Market game can include the minimum player number, the maximum player number, game duration, demand (pennies) including the minimum value and the maximum value, supply (pennies) including the minimum cost and the maximum cost, initial cash, value/cost increment, etc.

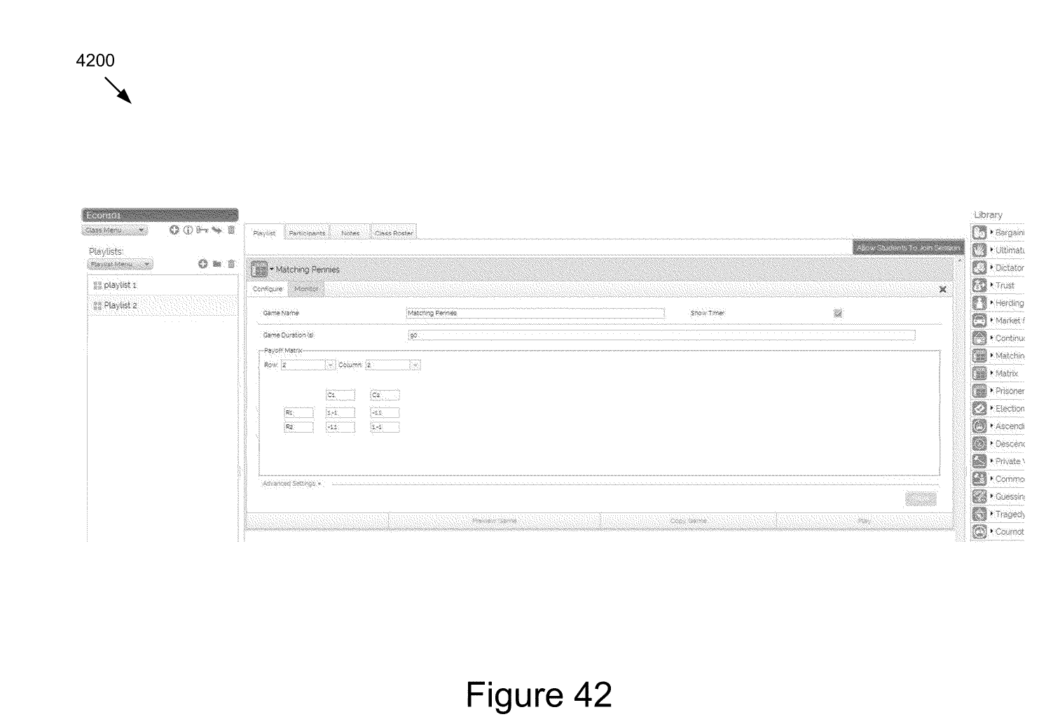

FIG. 42 is a graphical representation illustrating a user interface 4200 that displays parameters for configuring a game of Matching Pennies according to one embodiment. For example, the parameters for configuring the game of Matching Pennies can include a game duration and a payoff matrix including rows and columns.

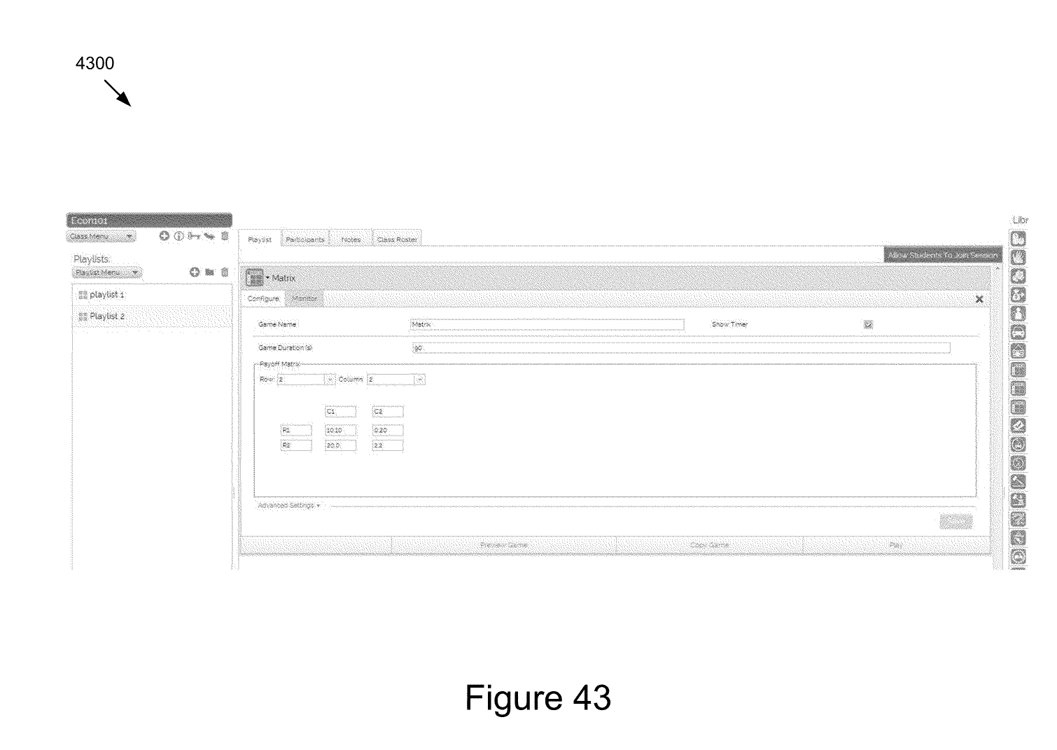

FIG. 43 is a graphical representation illustrating a user interface 4300 that displays parameters for configuring a Matrix game according to one embodiment. For example, the parameters for configuring the Matrix game can include a game duration and a payoff matrix including rows and columns.

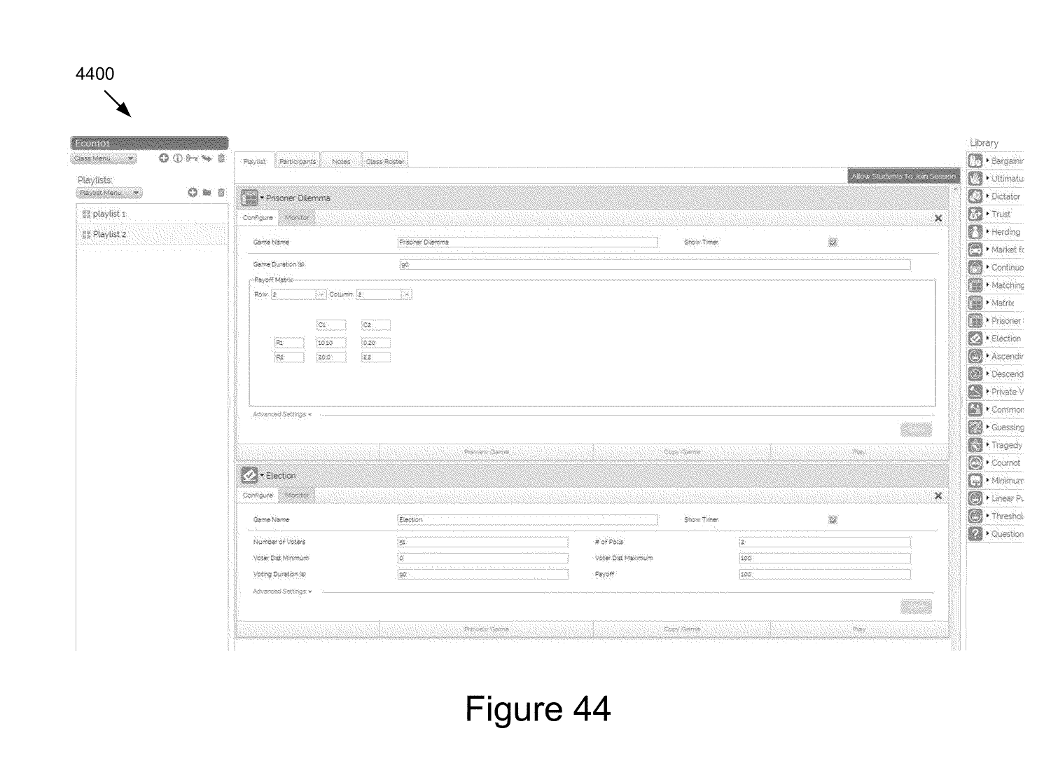

FIG. 44 is a graphical representation illustrating a user interface 4400 that displays parameters for configuring a game of Prisoner Dilemma and an Election game according to one embodiment. For example, the parameters for configuring the game of Prisoner Dilemma can include a game duration and a payoff matrix including rows and columns. The parameters for configuring the Election game can include the number of voters, the number of polls, the voter distance minimum, the voter distance maximum, a voting duration and payoff

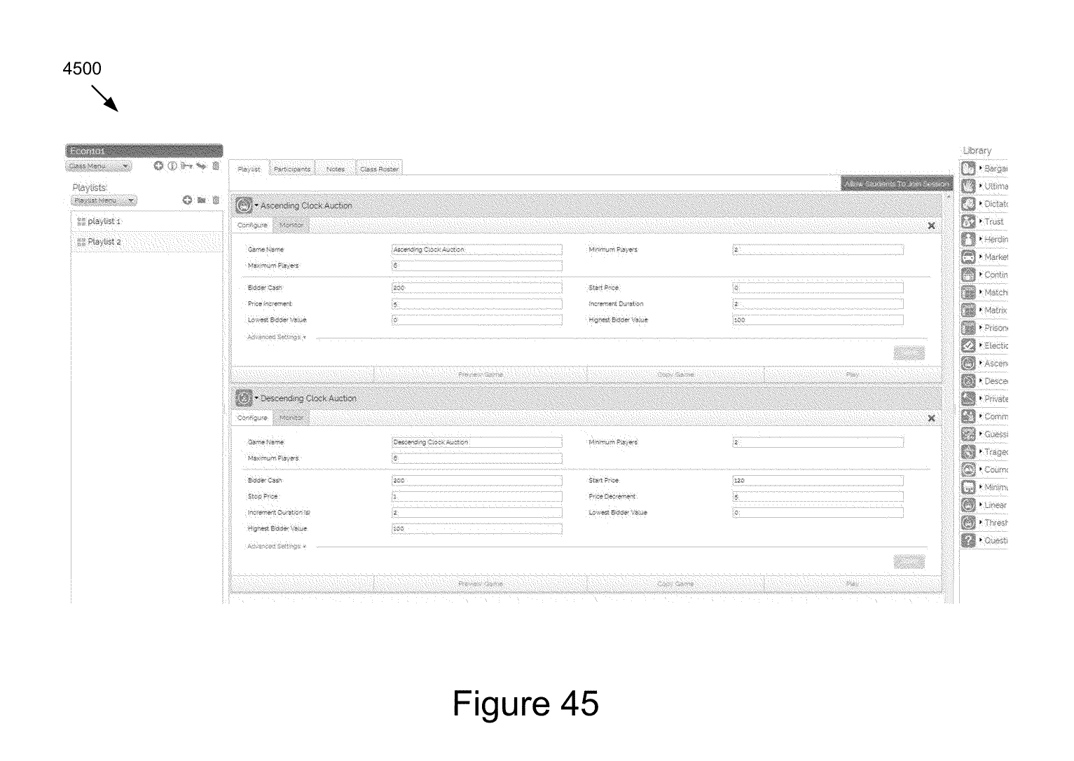

FIG. 45 is a graphical representation illustrating a user interface 4500 that displays parameters for configuring a game of Ascending Clock Auction and a game of Descending Clock auction according to one embodiment. For example, the parameters for configuring the game of Ascending Clock Auction can include the maximum number of players, the minimum number of players, bidder cash, start price, price increment, increment duration, the lowest bidder value, the highest bidder value, etc. The parameters for configuring the game of Descending Clock Auction can include the maximum number of players, the minimum number of players, bidder cash, start price, price increment, increment duration, the lowest bidder value, the highest bidder value, etc.

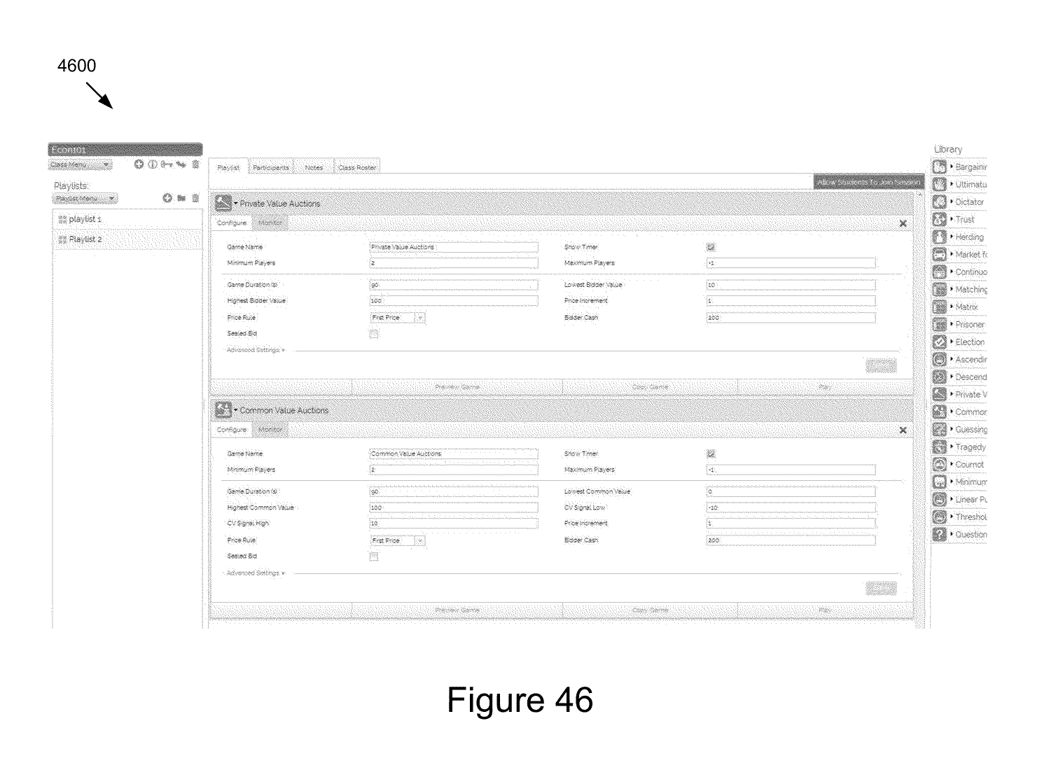

FIG. 46 is a graphical representation illustrating a user interface 4600 that displays parameters for configuring a game of Private Value Auctions and a game of Common Value Auctions according to one embodiment. For example, the parameters for configuring the game of Private Value Auctions can include the maximum number of players, the minimum number of players, a game duration, bidder cash, price increment, the lowest bidder value, the highest bidder value, price rule, with sealed bid or not, etc. The parameters for configuring the game of Common Value Auctions can include the maximum number of players, the minimum number of players, game duration, bidder cash, price rule, price increment, the lowest common value, the highest common value, common value (CV) signal low, CV signal high, with sealed bid or not, etc.

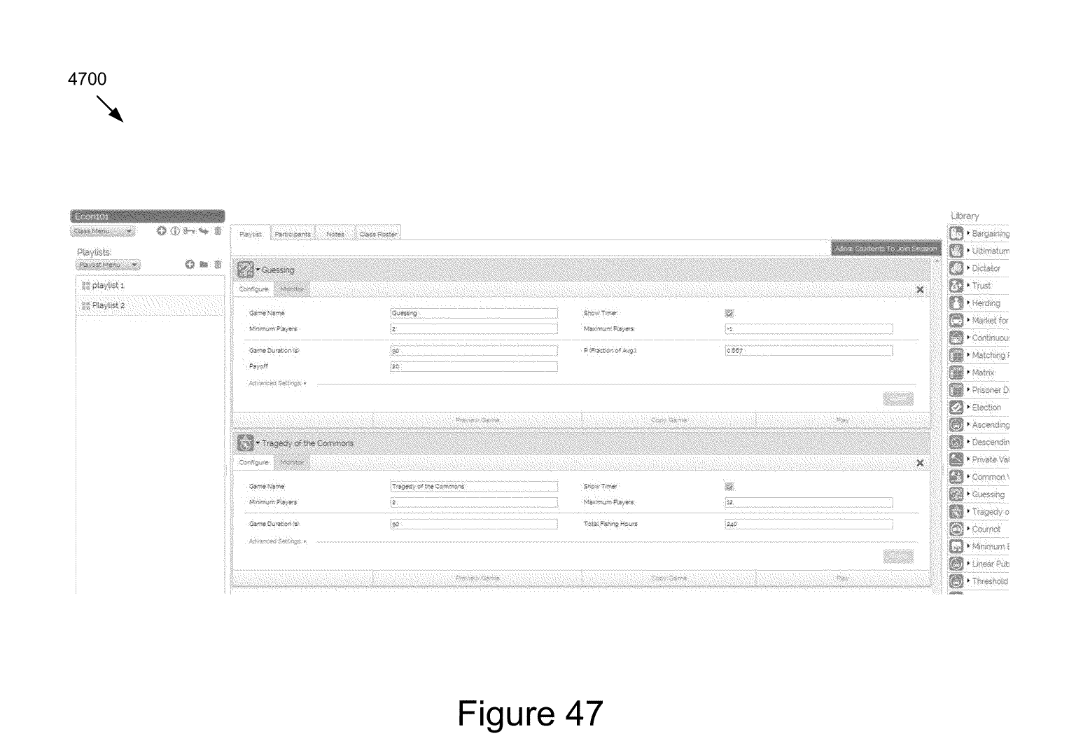

FIG. 47 is a graphical representation illustrating a user interface 4700 that displays parameters for configuring a Guessing game and a game of Tragedy of the Commons according to one embodiment. For example, the parameters for configuring the Guessing game can include the maximum number of players, the minimum number of players, game duration, payoff, fraction of average, etc. The parameters for configuring the game of Tragedy of the Commons can include the maximum number of players, the minimum number of players, game duration, total fishing hours, etc.

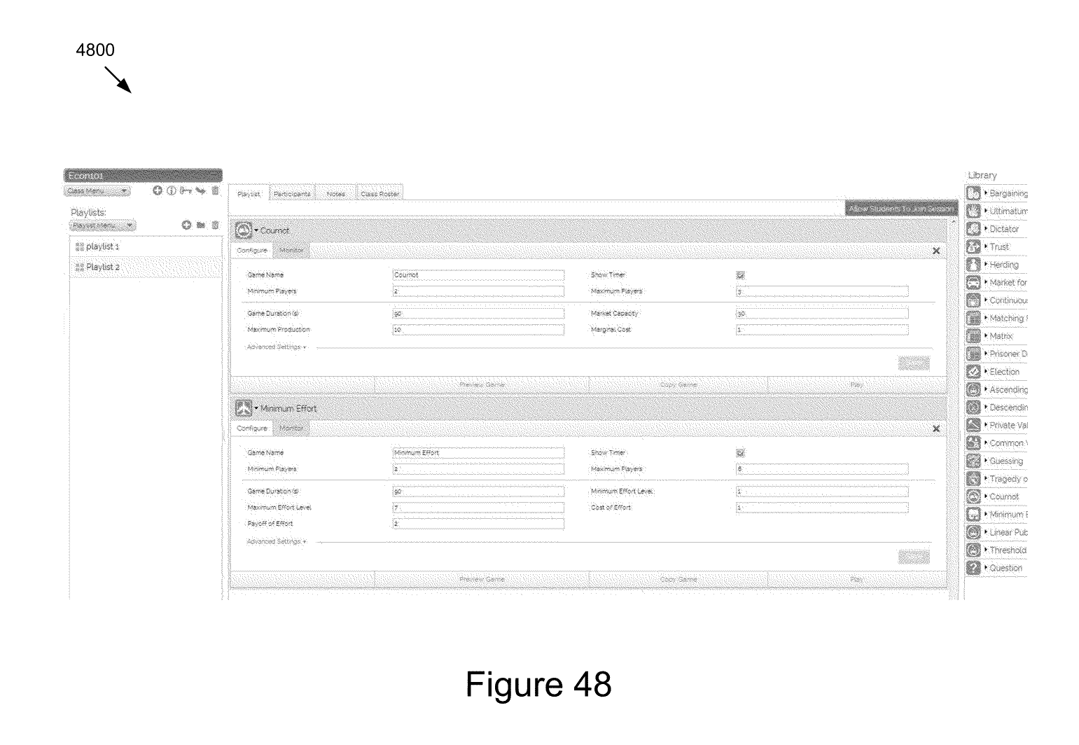

FIG. 48 is a graphical representation illustrating a user interface 4800 that displays parameters for configuring a Oligopoly game and a Minimum Effort game according to one embodiment. For example, the parameters for configuring the Oligopoly game can include the maximum number of players, the minimum number of players, game duration, market capacity, maximum production, marginal cost, etc. The parameters for configuring the Minimum Effort Game can include the maximum number of players, the minimum number of players, game duration, minimum effort level, maximum effort level, cost of effort, payoff of effort, etc.

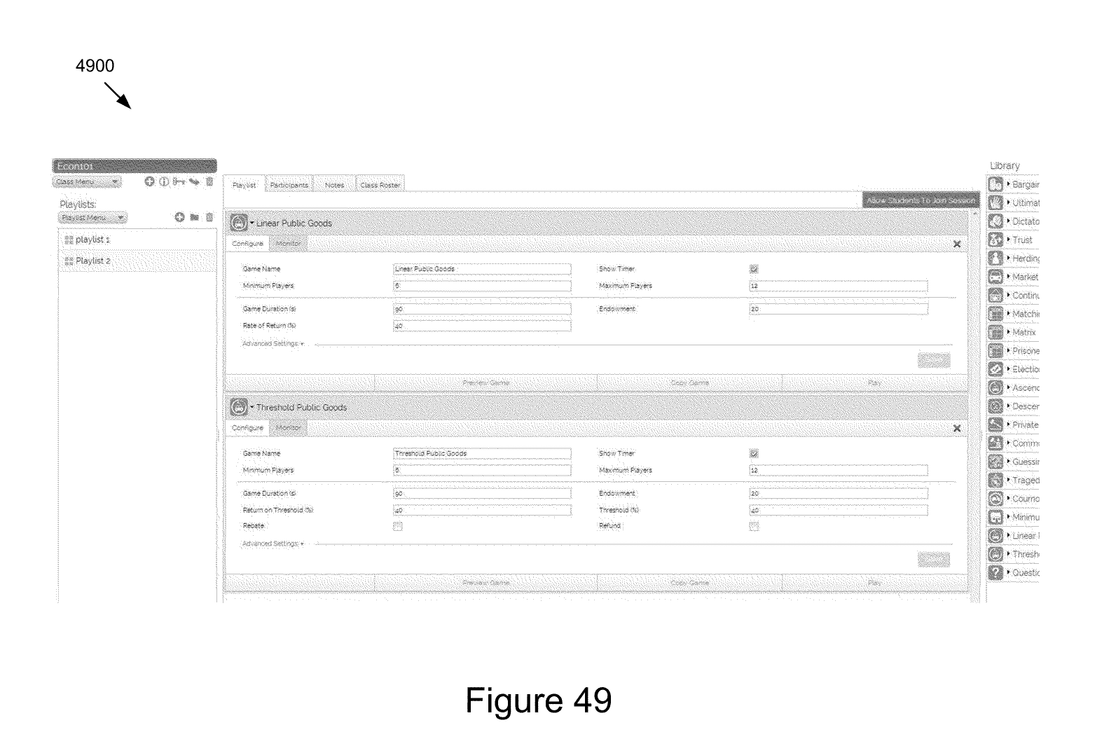

FIG. 49 is a graphical representation illustrating a user interface 4900 that displays parameters for configuring a game of Linear Public Goods and a game of Threshold Public Goods according to one embodiment. For example, the parameters for configuring the game of Linear Public Goods can include the maximum number of players, the minimum number of players, game duration, endowment, rate of return, etc. The parameters for configuring the game of Threshold Public Goods can include the maximum number of players, the minimum number of players, game duration, endowment, return on threshold, threshold, rebate, refund, etc.

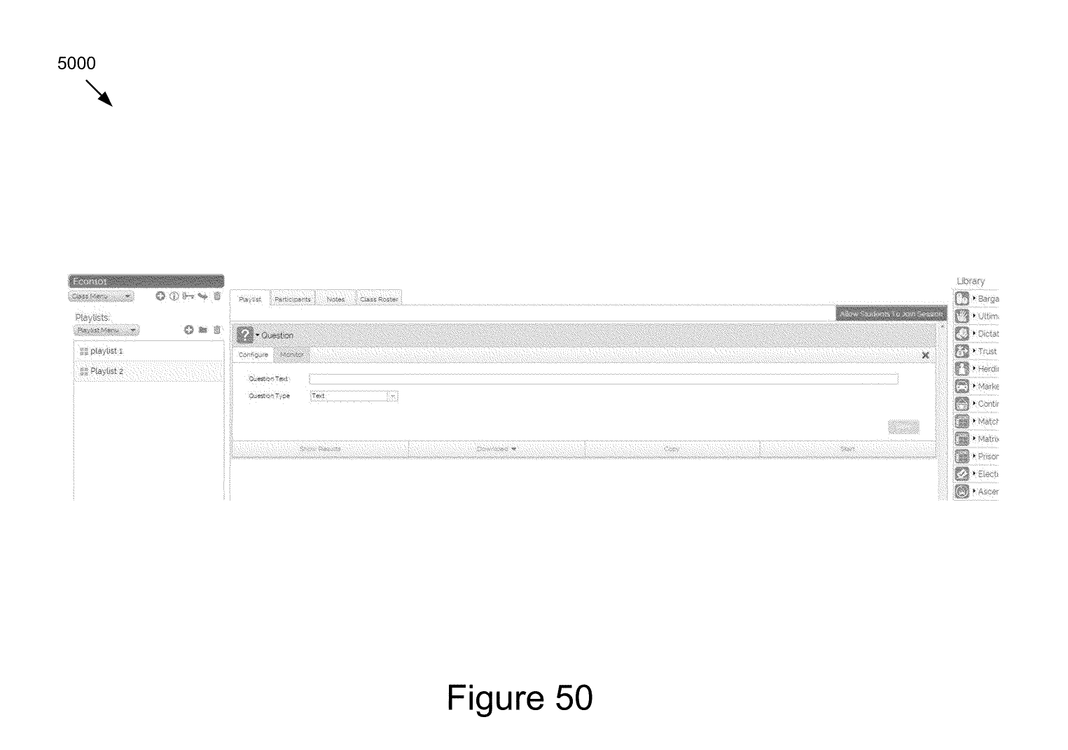

FIG. 50 is a graphical representation illustrating a user interface 5000 that allows users 125 to input questions according to one embodiment.

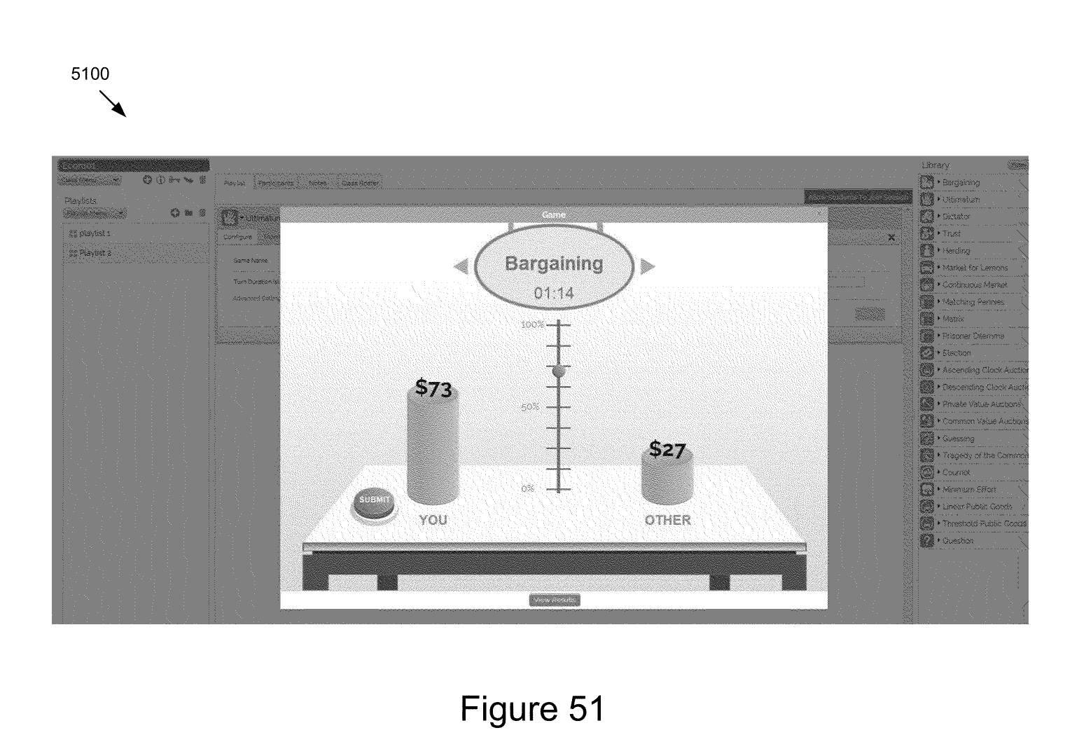

FIG. 51 is a graphical representation illustrating a user interface 5100 that allows users 125 to play the Ultimatum game according to one embodiment.

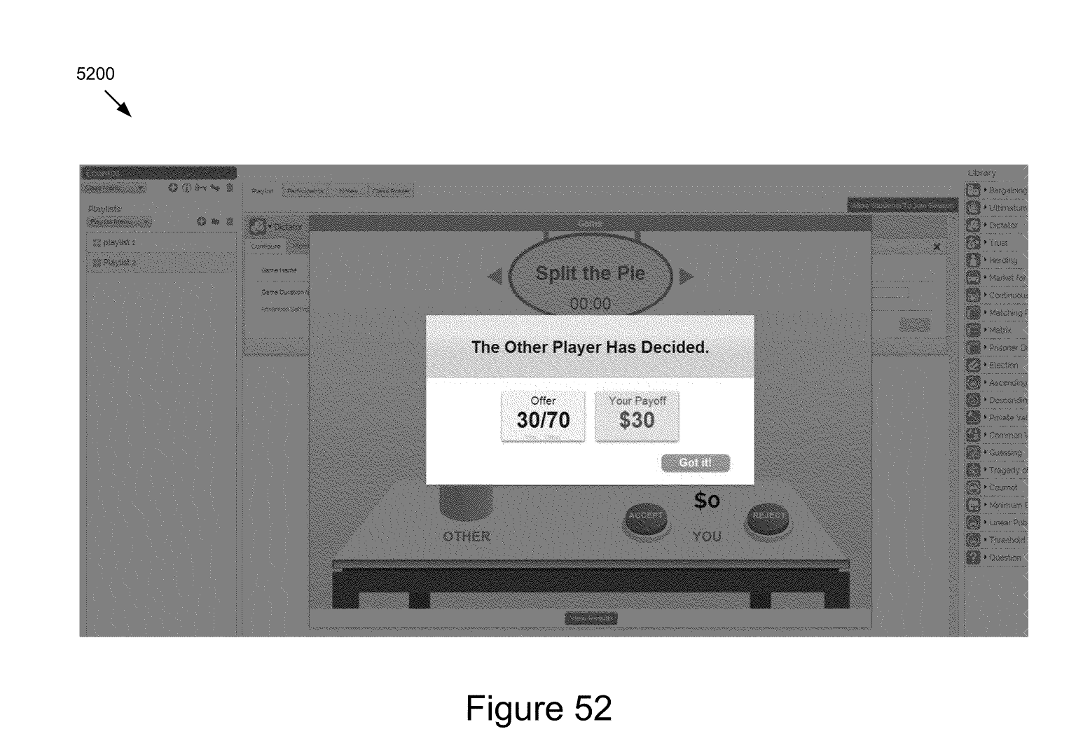

FIG. 52 is a graphical representation illustrating a user interface 5200 that displays how users 125 play the Dictator game according to one embodiment.

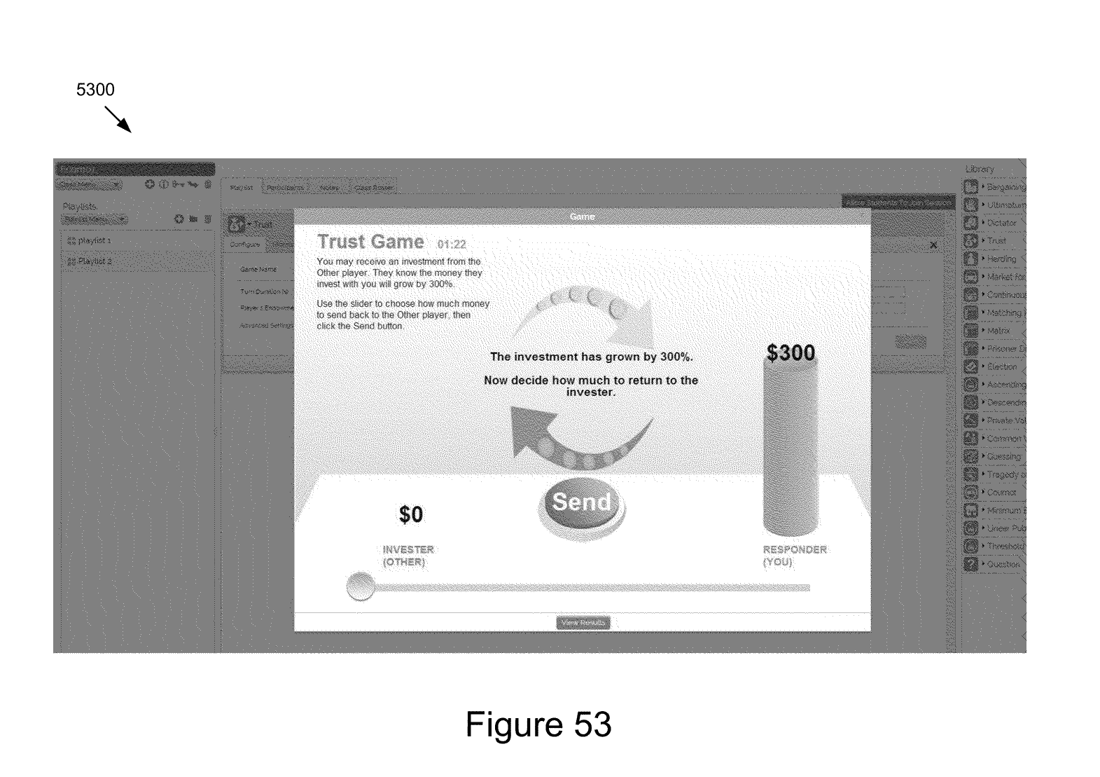

FIG. 53 is a graphical representation illustrating a user interface 5300 that allows users 125 to play the Trust game according to one embodiment.

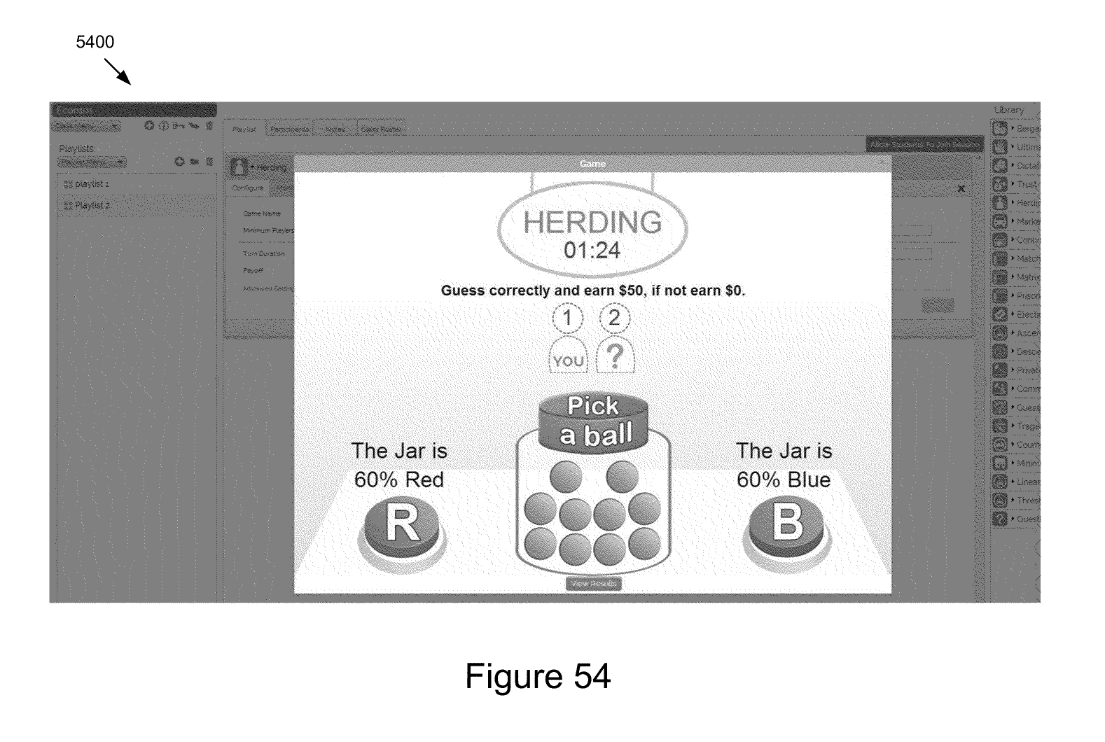

FIG. 54 is a graphical representation illustrating a user interface 5400 that allows users 125 to play the Herding game according to one embodiment.

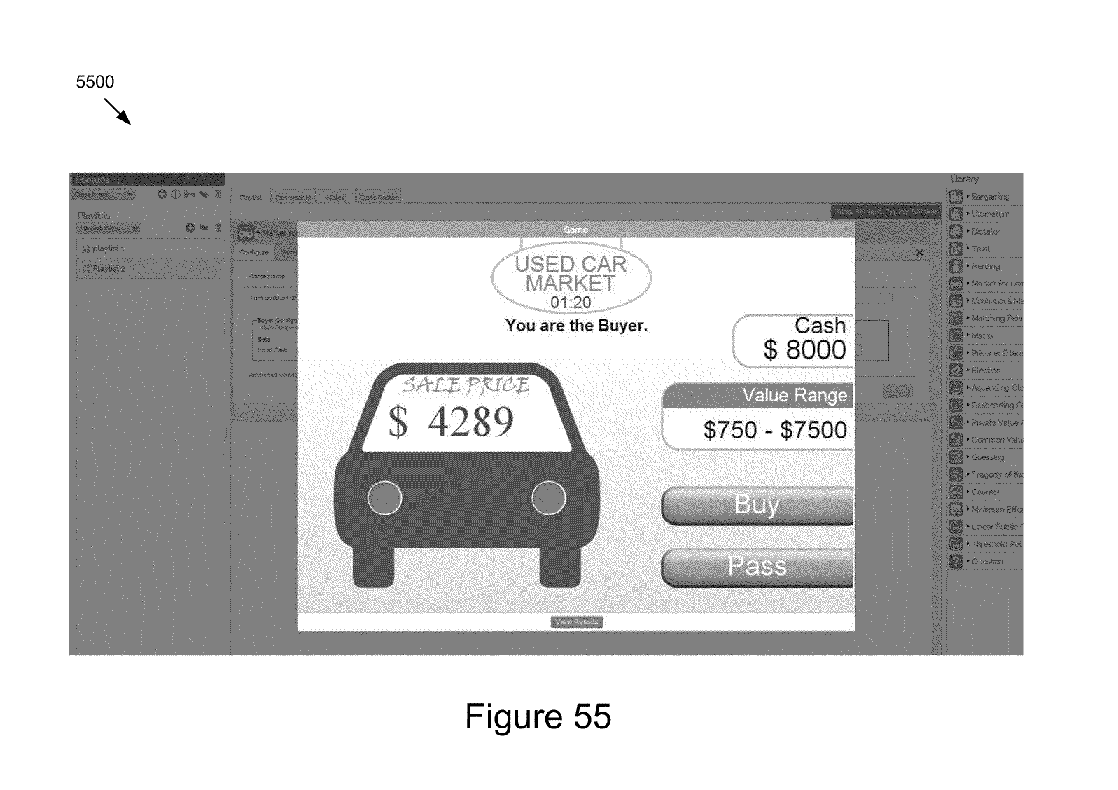

FIG. 55 is a graphical representation illustrating a user interface 5500 that allows users 125 to play the game of Market for Lemons according to one embodiment.

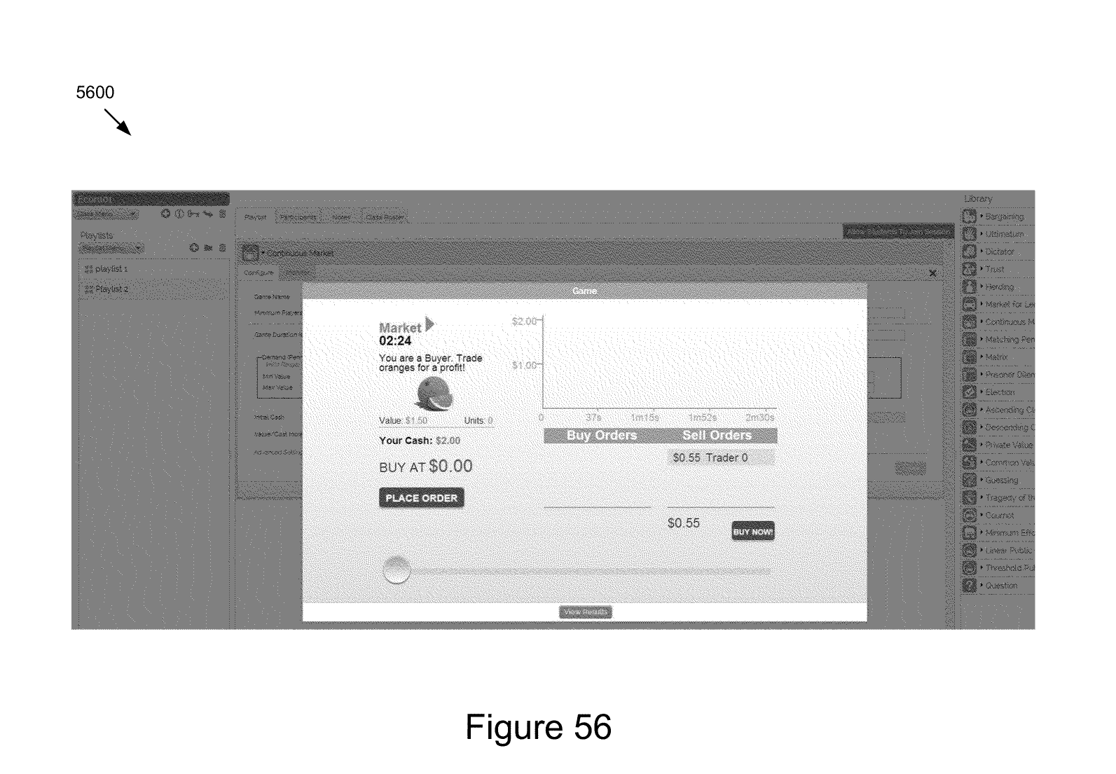

FIG. 56 is a graphical representation illustrating a user interface 5600 that allows users 125 to play the Continuous Market game according to one embodiment.

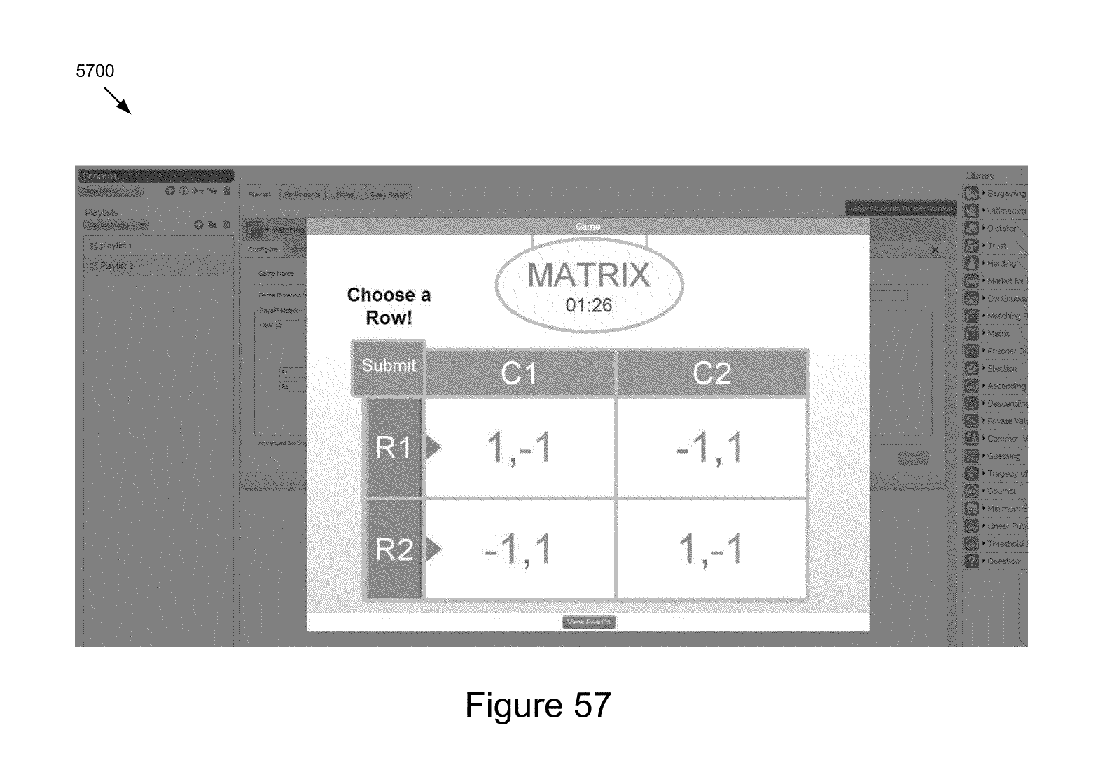

FIG. 57 is a graphical representation illustrating a user interface 5700 that allows users 125 to play the game of Matching Pennies according to one embodiment.

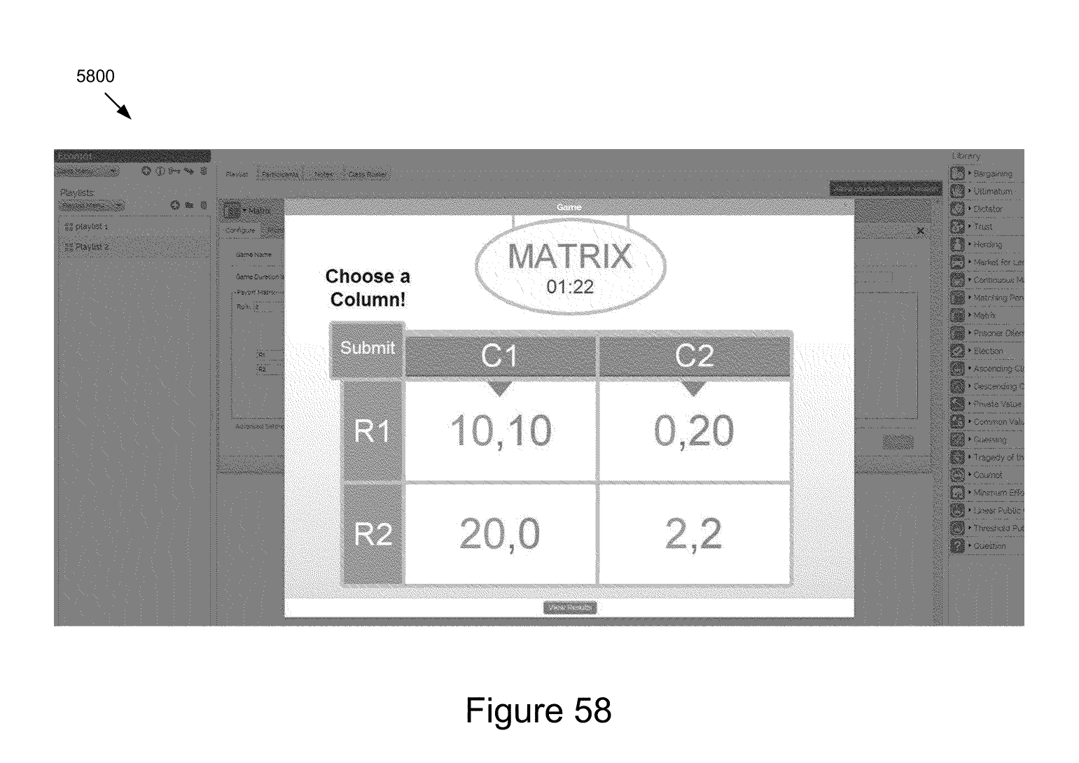

FIG. 58 is a graphical representation illustrating a user interface 5800 that allows users 125 to play the Matrix game according to one embodiment.

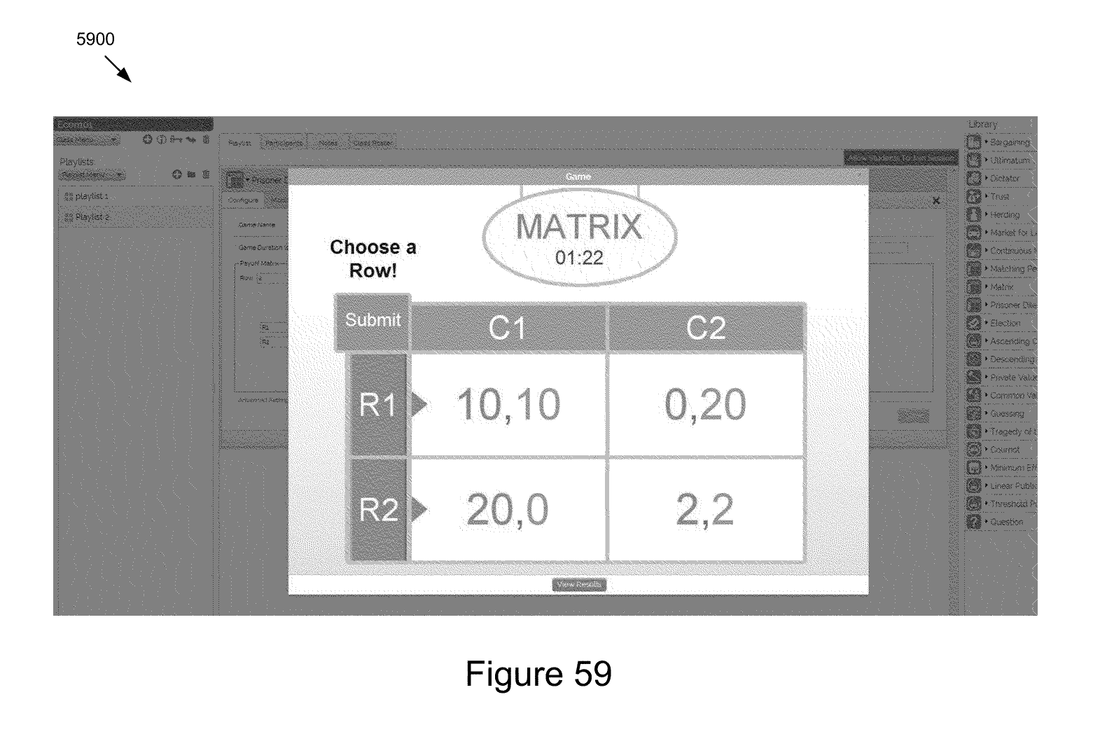

FIG. 59 is a graphical representation illustrating a user interface 5900 that allows users 125 to play the Prisoner Dilemma game according to one embodiment.

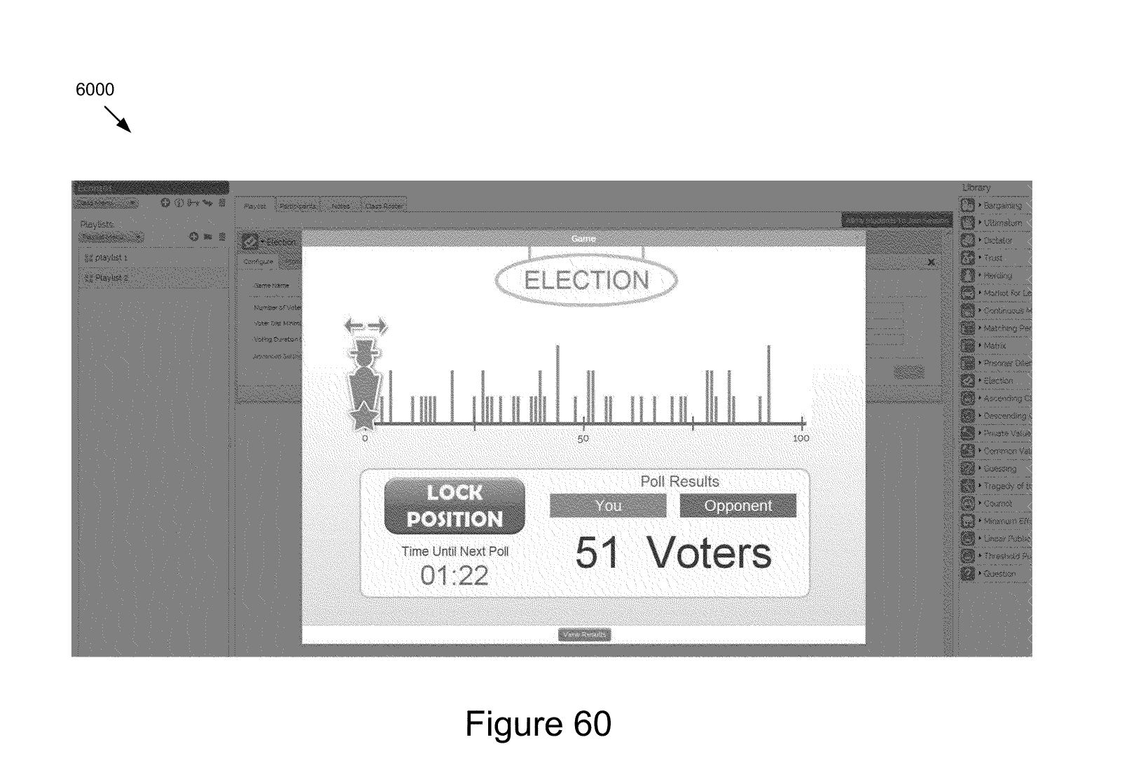

FIG. 60 is a graphical representation illustrating a user interface 6000 that allows users 125 to play the Election game according to one embodiment.

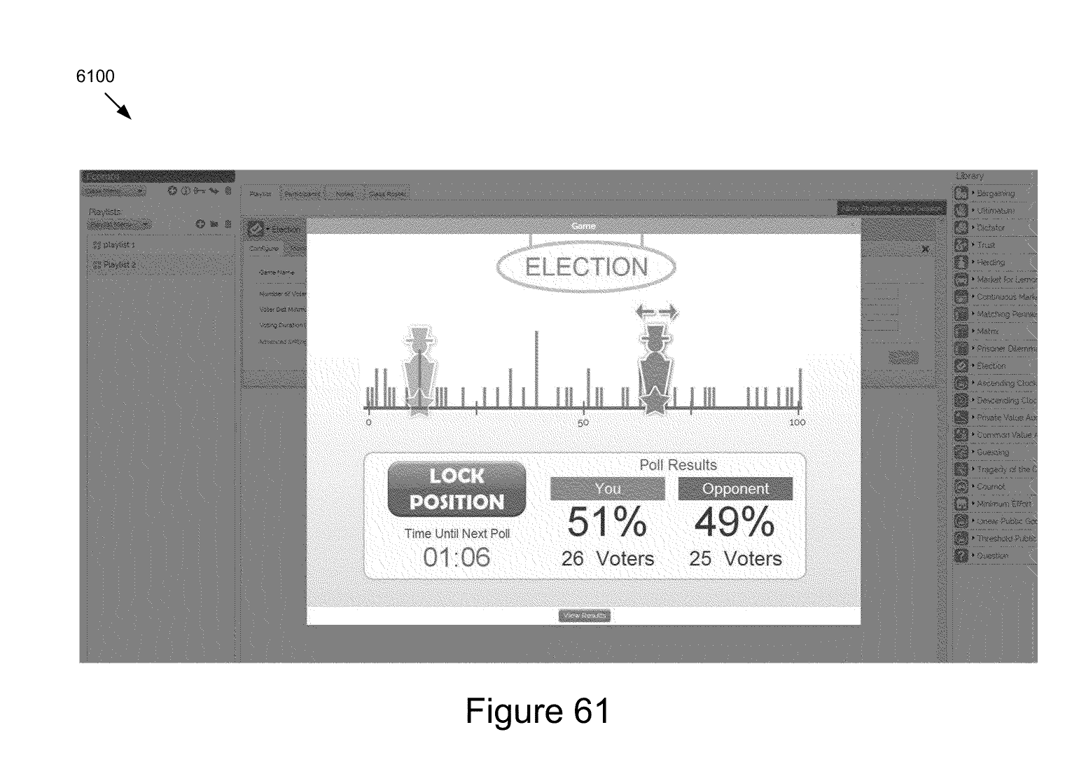

FIG. 61 is a graphical representation illustrating a user interface 6100 that allows users 125 to play the Election game according to another embodiment.

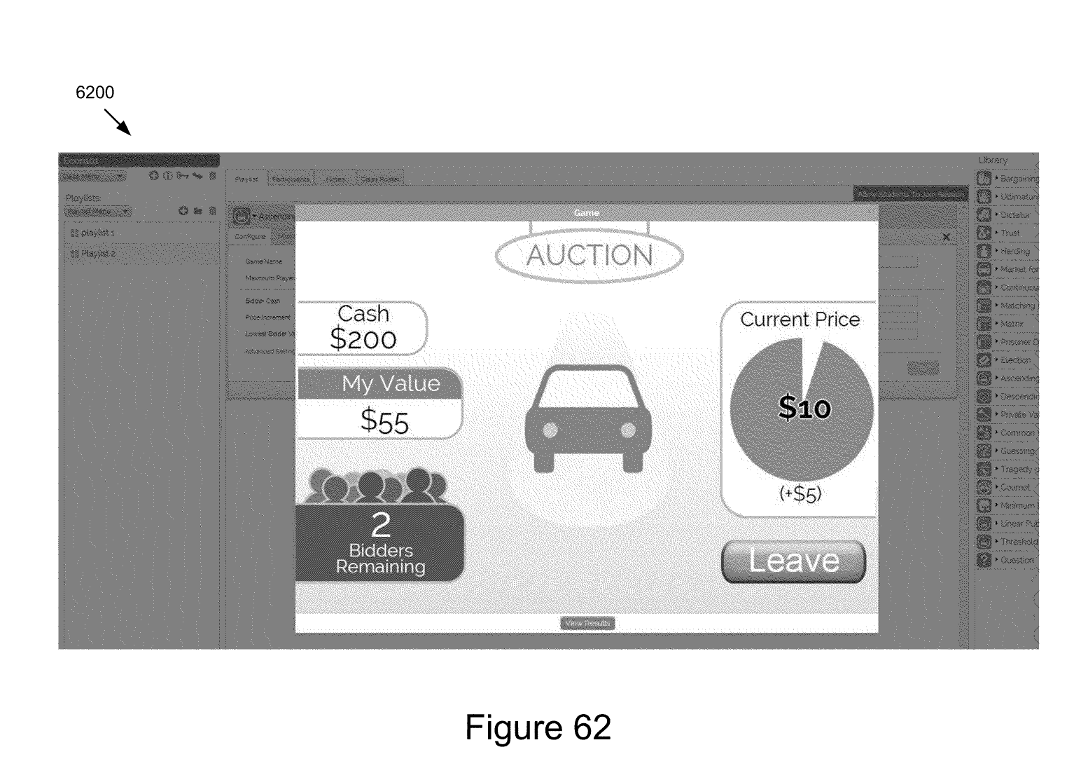

FIG. 62 is a graphical representation illustrating a user interface 6200 that allows users 125 to play the game of Ascending Clock Auction according to one embodiment.

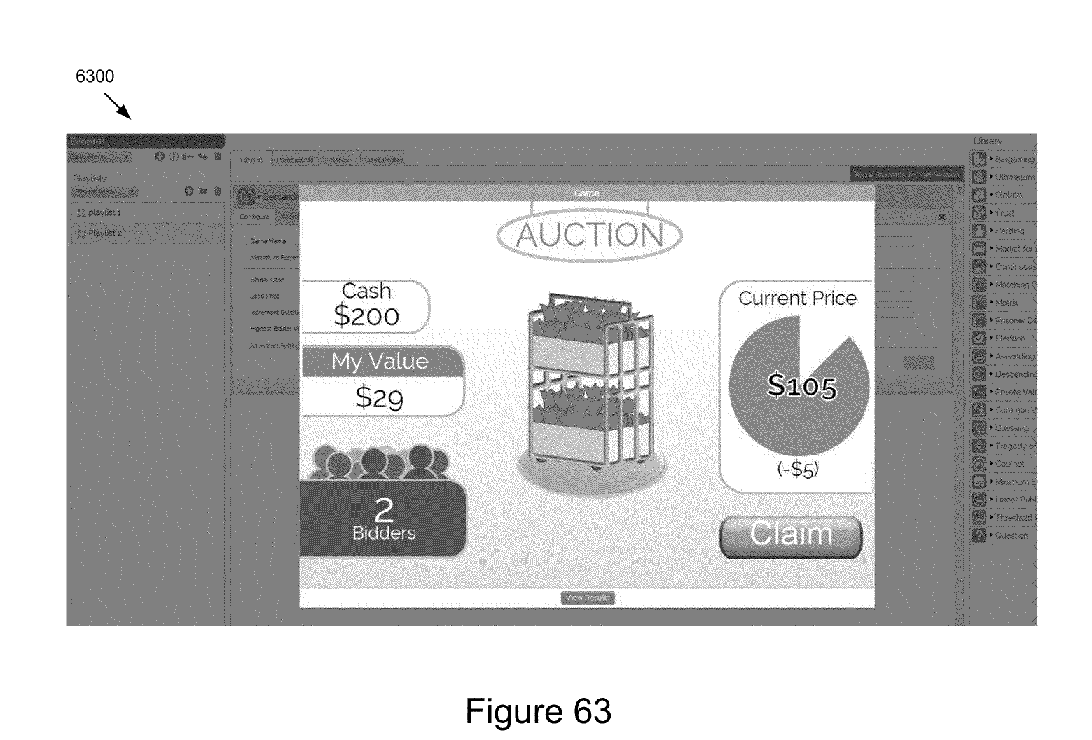

FIG. 63 is a graphical representation illustrating a user interface 6300 that allows users 125 to play the game of Descending Clock auction according to one embodiment.

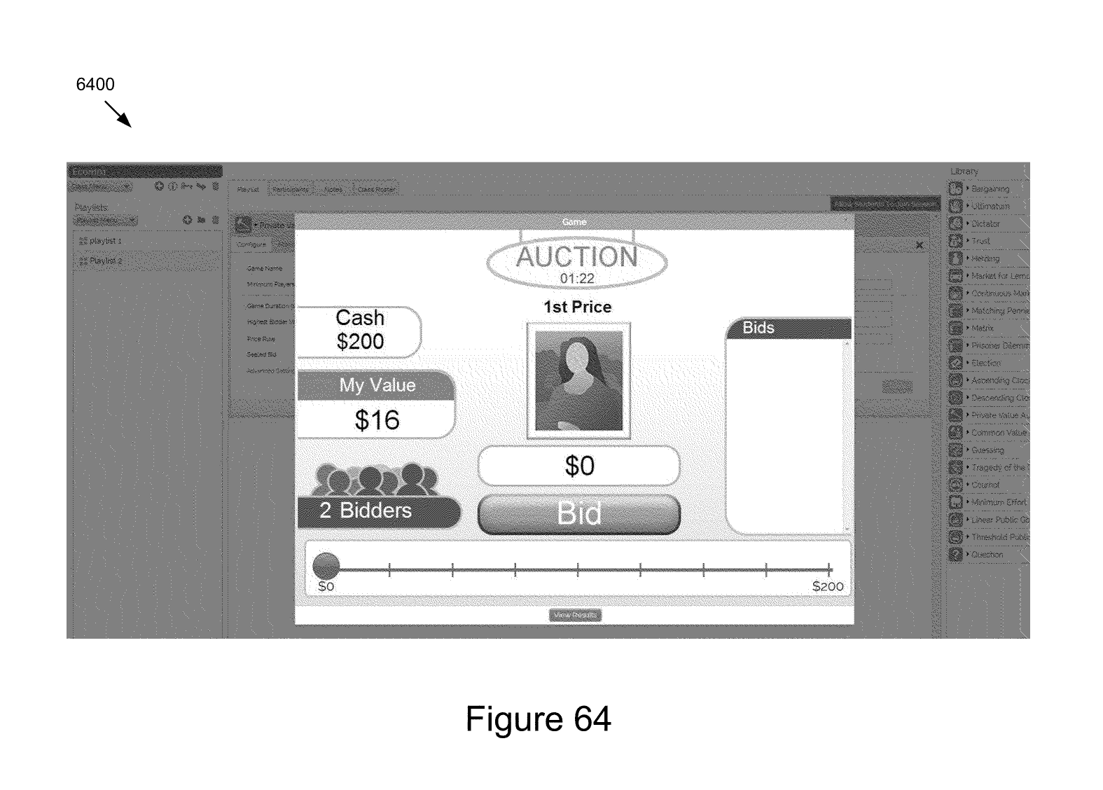

FIG. 64 is a graphical representation illustrating a user interface 6400 that allows users 125 to play the game of Private Value Auction according to one embodiment.

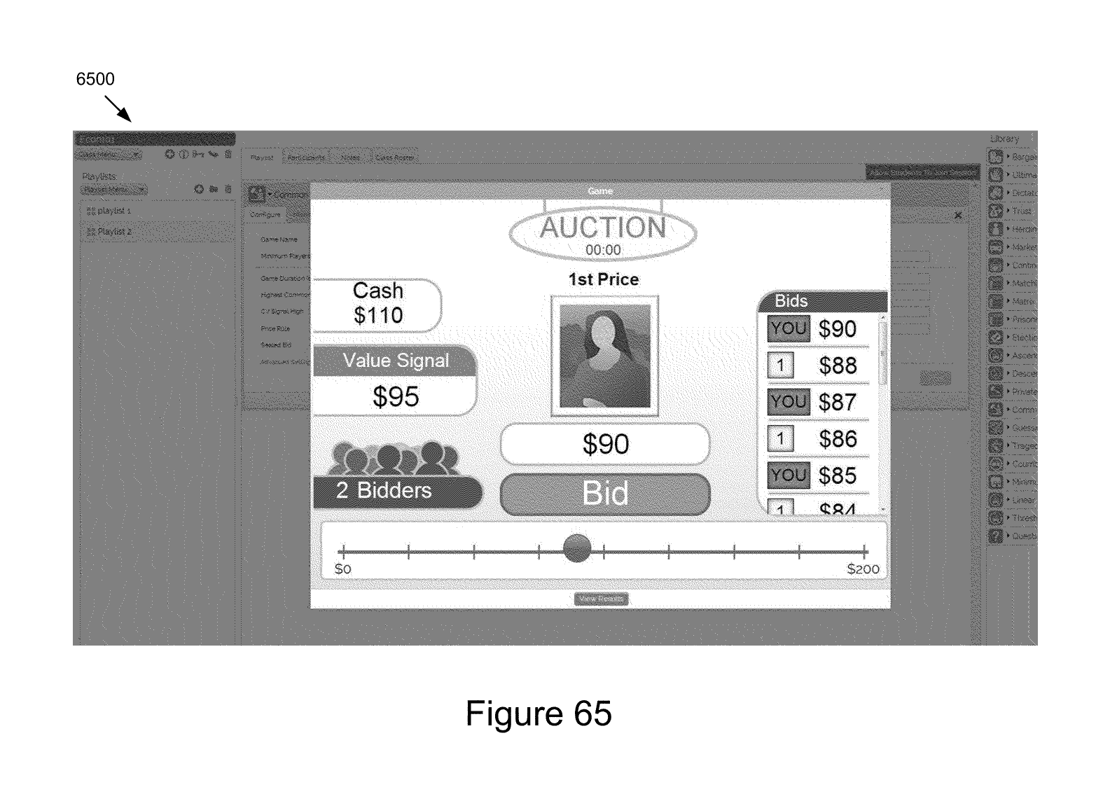

FIG. 65 is a graphical representation illustrating a user interface 6500 that allows users 125 to play the game of Common Value Auctions according to one embodiment.

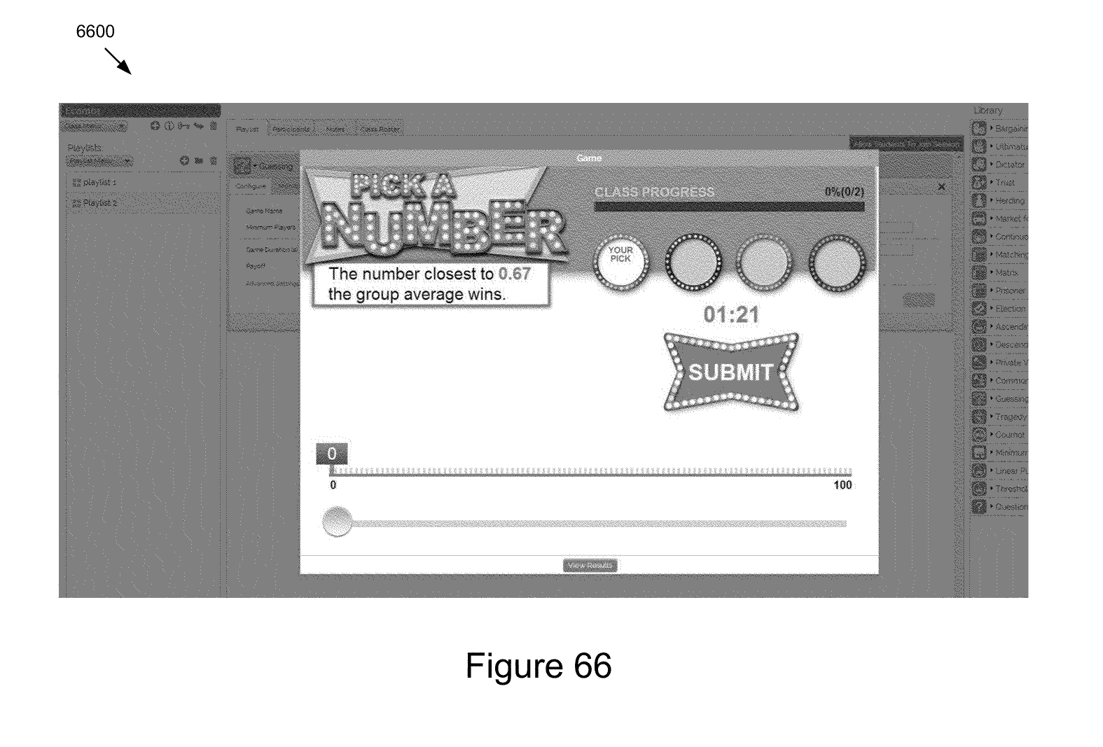

FIG. 66 is a graphical representation illustrating a user interface 6600 that allows users 125 to play the Guessing game according to one embodiment.

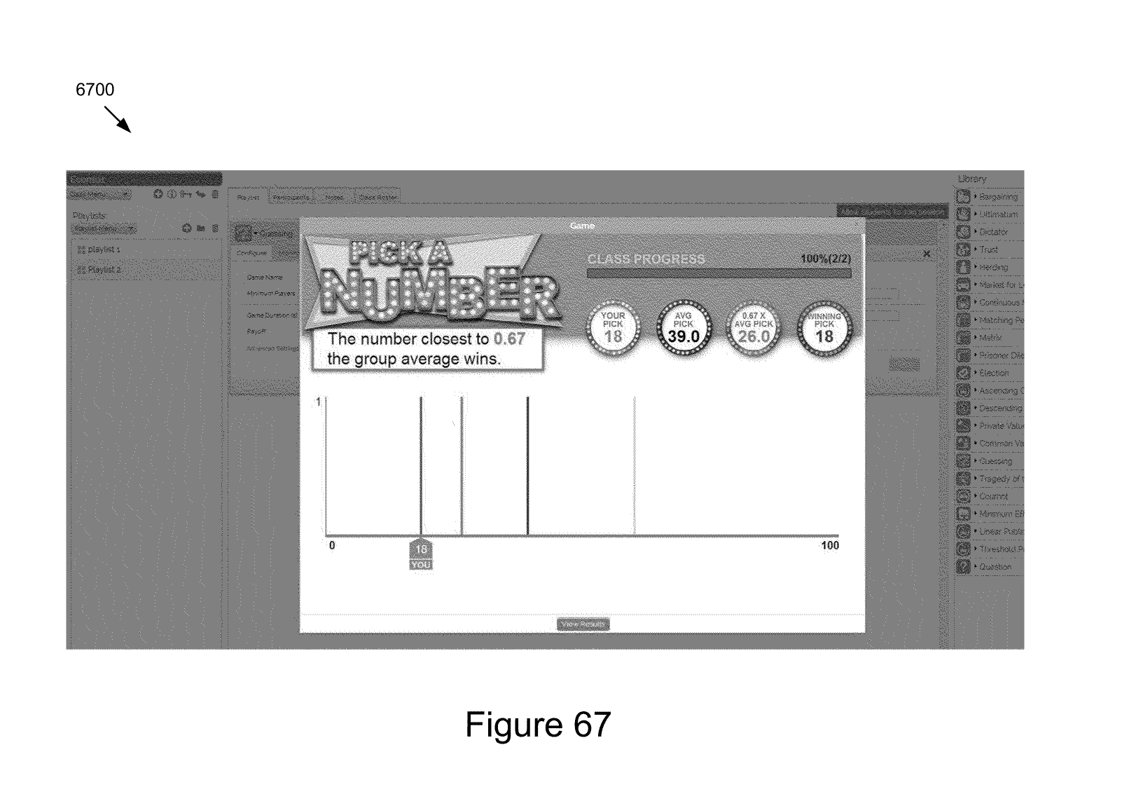

FIG. 67 is a graphical representation illustrating a user interface 6700 that displays how users 125 play the Guessing game according to one embodiment.

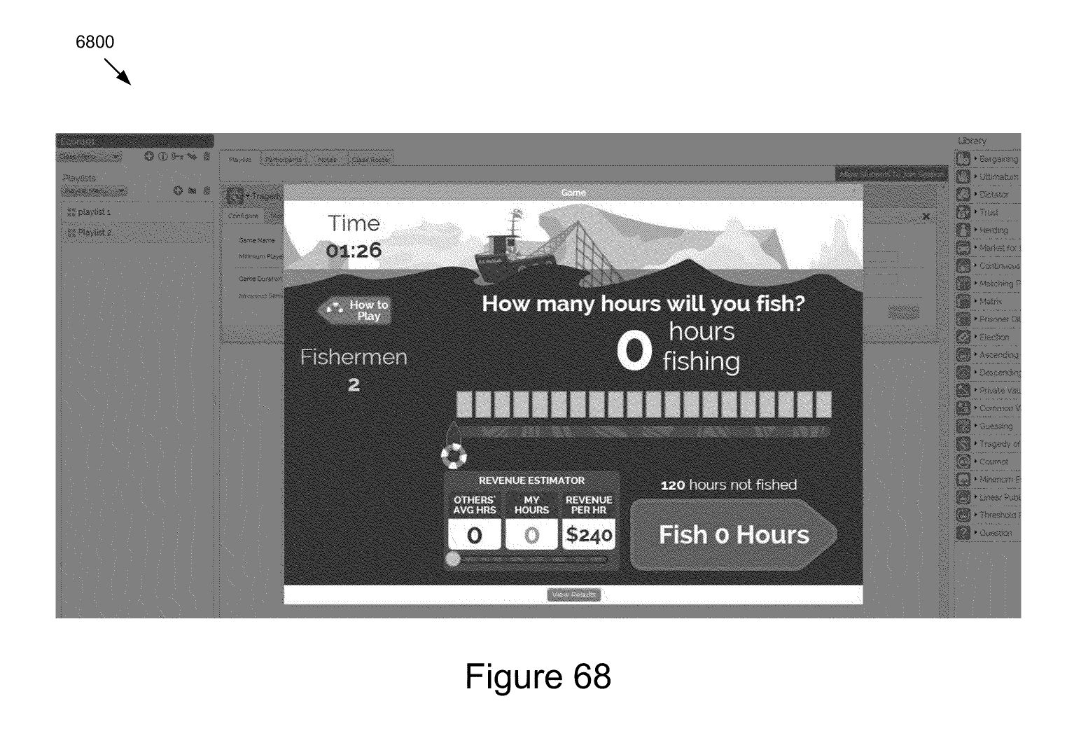

FIG. 68 is a graphical representation illustrating a user interface 6800 that allows users 125 to play the game of Tragedy of the Commons according to one embodiment.

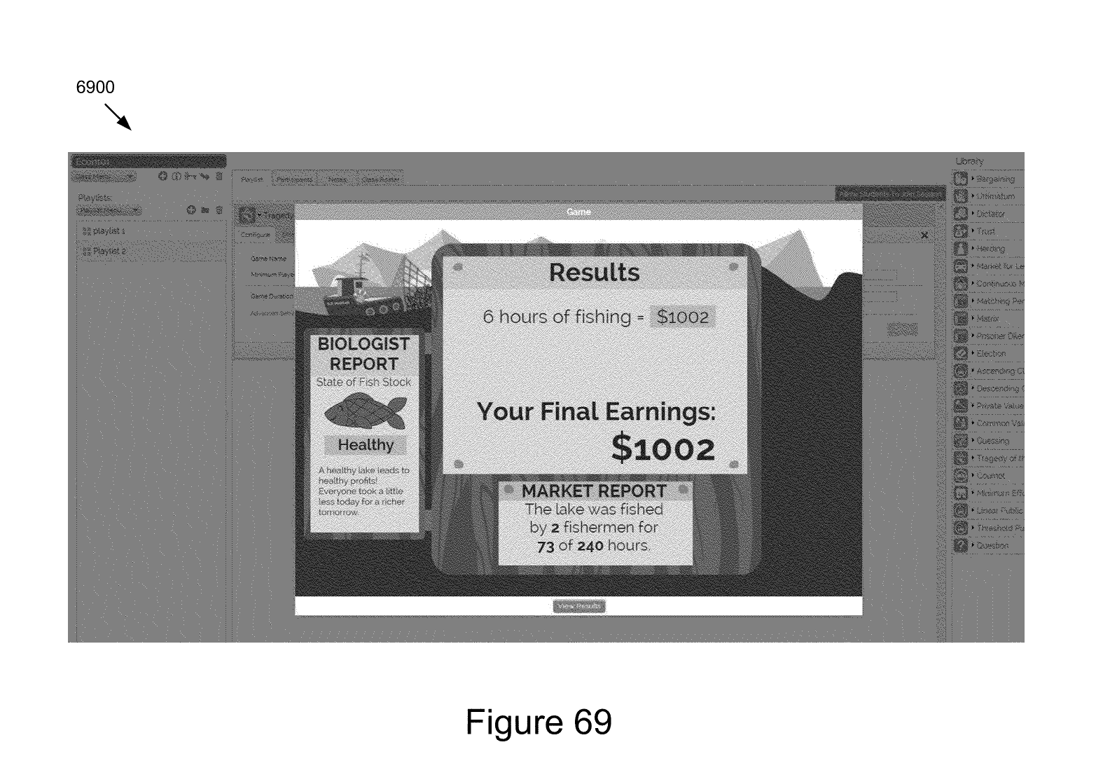

FIG. 69 is a graphical representation illustrating a user interface 6900 that displays how users 125 play the game of Tragedy of the commons according to one embodiment.

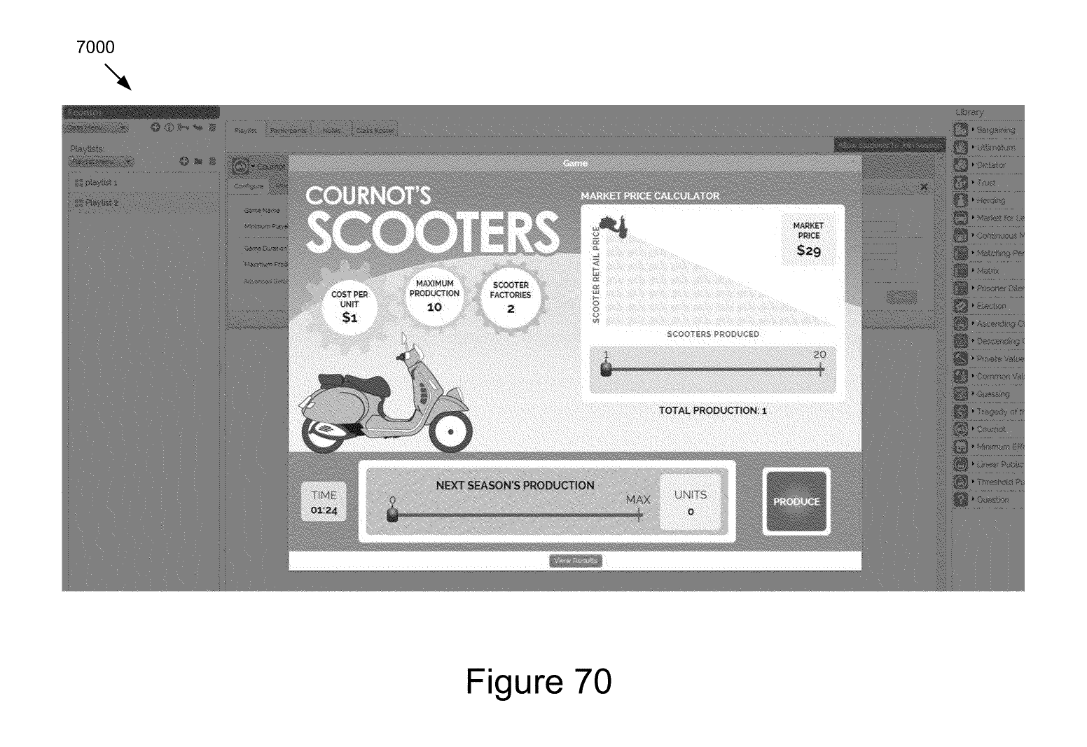

FIG. 70 is a graphical representation illustrating a user interface 7000 that allows users 125 to play the Oligopoly game according to one embodiment.

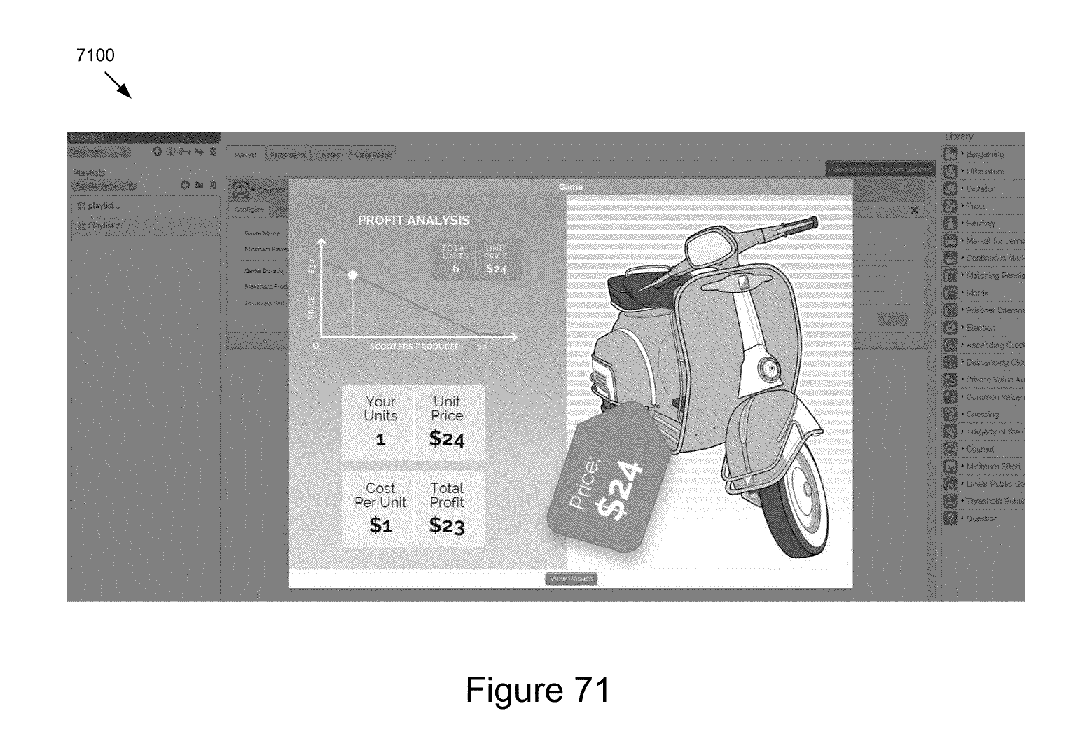

FIG. 71 is a graphical representation illustrating a user interface 7100 that displays how users 125 play the Oligopoly game according to one embodiment.

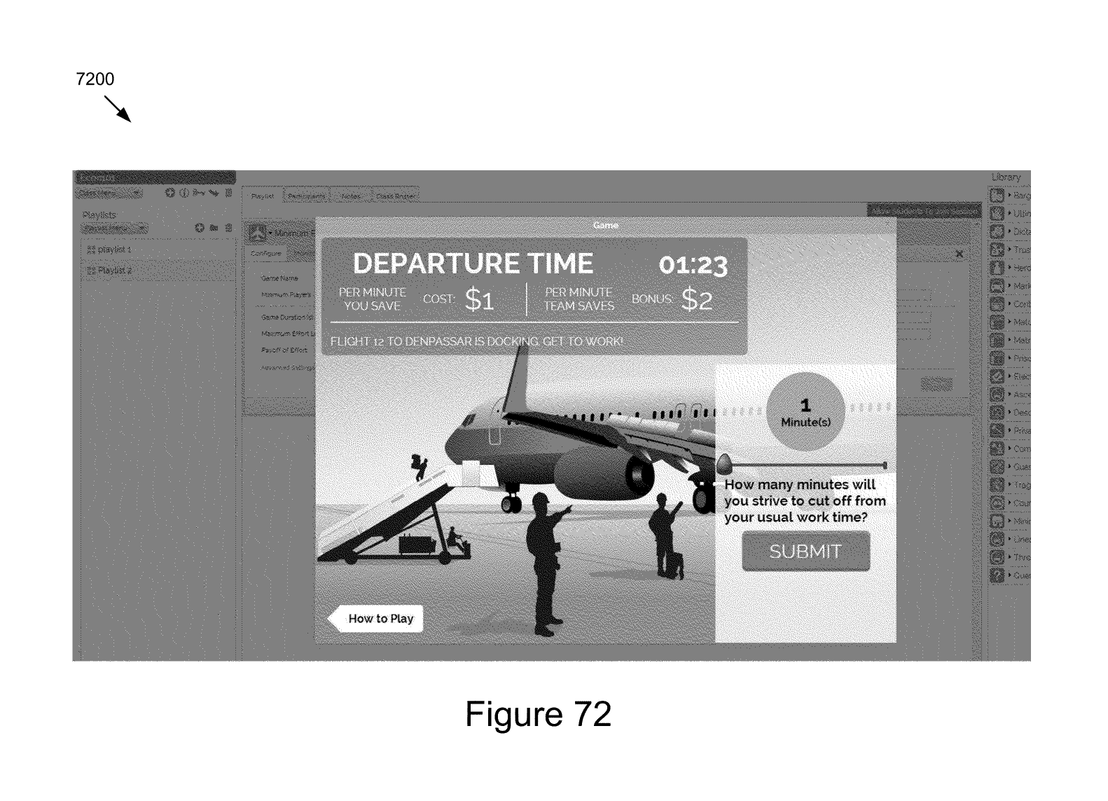

FIG. 72 is a graphical representation illustrating a user interface 7200 that allows users 125 to play the Minimum Effort game according to one embodiment.

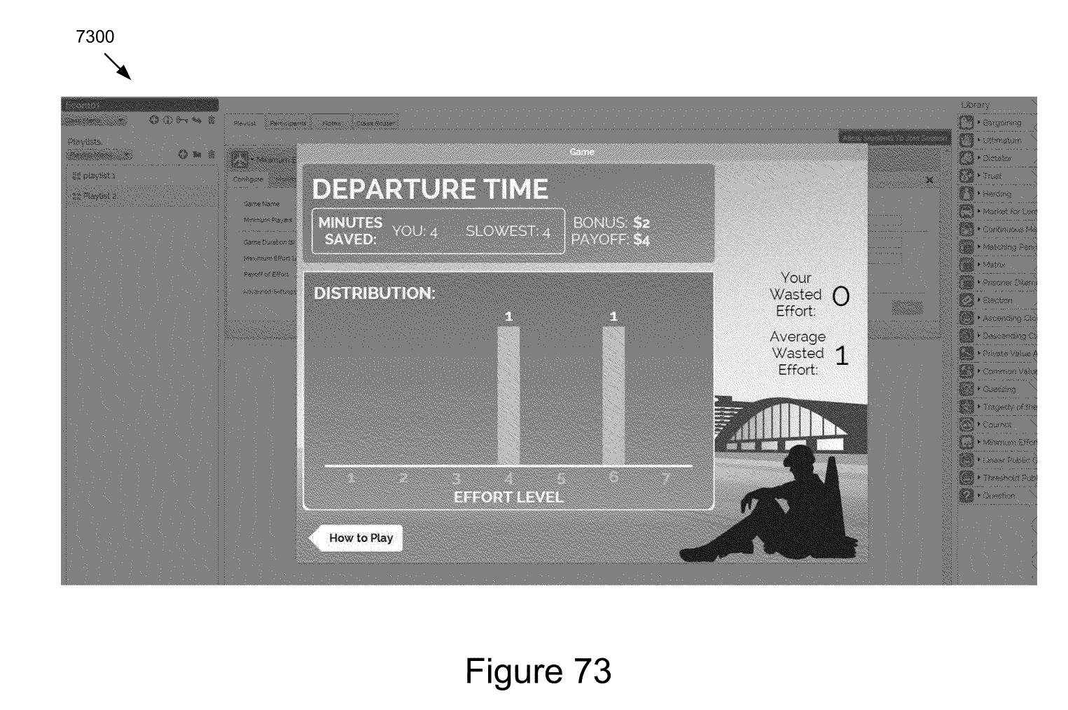

FIG. 73 is a graphical representation illustrating a user interface 7300 that displays how users 125 play the Minimum Effort game according to one embodiment.

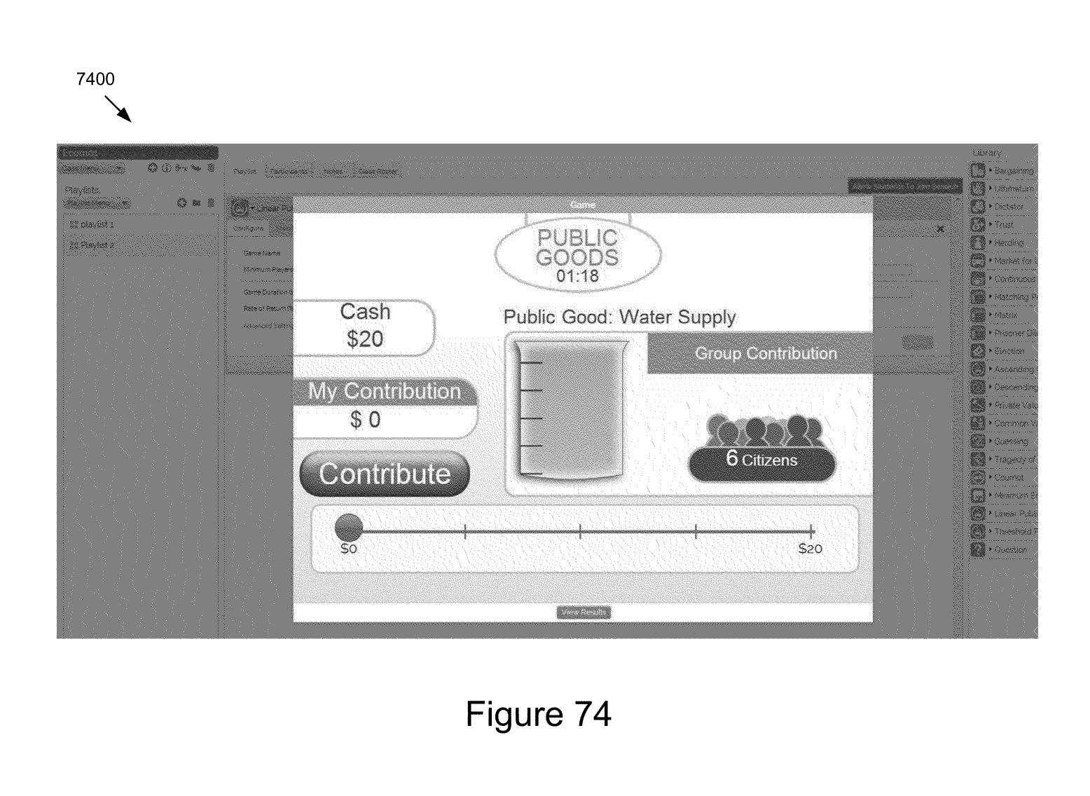

FIG. 74 is a graphical representation illustrating a user interface 7400 that allows users 125 to play the Linear Public Goods game according to one embodiment.

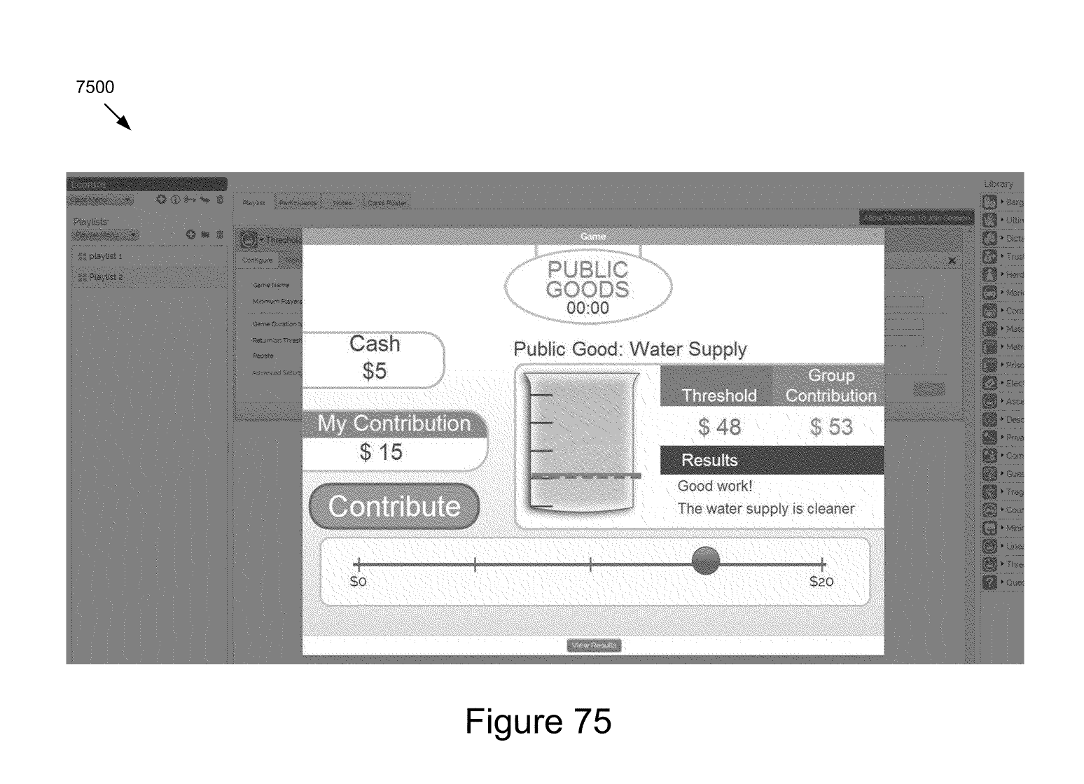

FIG. 75 is a graphical representation illustrating a user interface 7500 that allows users 125 to play the Threshold Public Goods game according to one embodiment.

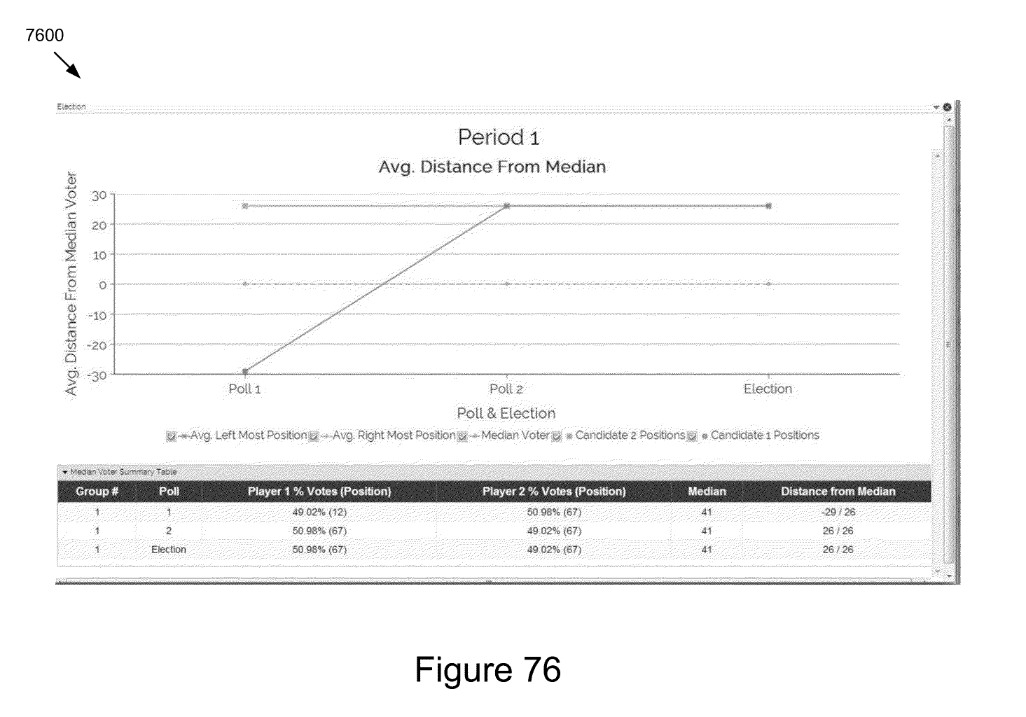

FIG. 76 is a graphical representation illustrating a user interface 7600 that displays an analysis result for the Election game according to one embodiment.

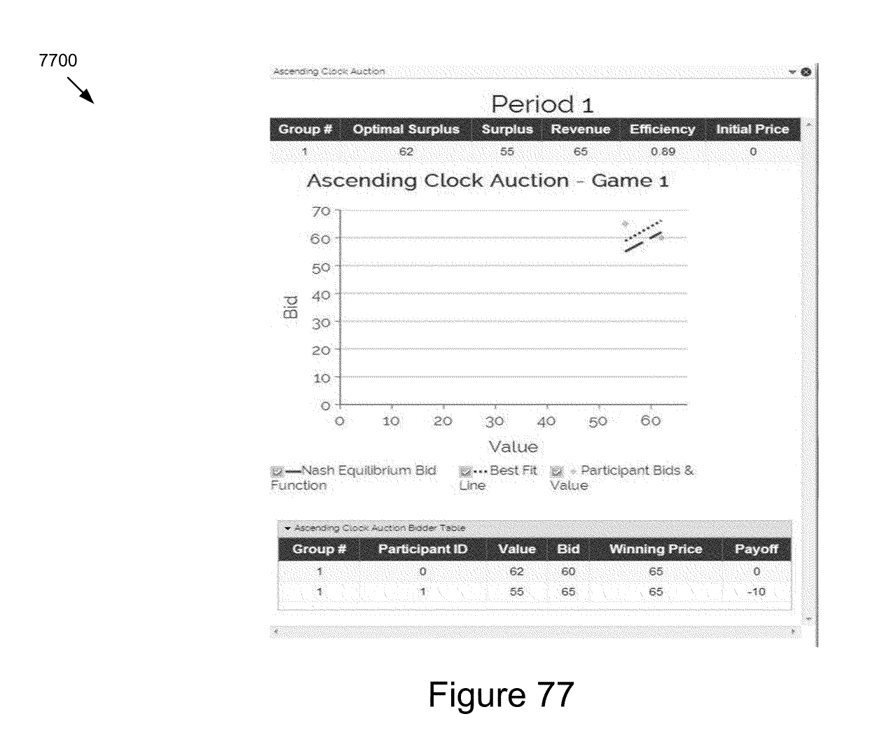

FIG. 77 is a graphical representation illustrating a user interface 7700 that displays an analysis result for the game of Ascending Clock Auction according to one embodiment.

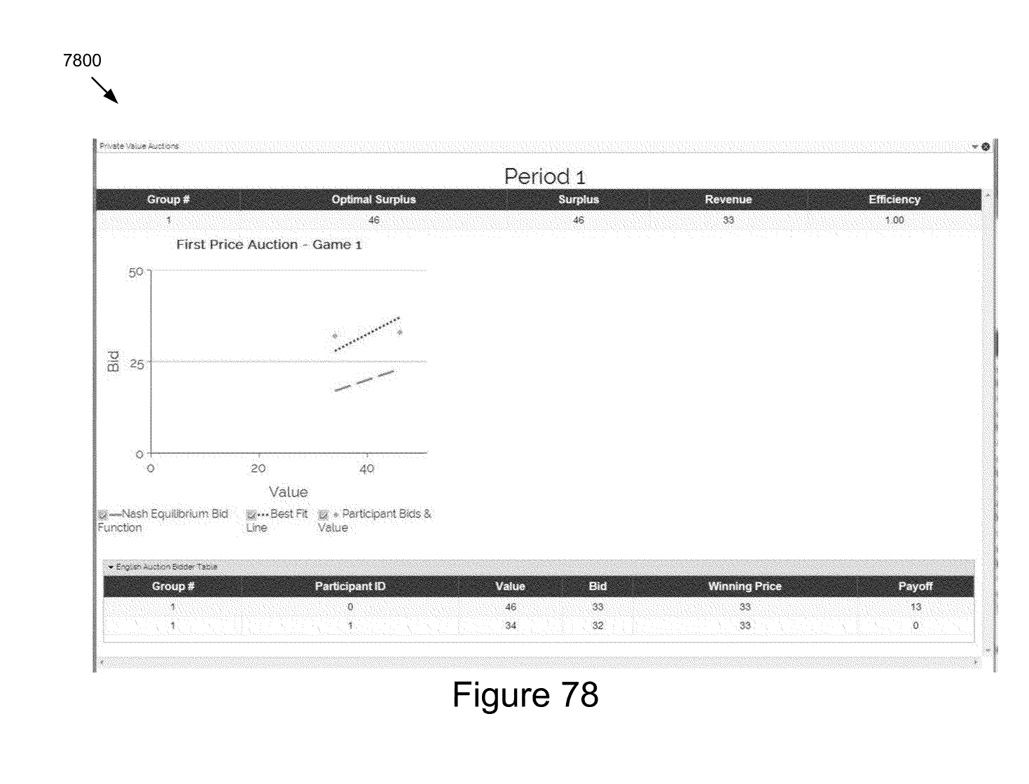

FIG. 78 is a graphical representation illustrating a user interface 7800 that displays an analysis result for the game of Private Value Auctions according to one embodiment.

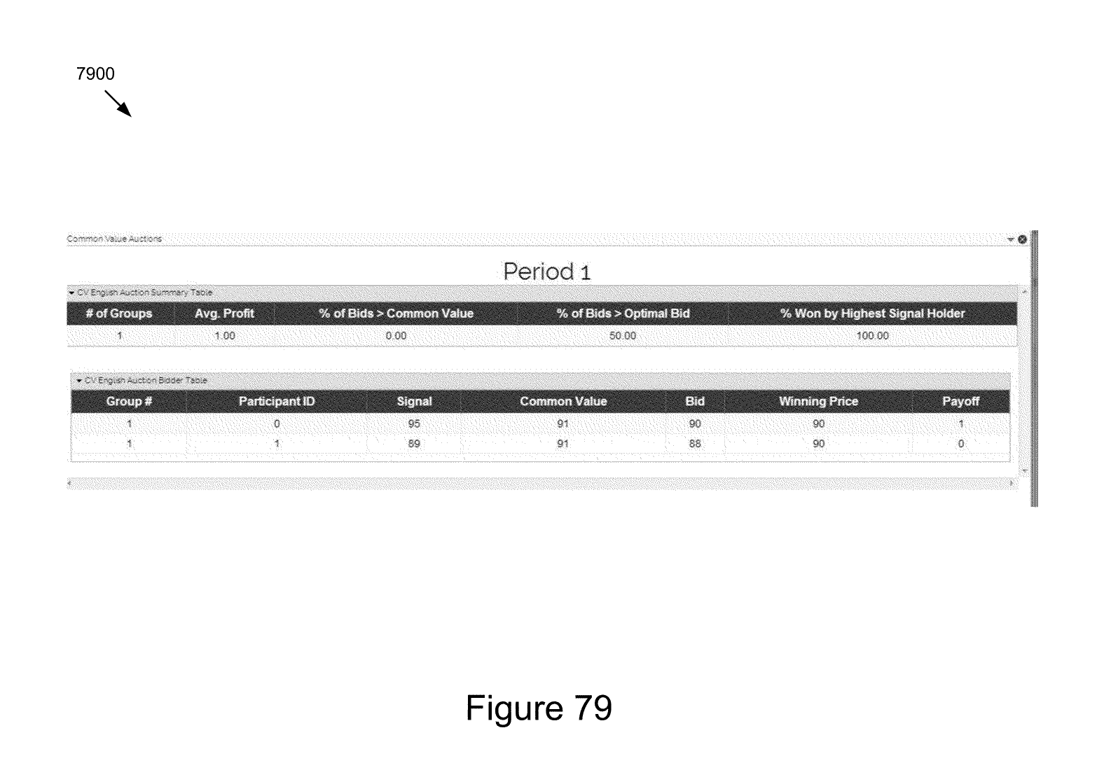

FIG. 79 is a graphical representation illustrating a user interface 7900 that displays an analysis result for the game of Common Value Auctions according to one embodiment.

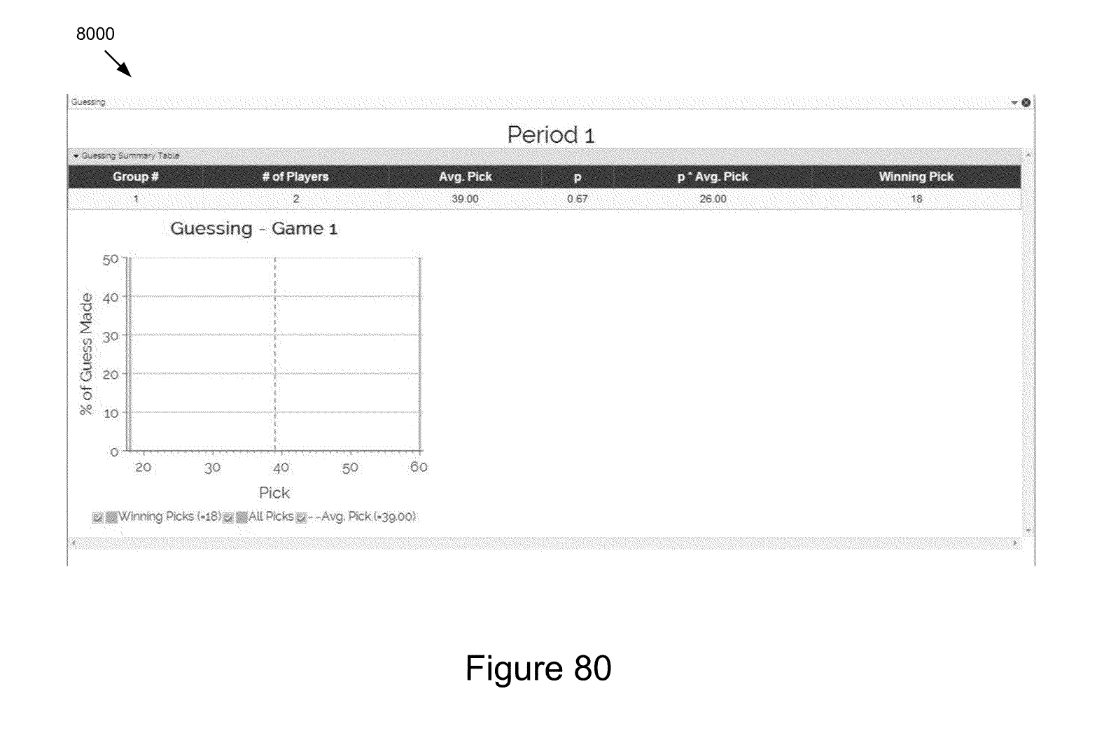

FIG. 80 is a graphical representation illustrating a user interface 7800 that displays an analysis result for the Guessing game according to one embodiment.

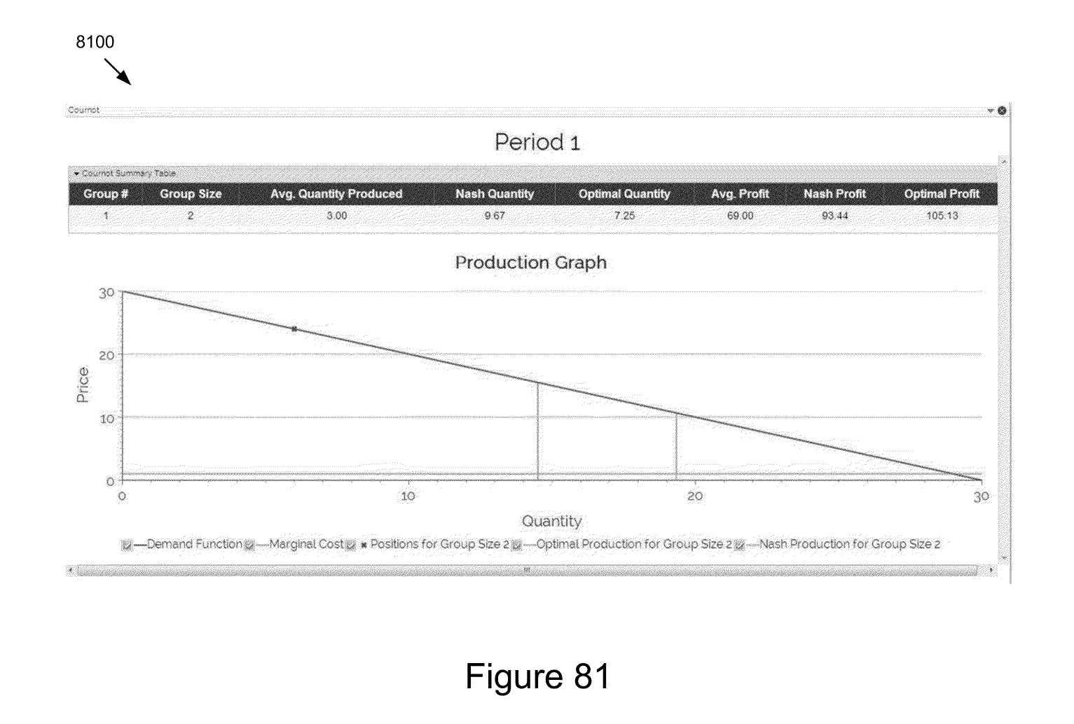

FIG. 81 is a graphical representation illustrating a user interface 8100 that displays an analysis result for the Oligopoly game according to one embodiment.

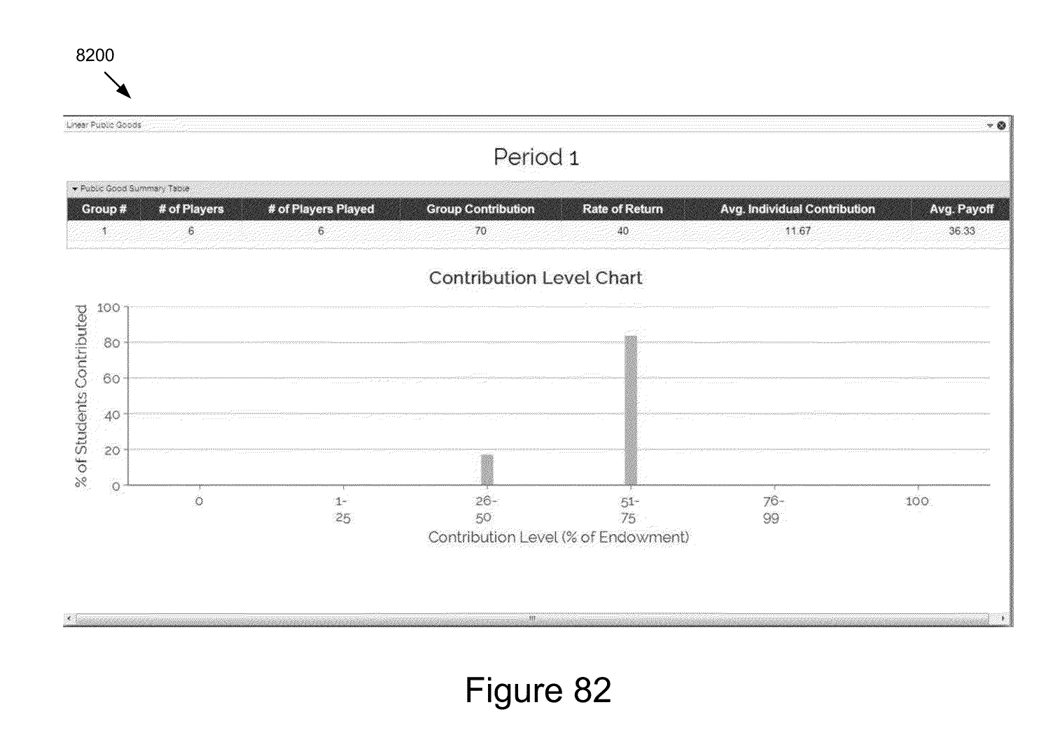

FIG. 82 is a graphical representation illustrating a user interface 8200 that displays an analysis result for the game of Linear Public Goods according to one embodiment.

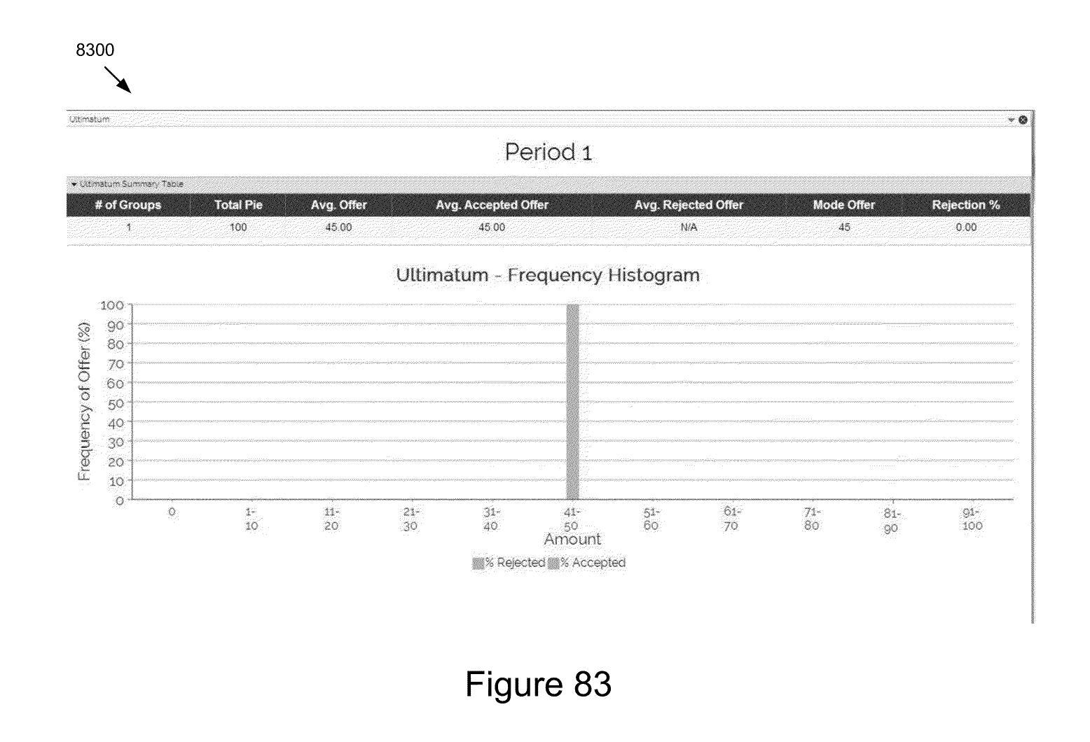

FIG. 83 is a graphical representation illustrating a user interface 8300 that displays an analysis result for the Ultimatum game according to one embodiment.

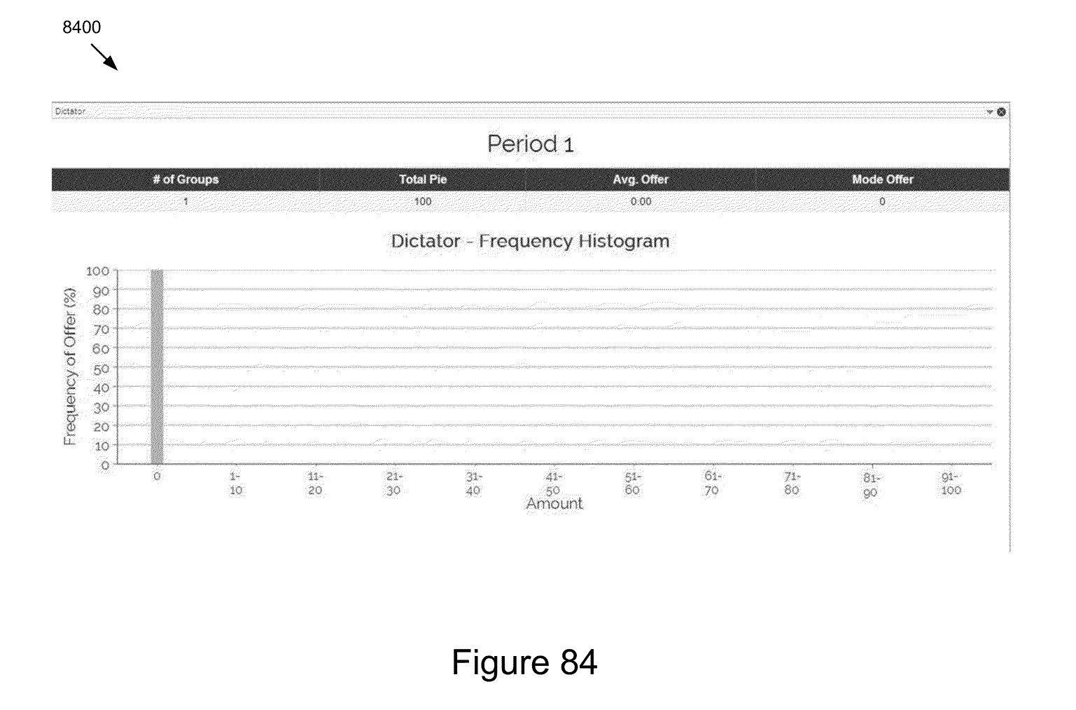

FIG. 84 is a graphical representation illustrating a user interface 8400 that displays an analysis result for the Dictator game according to one embodiment.

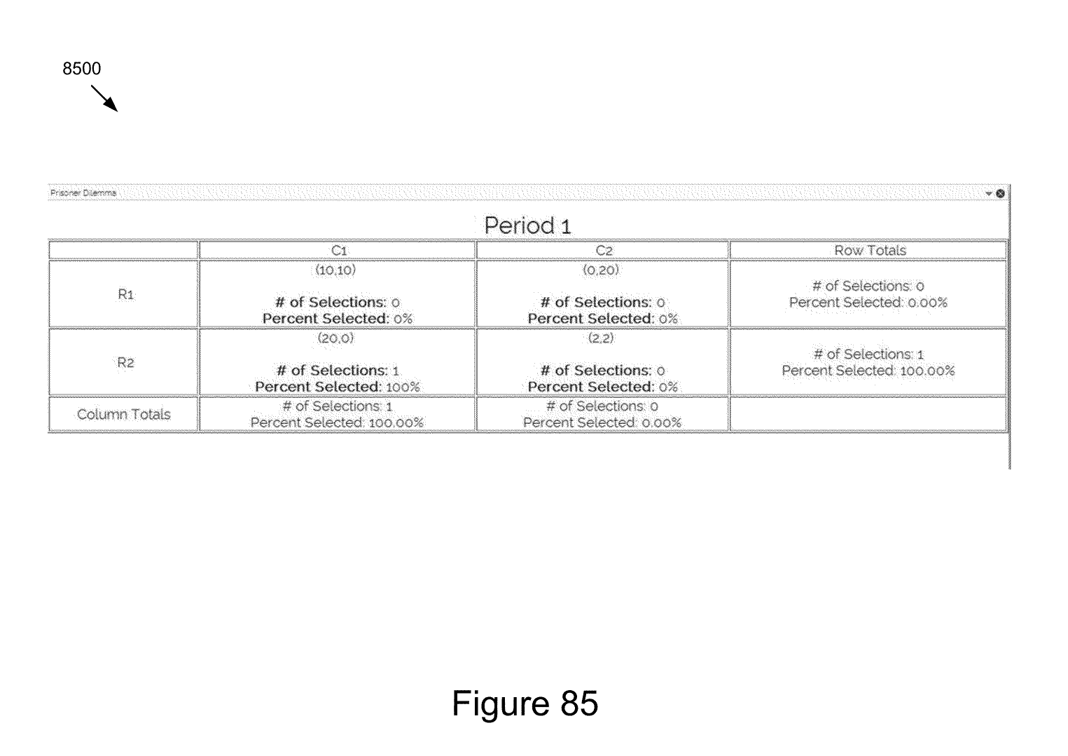

FIG. 85 is a graphical representation illustrating a user interface 8500 that displays an analysis result for the Prisoner Dilemma game according to one embodiment.

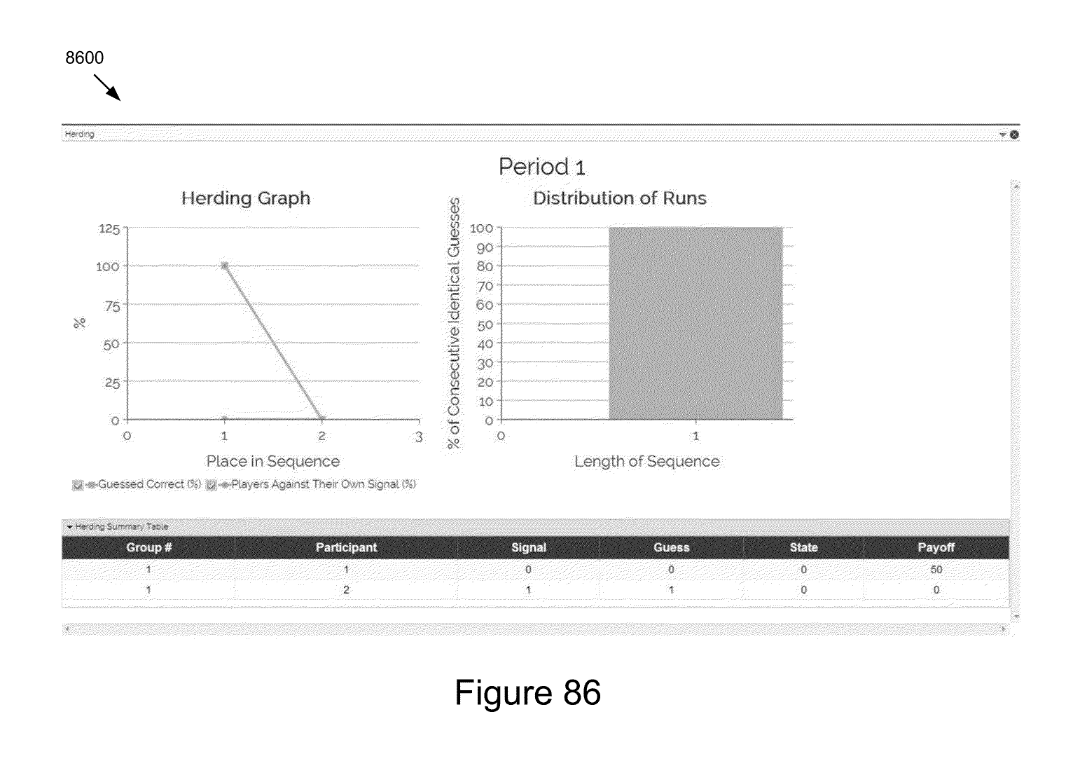

FIG. 86 is a graphical representation illustrating a user interface 8600 that displays an analysis result for the Herding game according to one embodiment.

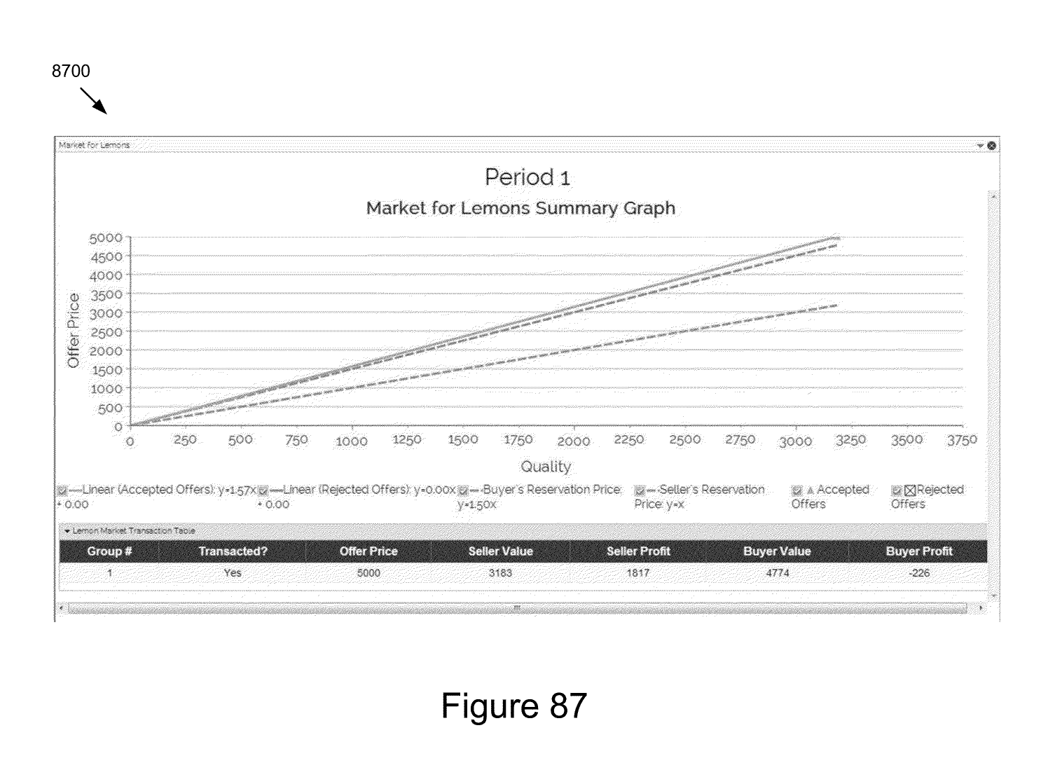

FIG. 87 is a graphical representation illustrating a user interface 8700 that displays an analysis result for the game of Market for Lemons according to one embodiment.

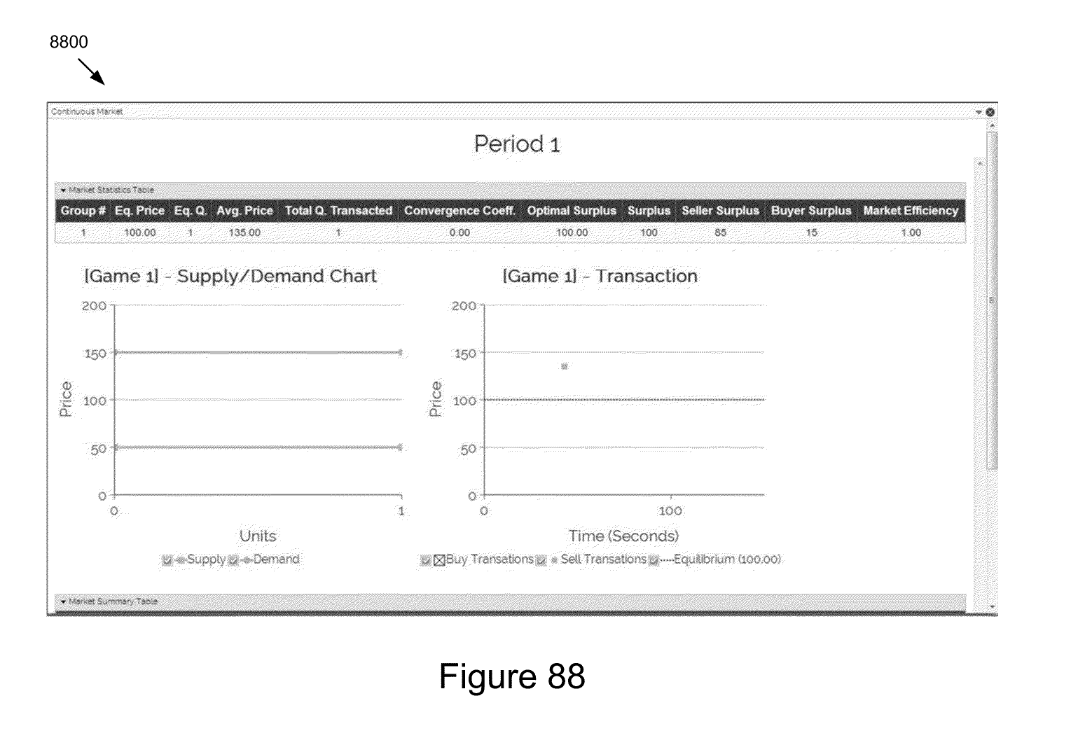

FIG. 88 is a graphical representation illustrating a user interface 8800 that displays an analysis result for the Continuous Market game according to one embodiment.

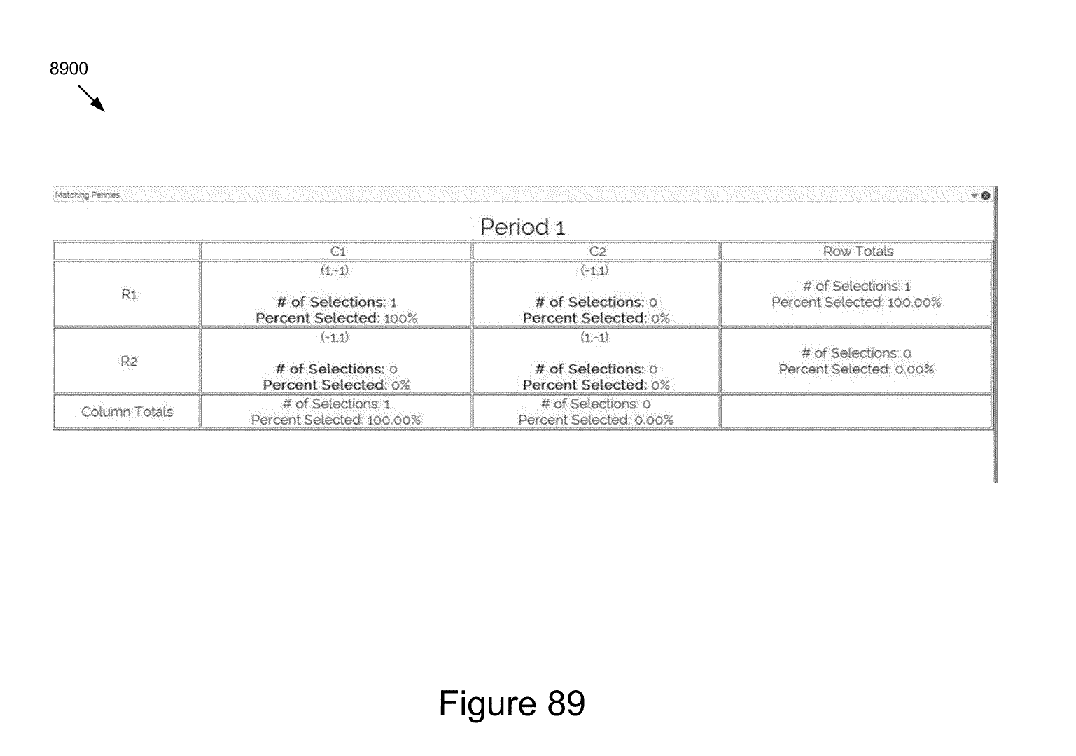

FIG. 89 is a graphical representation illustrating a user interface 8900 that displays an analysis result for the game of Matching Pennies according to one embodiment.

FIG. 90 is a graphical representation illustrating a user interface 9000 that displays an analysis result for the Matrix game according to one embodiment.

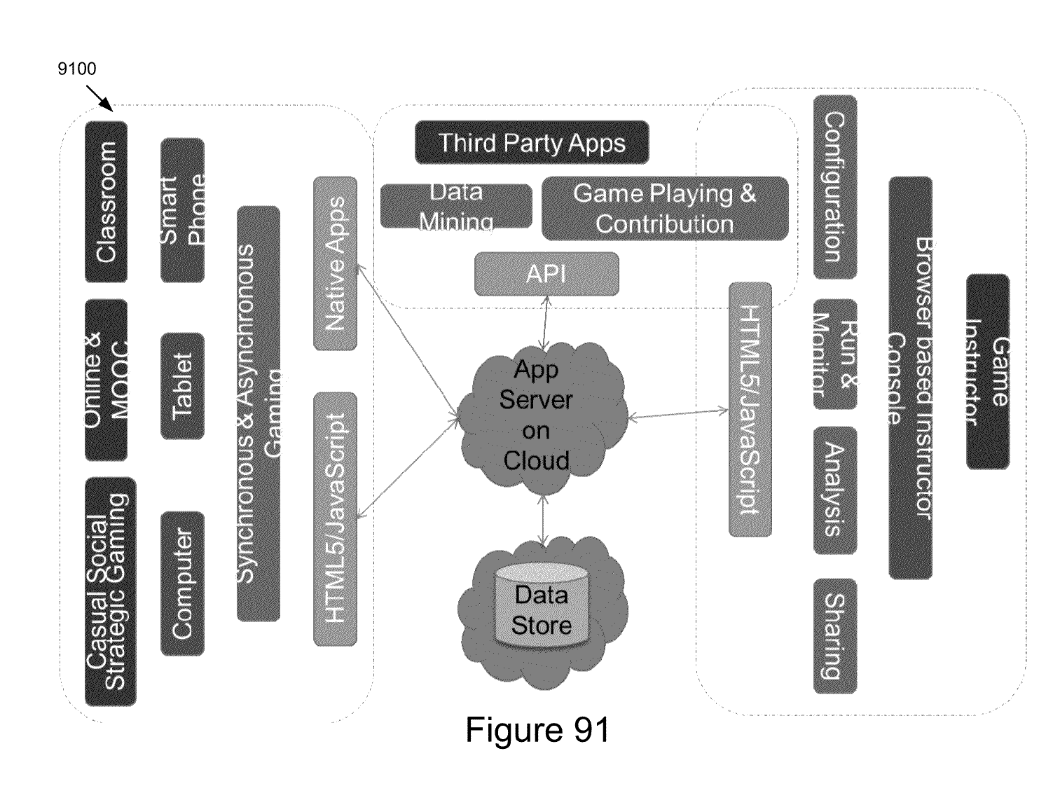

FIG. 91 is a block diagram illustrating a system for providing interactive experimentations to users 125 according to yet another embodiment.

The foregoing description of the embodiments has been presented for the purpose of illustration and description. It is not intended to be exhaustive or to limit the present embodiments to the precise forms disclosed. Many modifications and variations are possible in light of the above teaching. It is intended that the scope of the present embodiments be limited not by this detailed description, but rather by the claims of this application. As will be understood by those familiar with the art, the present embodiments may take other specific forms without departing from the spirit or essential characteristics thereof. Likewise, the particular naming and division of the modules, routines, features, attributes, methodologies and other aspects are not mandatory or significant, and the mechanisms that implement one embodiment or its features may have different names, divisions and/or formats. Furthermore, as will be apparent, the modules, routines, features, attributes, methodologies and other aspects of the embodiments can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the embodiments are in no way limited to implementation in any specific programming language, or for any specific operating system or environment. Accordingly, the disclosure is intended to be illustrative, but not limiting, of the scope, which is set forth in the following claims.

What is claimed is:

1. A method comprising:
receiving, using one or more processors, a signal to create a playlist from a first user;
creating, using the one or more processors, an empty playlist, responsive to receiving the signal;
receiving, using the one or more processors, a first template for a first game; and
populating, using the one or more processors, the playlist based on the first template for the first game.

2. The method of claim 1 comprising:
receiving, using the one or more processors, a second template for a second game; and
populating, using the one or more processors, the playlist with the second template for the first game.

3. The method of claim 2 wherein the order of the first template and the second template in the playlist determines an order in which the first game and the second game are executed.

4. The method of claim 2 wherein the first game and second game simulate real-world economic interactions.

5. The method of claim 2 comprising:
receiving, using the one or more processors, a signal to modify an order of the first and second game;
modifying, using the one or more processors, the order of the first and second game in the playlist; and
executing, using the one or more processors, the first game and the second game in the modified order.

6. The method of claim 1 wherein the playlist may be shared by the first user with a second user.

7. The method of claim 1 comprising:
receiving, using the one or more processors, at least one parameter for the first game; and
executing the first game using the received parameter.

8. A computer program product comprising a computer usable medium including a computer readable program, wherein the computer readable program when executed on a computer causes the computer to:
receive a signal to create a playlist from a first user;
create an empty playlist, responsive to receiving the signal;
receive a first template for a first game; and
populate the playlist based on the first template for the first game.

9. The computer program product of claim 8 wherein the computer readable program when executed on a computer also causes the computer to:
receive a second template for a second game; and
populate the playlist with the second template for the first game.

10. The computer program product of claim 9 wherein the order of the first template and the second template in the playlist determines an order in which the first game and the second game are executed.

11. The computer program product of claim 9 wherein the first game and second game simulate real-world economic interactions.

12. The computer program product of claim 8 wherein the computer readable program when executed on a computer also causes the computer to:
receive a signal to modify an order of the first and second game;
modify the order of the first and second game in the playlist; and
execute the first game and the second game in the modified order.

13. The computer program product of claim 8 wherein the playlist may be shared by the first user with a second user.

14. The computer program product of claim 8 wherein the computer readable program when executed on a computer also causes the computer to:
receive at least one parameter for the first game; and
execute the first game using the received parameter.

15. A system comprising:
a processor; and
a memory storing instructions that, when executed, cause the system to:
receive a signal to create a playlist from a first user;
create an empty playlist, responsive to receiving the signal;
receive a first template for a first game; and
populate the playlist based on the first template for the first game.

16. The system of claim 8 wherein the memory also stores instructions that, when executed, cause the system to:
receive a second template for a second game; and
populate the playlist with the second template for the first game.

17. The system of claim 9 wherein the order of the first template and the second template in the playlist determines an order in which the first game and the second game are executed.

18. The system of claim 9 wherein the first game and second game simulate real-world economic interactions.

19. The system of claim 8 wherein the memory also stores instructions that, when executed, cause the system to:
receive a signal to modify an order of the first and second game;
modify the order of the first and second game in the playlist; and
execute the first game and the second game in the modified order.

20. The computer program product of claim 8 wherein the computer readable program when executed on a computer also causes the computer to:
receive at least one parameter for the first game; and
execute the first game using the received parameter.
